(19) United States
(12) Patent Application Publication
(10) Pub. No.: US 2025/0057093 A1
(43) Pub. Date: Feb. 20, 2025

(54) COMPOSITIONS AND METHODS FOR ARUNDO PLANT BIOMASS PRODUCTION

(71) Applicant: Hexas Biomass Inc., Olympia, WA (US)

(72) Inventor: Wendy Owens, Olympia, WA (US)

(21) Appl. No.: 18/675,540

(22) Filed: May 28, 2024

Related U.S. Application Data
(63) Continuation of application No. PCT/US2022/051286, filed on Nov. 29, 2022.
(60) Provisional application No. 63/284,311, filed on Nov. 30, 2021.

(51) Int. Cl. A01G 22/00; B09C 1/10; B27N 3/04; B27N 3/14

(52) U.S. Cl. CPC A01G 22/00; B09C 1/105; B27N 3/04; B27N 3/143

(57) ABSTRACT

Disclosed herein are compositions and products of Arundo grass plants and methods of producing the same.

### CROSS-REFERENCE

This application is a continuation of International Application No. PCT/US2022/051286, filed Nov. 29, 2022, which claims the benefit of U.S. Provisional Application No. 63/284,311, filed Nov. 30, 2021, which are incorporated herein by reference in its entirety.

### BACKGROUND

Biomass production is important in generating feedstocks for applications ranging from fuels to construction materials. Substandard soils may provide an attractive source of new farmland for production of biomass.

### SUMMARY

Recognized herein is the need for improved methods and crops which can be grown at high density in substandard soils.

In an aspect, described herein is a method for hydroponically growing Arundo grass planting units, the method comprising contacting a plurality of Arundo grass clone units with liquid; and subjecting the plurality of Arundo grass clone units to hydroponic growing conditions sufficient to provide a plurality of Arundo grass planting units; the hydroponic growing conditions comprising grow lights of an illumination level of no more than about 1,000-foot candles. In some embodiments, the grow lights comprise sunlight. In some embodiments, a grow light can be any light source which is sufficiently broadband (e.g. including visible, ultraviolet, and/or infrared light) to sustain growth of a plant. In some embodiments, the grow lights are characterized by an illumination level of no more than about 700- or 600-foot candles (e.g., from about 300- to about 600-foot candles). In some embodiments, the contacting comprises placing the plurality of Arundo grass clone units in a container comprising the liquid. In some embodiments, the liquid comprises water. In some embodiments, the liquid comprises one or more nutrients.

In some embodiments, the liquid is still. In some embodiments, the liquid is circulated (e.g., using a pump and filtration system). In some embodiments, the hydroponic growing conditions comprise subjecting the plurality of Arundo grass clone units to a temperature from about 55 degrees Fahrenheit (° F.) to about 85° F. In some embodiments, the hydroponic growing conditions comprise subjecting the plurality of Arundo grass clone units to the grow lights for a root establishment duration (e.g., from about 7 to about 21 days). In some embodiments, the hydroponic growing conditions comprise subjecting the plurality of Arundo grass clone units to a temperature of about 68 degrees Fahrenheit (° F.) or higher.

In some embodiments, the Arundo is selected from Arundo collina, Arundo donaciformis, Arundo donax, Arundo formosana, Arundo micrantha (e.g., Arundo micrantha Lam), and Arundo plinii. In some embodiments, each of the plurality of planting units is an Arundo grass plant, an Arundo grass plantlet, or an Arundo grass cultivar, or a part, stem, rhizome, or segment of any one of the foregoing. In some embodiments, at least one planting unit of the plurality of Arundo grass planting units comprises a root structure. In some embodiments, at least one planting unit of the plurality of Arundo grass planting units comprises a shoot structure. In some embodiments, at least one planting unit of the plurality of Arundo grass planting units comprises a root structure and a shoot structure. In some embodiments, at least about 10%, 20%, 30%, 40%, 50%, 60%, 70%, 80%, or 90% planting units of the plurality of Arundo grass planting units comprise root structures. In some embodiments, at least one planting unit of the plurality of Arundo grass planting units comprise shoot structures. In some embodiments, at least about 10%, 20%, 30%, 40%, 50%, 60%, 70%, 80%, or 90% planting units of the plurality of Arundo grass planting units comprise root structures and shoot structures. In some embodiments, at least about 10%, 20%, 30%, 40%, 50%, 60%, 70%, 80%, or 90% planting units of the plurality of planting units are sterile. In some embodiments, the plurality of planting units are each independently about 4 centimeters (cm) to about 30 cm in height. In some embodiments, the plurality of planting units thereof each independently have about 1 node(s) to about 10 nodes. In some embodiments, the plurality of planting units are each independently from about 2 weeks old to about 16 weeks old.

In another aspect, described herein is a method for growing Arundo grass, the method comprising: (a) providing (e.g., planting) a plurality of Arundo grass planting units in soil; and (b) subjecting the plurality of Arundo grass planting units to conditions sufficient to grow the plurality of Arundo grass planting units to provide a plurality of Arundo grass plants having a density of at least about 1 unit per square meter (U/m²) surface of the soil. In some embodiments, in (a), the providing comprises planting the plurality of Arundo grass planting units in the soil. In some embodiments, in (a), the providing comprises providing (e.g., planting) a first planting unit and a second planting unit separate and apart from each other by a distance of about 2 meters or less. In some embodiments, in (a), the providing comprises providing (e.g., planting) a first planting unit and a second planting unit separate and apart from each other by a distance of about 1 meter or less. In some embodiments, in (a), the providing comprises providing (e.g., planting) a first planting unit and a second planting unit separate and apart from each other by a distance from about 0.5 to about 2 meter(s). In some embodiments, in (a), the providing comprises planting the plurality of Arundo grass planting units at a depth of at least about 50 millimeter(s) (mm). In some embodiments, in (b), the subjecting comprises growing the plurality of Arundo grass planting units for a time period of at most about 300 days. In some embodiments, the plurality of Arundo grass plants are each independently about 4.5 meters (m) to about 12 m in height.

In some embodiments, in (a), the soil is potting soil. In some embodiments, the soil is essentially free of peat. In some embodiments, the soil comprises peat. In some embodiments, the soil has a soil moisture level from about 10% to about 80%, by volume, e.g., as determined by a soil moisture meter. In some embodiments, the Arundo is selected from Arundo collina, Arundo donaciformis, Arundo donax, Arundo formosana, Arundo micrantha (e.g., Arundo micrantha Lam), and Arundo plinii. In some embodiments, at least about 10%, 20%, 30%, 40%, 50%, 60%, 70%, 80%, 90%, or 95% planting units of the plurality of planting units are derived from a high-yield phenotype of Arundo grass. In some embodiments, at least about 10%, 20%, 30%, 40%, 50%, 60%, 70%, 80%, 90%, or 95% planting units of the plurality of planting units are derived from a drought-resistant phenotype of Arundo grass. In some embodiments, at least about 10%, 20%, 30%, 40%, 50%, 60%, 70%, 80%, 90%, or 95% planting units of the plurality of planting units are derived from a cold-resistant phenotype of Arundo grass. In some embodiments, the cold-resistant phenotype of Arundo grass comprises rhizomes which survive in freezing temperatures. In some embodiments, at least about 10%, 20%, 30%, 40%, 50%, 60%, 70%, 80%, 90%, or 95% planting units of the plurality of planting units are derived from a saline-tolerant phenotype of Arundo grass. In some embodiments, at least about 10%, 20%, 30%, 40%, 50%, 60%, 70%, 80%, 90%, or 95% planting units of the plurality of planting units are derived from a low nutrient requiring phenotype of Arundo grass.

In some embodiments, the method further comprises, subsequent to (b), (c) harvesting the plurality of Arundo grass plants to provide a plurality of harvested Arundo grass. In some embodiments, the plurality of harvested Arundo grass comprises stalks. In some embodiments, the plurality of harvested Arundo grass comprises leaves. In some embodiments, the plurality of harvested Arundo grass comprises stalks and leaves. In some embodiments, the plurality of harvested Arundo grass comprises stalks each independently about 0.5 to about 12 m in height. In some embodiments, the plurality of harvested Arundo grass has a moisture content of at least about 21%. In some embodiments, the plurality of harvested Arundo grass comprises, by weight, a sugar content of about 1.5% to about 45%. In some embodiments, the plurality of harvested Arundo grass comprises, by weight, a cellulose content of about 25% to about 33%. In some embodiments, wherein the plurality of harvested Arundo grass comprises, by weight, a hemicellulose content of about 25% to about 38%. In some embodiments, the plurality of harvested Arundo grass comprises, by weight, a lignin content of about 17% to about 20%. In some embodiments, the plurality of harvested Arundo grass is harvested prior to the plants entering dormancy/cessation, such as by harvesting during the new moon.

In some embodiments, an annual yield of Arundo grass stalks is at least about 10 bone-dry metric tons per hectare (e.g., at least 10, 20, 30, or 40 metric tons per hectare).

In some embodiments, the method is used for bioremediation of soil. In some embodiments, the bioremediation is used to reduce a content of one or more elements in the soil by at least 0.1 (e.g., at least 0.1, 0.5, 1, 100, 1000, or 10,000) μg of element per gram of Arundo grown as measured in fiber produced from stalks of the Arundo. In some embodiments, wherein the one or more elements are selected from the group of: Aluminum, Antimony, Arsenic, Barium, Beryllium, Boron, Cadmium, Chromium, Cobalt, Copper, Iron, Lead, Lithium, Magnesium, Mercury, Molybdenum, Nickel, Phosphorus, Potassium, Selenium, Silicon, Silver, Strontium, Sulfur, Thallium, Tin, Titanium, Vanadium, and Zinc. In some embodiments, a content of at least five or more elements in the soil are reduced. In some embodiments, the soil is contaminated with one or more toxins, and is rendered food safe after one or more Arundo plantings. In some embodiments, the soil is not suitable for sustained growth of food crops prior to the growing of the plurality of Arundo grass plants. In some embodiments, the methods further comprise repeatedly planting and harvesting Arundo grass plants in the soil until a predetermined target soil composition is obtained.

In another aspect, described herein is a method for processing Arundo grass, the method comprising: (a) providing a plurality of Arundo grass that comprises at most 30%, 20%, 10%, or 5%, by weight, leaves (optionally, wherein the plurality of Arundo grass is substantially free of leaves); and (b) processing the plurality of Arundo grass to provide a plurality of chips, wherein a chip of the plurality of chips has an ash content of about 8% or less by weight.

In another aspect, described herein is a method for preparing Arundo base materials, the method comprising: (a) providing a plurality of Arundo grass that comprises at most 30%, 20%, 10%, or 5%, by weight, leaves (optionally, wherein the plurality of Arundo grass is substantially free of leaves); (b) processing the plurality of Arundo grass to provide a plurality of Arundo grass chips; and (c) processing the plurality of Arundo grass chips to provide a material selected from the group consisting of a pellet, a weed control mat, an absorptive pellet, a combustion pellet, a flooring material, a structural beam, a fiberboard, a fiber reinforcement in a composite, a particle board, a bioplastic, a fire retardant, an animal feed, a biochar, an aggregate, a pulp, a paper product (e.g., packaging, toilet paper, paper towels, tissue, or a combination thereof), a fabric, a weaving, a biofuel material, a biochemical material, a wood replacement material, a bamboo replacement material, a corn replacement material, an oriented strand board (OSB), a bioplastic, an insulation material, and a reinforcement material. In some embodiments, the plurality of Arundo grass comprises stalks having a length of no more than about 500, 400, 300, 200, 150, 100, 50, 40, 30, 20, or 10 millimeters (mm).

In some embodiments, the plurality of Arundo grass comprises stalks having a length of about 150 millimeters (mm) to about 10 mm. In some embodiments, the plurality of Arundo grass comprises stalks having a length of about 50 millimeters (mm) to about 10 mm. In some embodiments, the plurality of Arundo grass chips each have a length of no more than about 150, 100, 50, 40, 30, 20, or 10 millimeters (mm). In some embodiments, the plurality of Arundo grass chips each have a length of about 150 millimeters (mm) to about 10 mm. In some embodiments, the plurality of Arundo grass chips each have a length of about 50 millimeters (mm) to about 10 mm. In some embodiments, the plurality of Arundo grass comprises stalks characterized by a moisture level of about 5% to about 65%, by volume or by weight, as determined by a biomass moisture meter. In some embodiments, the method further comprises washing the plurality of Arundo grass chips, e.g., with an acid, such as hydrochlorine (HCl). In some embodiments, the Arundo grass stalks have been made substantially free of leaves using a defoliant agent, such as ethephon, mechanically, such as using a sugar cane harvester, or manually. In some embodiments, the method further comprises orienting the Arundo grass stalks prior to cutting. In some embodiments, further comprises sorting the Arundo grass stalks by diameter. In some embodiments, the Arundo grass stalks have been sorted by diameter. In some embodiments, further comprises drying the Arundo grass chips.

Another aspect, described herein is a composition comprising, by weight, at least about 10%, 20%, 30%, 40%, 50%, 60%, 70%, 80%, or 90% Arundo fibers characterized by at least one of: (i) the Arundo fibers comprise, by weight, no more than about 0.05-0.15% one or more chlorine content(s); (ii) the Arundo fibers comprise, by weight, a sugar content of about 5% to about 32%; (iii) the Arundo fibers comprise, by weight, a cellulose content of about 25% to about 49%; (iv) the Arundo fibers comprise, by weight, a hemicellulose content of about 9% to about 28%; and (v) the Arundo fibers comprise, by weight, a lignin content of about 15% to about 22%; (vi) the Arundo fibers have a Young's modulus of about 5 gigapascals (GPa) to about 30 GPa as determined by an American Society for Testing and Materials (ASTM) Standard method; (vii) the Arundo fibers have a Shear modulus of about 0.8 megapascals (MPa) to about 12 MPa as determined by an American Society for Testing and Materials (ASTM) Standard method;

In some embodiments, the Arundo fibers are characterized by at least two of (i)-(vii). In some embodiments, the Arundo fibers are characterized by at least three of (i)-(vii). In some embodiments, the Arundo fibers are characterized by at least four of (i)-(vii). In some embodiments, the Arundo fibers are characterized by at least five of (i)-(vii). In some embodiments, the Arundo fibers are characterized by at least six of (i)-(vii). In some embodiments, the Arundo fibers are characterized by (i)-(vii). In some embodiments, wherein the Arundo fibers comprise, by (e.g., dry or wet) weight, no more than about 8% ash content(s).

In some embodiments, the Arundo fibers comprise, by weight, no more than about 300 mg/kg sodium content(s). In some embodiments, the composition of any one of claims 81-89, wherein the Arundo fibers comprise, by weight, no more than about 15,500 mg/kg potassium content(s). In some embodiments, the composition is a weed control mat. In some embodiments, the composition is an absorptive pellet. In some embodiments, the composition is a combustion pellet. In some embodiments, the composition is a flooring material. In some embodiments, the composition is a structural beam. In some embodiments, the composition is a fiberboard. In some embodiments, the composition is a fiber reinforcement in a composite. In some embodiments, the composition is an oriented strand board (OSB). In some embodiments, the composition is a bioplastic. In some embodiments, the composition is an insulation material. In some embodiments, the composition is a particle board. In some embodiments, the composition is a bioplastic. In some embodiments, the composition is a fire retardant. In some embodiments, the composition is an animal feed. In some embodiments, the composition is a biochar. In some embodiments, the composition is an aggregate. In some embodiments, the composition is a pulp. In some embodiments, the composition is a paper product (e.g., packaging, toilet paper, paper towels, tissue, or a combination thereof). In some embodiments, the composition is a fabric.

In some embodiments, the composition is a weaving. In some embodiments, the composition is a biofuel material. In some embodiments, the composition is a biochemical material. In some embodiments, the composition is a wood replacement material. In some embodiments, the composition is a bamboo replacement material. In some embodiments, the composition is a corn replacement material. In some embodiments, the composition is a reinforcement material.

In another aspect described herein are oriented strand boards comprising material obtained from an Arundo grass plant. In some embodiments, the oriented strand boards comprise randomly oriented, orthogonally oriented, or parallel oriented strands of Arundo grass plant. In some embodiments, the oriented strand boards comprise a binding agent, the oriented strands being bound together by the binding agent.

In some embodiments, the Arundo grass plant strands are at least 10% of a total composition of the oriented strand board. In some embodiments, the Arundo grass plant strands are at least 30% of a total composition of the oriented strand board. In some embodiments, the Arundo grass plant strands are at least 50% of a total composition of the oriented strand board. In some embodiments, the Arundo grass plant strands are at least 80% of a total composition of the oriented strand board. In some embodiments, the binding agent is no more than about 10% of the total composition of the oriented strand board.

In some embodiments, the strands are randomly oriented. In some embodiments, the strands are orthogonally oriented. In some embodiments, the strands are parallel oriented. In some embodiments, the strands are oriented according to a predetermined periodic rotation of adjacent strands relative to each other. In some embodiments, the binding agent is polymeric 4,4′-diphenylmethane diisocyanate.

In another aspect, described herein are particle boards comprising material from an Arundo grass plant. In some embodiments, the particle boards comprise a plurality of particles. In some embodiments, the particle boards comprise a binding agent, the binding agent binding adjacent particles of the plurality of particles together to form the particle board. In some embodiments, the particles comprising at least 10% of Arundo grass plant particles.

In some embodiments, an average internal bonding strength of the particle board is at least 50 psi when tested for core failure by ASTM D1037-2012. In some embodiments, an average internal bonding strength of the particle board is at least 80 psi when tested for core failure by ASTM D1037-2012. In some embodiments, an average internal bonding strength of the particle board is at least 100 psi when tested for core failure by ASTM D1037-2012. In some embodiments, a moisture content of the particle board is less than about 50% water sorption after 24 hours when tested by ASTM D1037-2012.

In some embodiments, the particle board has a mean modulus of elasticity is about 200,000-400,000 psi. In some embodiments, the particle board has a mean modulus of rupture of at least about 1000 psi. In some embodiments, the particle board has a mean modulus of rupture of at about 1000-2000 psi. In some embodiments, the particle board has a mean strain at breaking point of at least about 0.001%. In some embodiments, the particle board has a mean strain at breaking point of about 0.001-0.01%.

In some embodiments, the particle board has an average internal bonding strength of at least 60 psi. In some embodiments, the particle board has a mean density of at least 20 lb/ft². In some embodiments, the particle board has a mean density of about 20-100 lb/ft². In some embodiments, the particle board has a mean density of about 45 lb/ft². In some embodiments, the binding agent is polymeric 4,4′-diphenylmethane diisocyanate.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIG. 1 illustrates shoot structures of example Arundo donax produced using methods described herein.

FIG. 2 illustrates example Arundo donax planting units with multiple shoot structures produced according to methods described herein.

FIG. 3 illustrates example Arundo donax planting units of various sizes produced according to methods described herein.

FIG. 4 illustrates an example of a cold hardy phenotype of Arundo donax produced according to methods described herein. As seen in the example, this phenotype survives when covered with snow.

FIG. 5 illustrates example pellets made with Arundo donax and produced according to methods described herein.

FIG. 6A illustrates an example medium density fiber board made with Arundo donax by methods described herein.

FIG. 6B illustrates an example particle board made with Arundo donax by methods described herein.

FIG. 7 illustrates example pulp for paper production made from Arundo donax by methods described herein.

FIG. 8 illustrates example paper samples made from Arundo donax by methods described herein.

FIG. 9 illustrates an example oriented strand board made from Arundo donax.

FIG. 10A illustrates bending strength of an example Arundo donax (identified on the charts as “Xano fiber”) oriented strand board (OSB) compared to wood and hemp and agricultural waste OSB at various compositions.

FIG. 10B illustrates bending test results for OSB made with Arundo donax.

FIG. 11A illustrates chipped Arundo donax.

FIG. 11B illustrates length variations of Arundo donax chips.

FIG. 12 illustrates an example Arundo donax cane without leaves produced by methods described herein.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

Certain inventive embodiments herein contemplate numerical ranges. When ranges are present, the ranges include the range endpoints. Additionally, every sub range and value within the range is present as if explicitly written out. The term “about” or “approximately” may mean within an acceptable error range for the particular value, which will depend in part on how the value is measured or determined, e.g., the limitations of the measurement system. For example, “about” may mean within 1 or more than 1 standard deviation, per the practice in the art. Alternatively, “about” may mean a range of up to 20%, up to 10%, up to 5%, or up to 1% of a given value. Where particular values are described in the application and claims, unless otherwise stated the term “about” meaning within an acceptable error range for the particular value may be assumed.

As used herein, “publications” shall include publications by the American Society for Testing and Materials (ASTM) identified herein by their ASTM number (e.g. ASTM E1876-22, ASTM D570, or ASTM D1037-2012) each of which are hereby incorporated by reference in their entirety.

As used herein, the term “plant hormone(s)” is intended to include natural or synthetic hormone(s) and generally refers to naturally occurring (endogenous) substance(s) that promote, inhibit, or modify plant growth and development. The terms “plant hormone(s)” and “phytohormone(s)” are used interchangeably herein.

As used herein, the term “plant growth regulator(s)” generally refers to synthetic substance(s) that promote, inhibit, or modify plant growth and development.

As used herein, the term “auxin(s)” generally refers to natural or synthetic substance(s) that promote, inhibit, or modify plant growth and development, particularly elongation of plant cells. One of skill in the art will understand that the term “plant hormone(s) and (plant) growth regulator(s)” or “plant hormone(s) or (plant) growth regulator(s),” as used herein, is sufficiently broad to cover auxin(s).

As used herein, the term “solution” generally refers to a liquid with or without suspended substances. Non-limiting examples of a “solution” with suspended substances can include a suspension (such as a colloidal suspension, or a cell suspension), an emulsion, etc.

As used herein, the term “chip” may refer to any portion of a harvested Arundo plant, which has been made smaller than the initially harvested plant by a processing step such as, but not limited to, cutting, chopping, grinding, milling, breaking, or pulverizing. Examples of chips may include but are not limited to powder, dust, strands, pellets, flakes, and fines. Chips may have a distribution of sizes, volumes, and aspect ratios or may be of uniform size, volume, or aspect ratio.

### Arundo Plant Explants

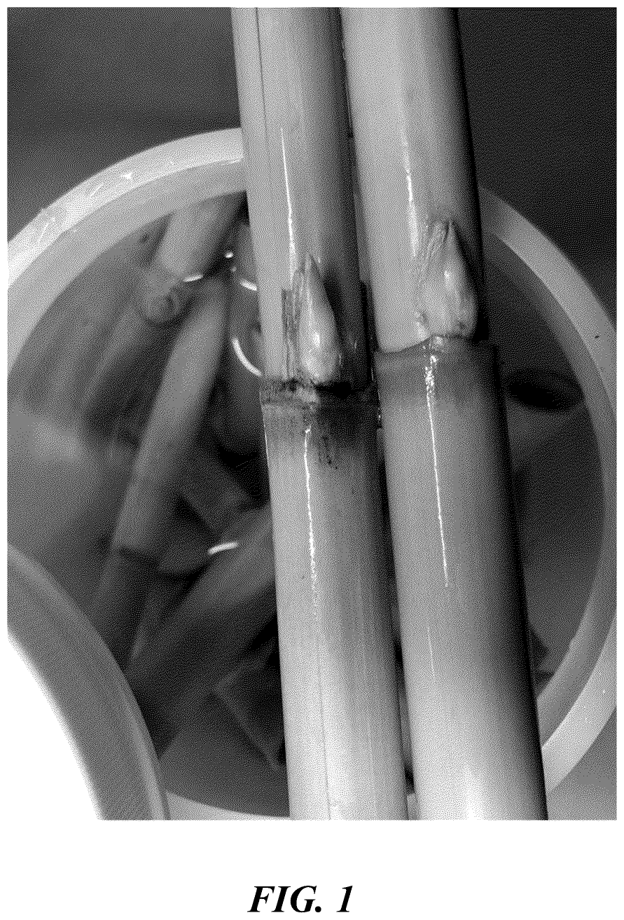

Some embodiments described herein are related to an Arundo plant explant, for example as seen in FIG. 1. In some embodiments, the Arundo plant explant described herein can comprise one or more members selected from the group consisting of apical meristem, cotyledon, young leaf, hypocotyl, ovule, stem, mature leaf, flower, flower stalk, root, bulb, germinated seed, rhizome, and cambial meristematic cell (CMC). In some embodiments, the Arundo plant explant described herein can comprise a CMC. In some embodiments, the Arundo plant explant described herein can comprise cambial meristematic cell (CMC) and one or more members selected from the group consisting of apical meristem, cotyledon, young leaf, hypocotyl, ovule, stem, mature leaf, flower, flower stalk, root, bulb, rhizome, and germinated seed. The Arundo plant explant can be a sample of a living Arundo plant, such as a sample removed from a living Arundo plant. In some cases where the Arundo plant explant is a sample removed from a living plant, the surface of the Arundo plant can be sterilized prior to removing the sample. In some cases, the explant can be sterilized after removal. The Arundo plant explant can be in a medium for preserving, maintaining, or culturing the Arundo explant. In some cases, the medium can be a sterile culture medium. In some embodiments, the medium can be a solid medium, a semi-solid medium, a gel medium, or a liquid medium.

### Methods

Provided herein, in some embodiments, are methods for growth or production of Arundo grass plants. In some embodiments, the Arundo grass plant may be produced by a hydroponic culture. In some embodiments, the Arundo grass plant may be produced from seeds. In some embodiments, the Arundo grass plant may be produced by propagation of stalks. In some embodiments, the Arundo grass plant may be produced by propagation of nodes. In some embodiments, the Arundo grass plant may be produced by vegetative propagation. In some embodiments, the Arundo grass plant may be produced by propagation of rhizomes. In some embodiments, the Arundo grass plant may be produced by propagation of culm nodes. In some embodiments, the Arundo grass plant may be produced by cloning.

In some embodiments, the Arundo grass plant may be Arundo collina. In some embodiments, the Arundo grass plant may be Arundo donax. In some embodiments, the Arundo grass plant may be Arundo formosana. In some embodiments, the Arundo grass plant may be Arundo mediterranea. In some embodiments, the Arundo grass plant may be Arundo micrantha. In some embodiments, the Arundo grass plant may be Arundo micrantha Lam. In some embodiments, the Arundo grass plant may be Arundo plinii. In some embodiments, the Arundo grass plant may be Arundo collina. In some embodiments, the Arundo grass plant may be Arundo phragmites.

### Hydroponic Cultures

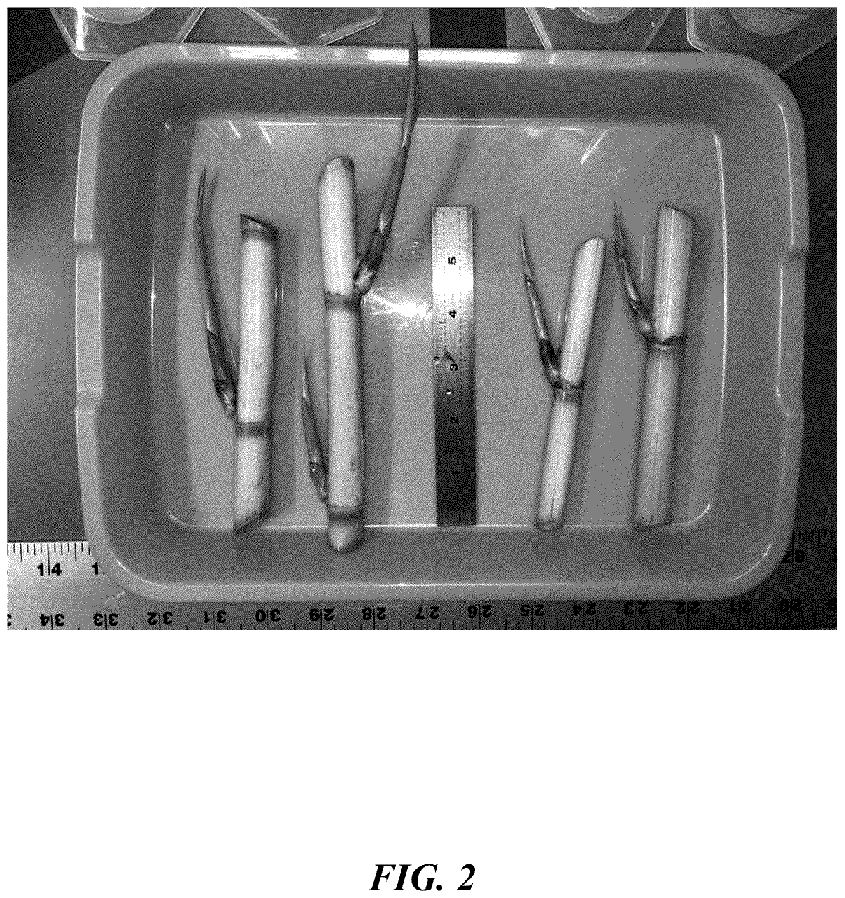

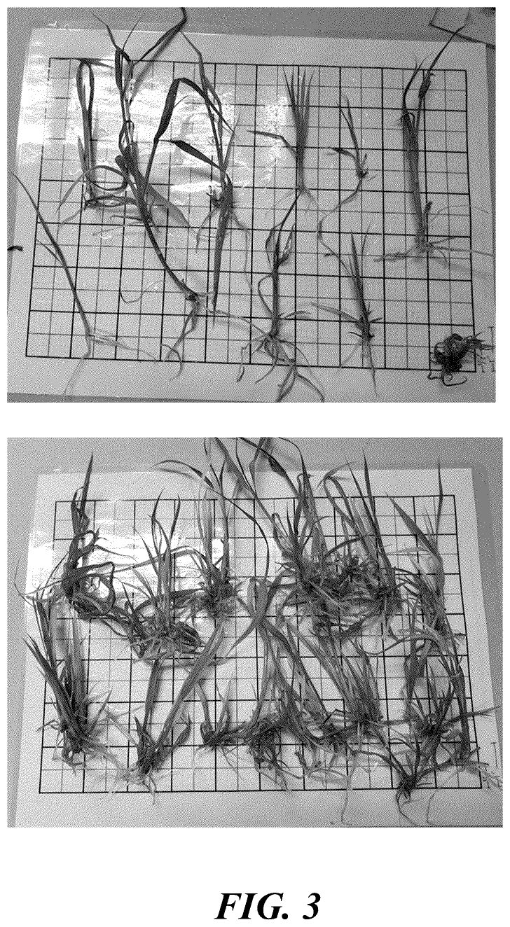

In one aspect provided herein, the hydroponic cultures may be produced by propagation of hydroponic clone units, which may comprise rhizomes, nodes, or stalks of an Arundo grass plant. For example, FIG. 2 shows Arundo donax planting units with multiple shoot structures and FIG. 3 shows Arundo donax planting units of various sizes. The hydroponic clone unit may be subjected to growing conditions which may comprise one or more grow lights, one or more ambient temperatures, and one or more irrigation systems, which may provide a liquid source to the rhizomes, nodes, or stalks. The grow lights, irrigation systems, and ambient temperatures may each independently be controlled to maintain a constant or variable set of growth conditions. The growth conditions may comprise one or more individual combinations of growth parameters for operating the grow lights, temperature controls, or irrigations systems.

The liquid source may comprise water. The liquid source may comprise a source of one or more nutrients. The one or more nutrients can comprise a source of one or more of the following elements: nitrogen, phosphorous, potassium, calcium source, magnesium, iron, copper, a zinc, boron, molybdenum, and/or manganese. The one or more nutrients can comprise a carbon source (e.g., a carbohydrate, elemental carbon, or a carbon salt). The one or more nutrients can comprise a plant and/or cell growth media. The one or more nutrients may promote propagation of the hydroponic clone unit. The grow lights may comprise sunlight. The grow lights may comprise commercially available broadband or ultra-violet light sources. The irrigation system may comprise one or more recirculating pumps. The irrigation system may comprise placing still liquid into the same container as the hydroponic planting unit. The irrigation system may comprise submerging or partially submerging the hydroponic planting unit into the liquid. The irrigation system may comprise a temperature control which maintains the liquid temperature at approximately the ambient temperature.

The hydroponic clone units may be subjected to the growth conditions for a root establishment duration. The hydroponic clone units may yield Arundo grass planting units after being subjected to the growth conditions. The planting units may comprise a root structure or a shoot structure. The planting units may comprise both a root structure and a shoot structure. The planting units may be stored for future use. The planting units may have a lifespan of about 20 years.

In some embodiments, the Arundo grass planting units are grown for a period of about 30 days to about 1,500 days. In some embodiments, the Arundo grass planting units are grown for a period of about 30 days to about 60 days, about 30 days to about 90 days, about 30 days to about 180 days, about 30 days to about 300 days, about 30 days to about 400 days, about 30 days to about 500 days, about 30 days to about 600 days, about 30 days to about 700 days, about 30 days to about 1,000 days, about 30 days to about 1,200 days, about 30 days to about 1,500 days, about 60 days to about 90 days, about 60 days to about 180 days, about 60 days to about 300 days, about 60 days to about 400 days, about 60 days to about 500 days, about 60 days to about 600 days, about 60 days to about 700 days, about 60 days to about 1,000 days, about 60 days to about 1,200 days, about 60 days to about 1,500 days, about 90 days to about 180 days, about 90 days to about 300 days, about 90 days to about 400 days, about 90 days to about 500 days, about 90 days to about 600 days, about 90 days to about 700 days, about 90 days to about 1,000 days, about 90 days to about 1,200 days, about 90 days to about 1,500 days, about 180 days to about 300 days, about 180 days to about 400 days, about 180 days to about 500 days, about 180 days to about 600 days, about 180 days to about 700 days, about 180 days to about 1,000 days, about 180 days to about 1,200 days, about 180 days to about 1,500 days, about 300 days to about 400 days, about 300 days to about 500 days, about 300 days to about 600 days, about 300 days to about 700 days, about 300 days to about 1,000 days, about 300 days to about 1,200 days, about 300 days to about 1,500 days, about 400 days to about 500 days, about 400 days to about 600 days, about 400 days to about 700 days, about 400 days to about 1,000 days, about 400 days to about 1,200 days, about 400 days to about 1,500 days, about 500 days to about 600 days, about 500 days to about 700 days, about 500 days to about 1,000 days, about 500 days to about 1,200 days, about 500 days to about 1,500 days, about 600 days to about 700 days, about 600 days to about 1,000 days, about 600 days to about 1,200 days, about 600 days to about 1,500 days, about 700 days to about 1,000 days, about 700 days to about 1,200 days, about 700 days to about 1,500 days, about 1,000 days to about 1,200 days, about 1,000 days to about 1,500 days, or about 1,200 days to about 1,500 days. In some embodiments, the Arundo grass planting units are grown for a period of about 30 days, about 60 days, about 90 days, about 180 days, about 300 days, about 400 days, about 500 days, about 600 days, about 700 days, about 1,000 days, about 1,200 days, or about 1,500 days. In some embodiments, the Arundo grass planting units are grown for a period of at least about 30 days, about 60 days, about 90 days, about 180 days, about 300 days, about 400 days, about 500 days, about 600 days, about 700 days, about 1,000 days, or about 1,200 days. In some embodiments, the Arundo grass planting units are grown for a period of at most about 60 days, about 90 days, about 180 days, about 300 days, about 400 days, about 500 days, about 600 days, about 700 days, about 1,000 days, about 1,200 days, or about 1,500 days.

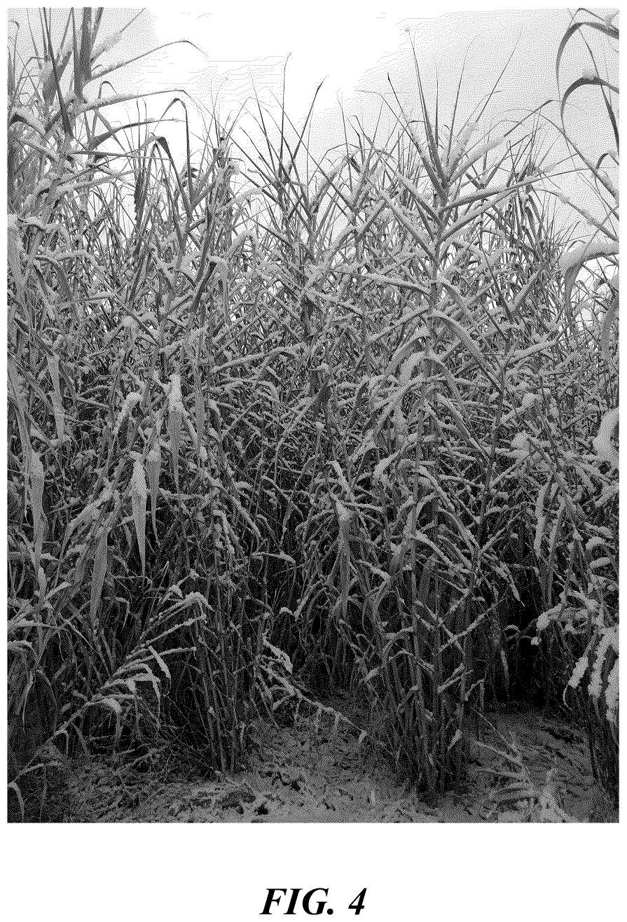

The hydroponic clone units may be selected for phenotypes of particular advantage. In some embodiments the phenotype may be a high-yield phenotype. In some embodiments, the phenotype may be a drought-resistant phenotype. In some embodiments, the phenotype may be a saline-tolerant phenotype. In some embodiments, the phenotype may be a low nutrient requiring phenotype. In some embodiments, the phenotype may be a cold-tolerant phenotype. For example, the phenotype may be the cold-tolerant phenotype shown in FIG. 4. The cold-tolerant phenotype may comprise rhizomes, which can survive in freezing temperatures.

In some embodiments, the grow lights may have an illumination level of no more than about 50 foot-candles to about 2,000 foot-candles. In some embodiments, the grow lights may have an illumination level of no more than about 50 foot-candles to about 100 foot-candles, about 50 foot-candles to about 200 foot-candles, about 50 foot-candles to about 300 foot-candles, about 50 foot-candles to about 400 foot-candles, about 50 foot-candles to about 500 foot-candles, about 50 foot-candles to about 600 foot-candles, about 50 foot-candles to about 700 foot-candles, about 50 foot-candles to about 800 foot-candles, about 50 foot-candles to about 900 foot-candles, about 50 foot-candles to about 1,000 foot-candles, about 50 foot-candles to about 2,000 foot-candles, about 100 foot-candles to about 200 foot-candles, about 100 foot-candles to about 300 foot-candles, about 100 foot-candles to about 400 foot-candles, about 100 foot-candles to about 500 foot-candles, about 100 foot-candles to about 600 foot-candles, about 100 foot-candles to about 700 foot-candles, about 100 foot-candles to about 800 foot-candles, about 100 foot-candles to about 900 foot-candles, about 100 foot-candles to about 1,000 foot-candles, about 100 foot-candles to about 2,000 foot-candles, about 200 foot-candles to about 300 foot-candles, about 200 foot-candles to about 400 foot-candles, about 200 foot-candles to about 500 foot-candles, about 200 foot-candles to about 600 foot-candles, about 200 foot-candles to about 700 foot-candles, about 200 foot-candles to about 800 foot-candles, about 200 foot-candles to about 900 foot-candles, about 200 foot-candles to about 1,000 foot-candles, about 200 foot-candles to about 2,000 foot-candles, about 300 foot-candles to about 400 foot-candles, about 300 foot-candles to about 500 foot-candles, about 300 foot-candles to about 600 foot-candles, about 300 foot-candles to about 700 foot-candles, about 300 foot-candles to about 800 foot-candles, about 300 foot-candles to about 900 foot-candles, about 300 foot-candles to about 1,000 foot-candles, about 300 foot-candles to about 2,000 foot-candles, about 400 foot-candles to about 500 foot-candles, about 400 foot-candles to about 600 foot-candles, about 400 foot-candles to about 700 foot-candles, about 400 foot-candles to about 800 foot-candles, about 400 foot-candles to about 900 foot-candles, about 400 foot-candles to about 1,000 foot-candles, about 400 foot-candles to about 2,000 foot-candles, about 500 foot-candles to about 600 foot-candles, about 500 foot-candles to about 700 foot-candles, about 500 foot-candles to about 800 foot-candles, about 500 foot-candles to about 900 foot-candles, about 500 foot-candles to about 1,000 foot-candles, about 500 foot-candles to about 2,000 foot-candles, about 600 foot-candles to about 700 foot-candles, about 600 foot-candles to about 800 foot-candles, about 600 foot-candles to about 900 foot-candles, about 600 foot-candles to about 1,000 foot-candles, about 600 foot-candles to about 2,000 foot-candles, about 700 foot-candles to about 800 foot-candles, about 700 foot-candles to about 900 foot-candles, about 700 foot-candles to about 1,000 foot-candles, about 700 foot-candles to about 2,000 foot-candles, about 800 foot-candles to about 900 foot-candles, about 800 foot-candles to about 1,000 foot-candles, about 800 foot-candles to about 2,000 foot-candles, about 900 foot-candles to about 1,000 foot-candles, about 900 foot-candles to about 2,000 foot-candles, or about 1,000 foot-candles to about 2,000 foot-candles. In some embodiments, the grow lights may have an illumination level of no more than about 50 foot-candles, about 100 foot-candles, about 200 foot-candles, about 300 foot-candles, about 400 foot-candles, about 500 foot-candles, about 600 foot-candles, about 700 foot-candles, about 800 foot-candles, about 900 foot-candles, about 1,000 foot-candles, or about 2,000 foot-candles. In some embodiments, the grow lights may have an illumination level of no more than at least about 50 foot-candles, about 100 foot-candles, about 200 foot-candles, about 300 foot-candles, about 400 foot-candles, about 500 foot-candles, about 600 foot-candles, about 700 foot-candles, about 800 foot-candles, about 900 foot-candles, or about 1,000 foot-candles. In some embodiments, the grow lights may have an illumination level of no more than at most about 100 foot-candles, about 200 foot-candles, about 300 foot-candles, about 400 foot-candles, about 500 foot-candles, about 600 foot-candles, about 700 foot-candles, about 800 foot-candles, about 900 foot-candles, about 1,000 foot-candles, or about 2,000 foot-candles.

In some embodiments, the hydroponic growing conditions may comprise subjecting Arundo grass clone units to a temperature of about 45° F. to about 95° F. In some embodiments, the hydroponic growing conditions may comprise subjecting Arundo grass clone units to a temperature of about 45° F. to about 50° F., about 45° F. to about 55° F., about 45° F. to about 60° F., about 45° F. to about 65° F., about 45° F. to about 68° F., about 45° F. to about 70° F., about 45° F. to about 75° F., about 45° F. to about 80° F., about 45° F. to about 85° F., about 45° F. to about 90° F., about 45° F. to about 95° F., about 50° F. to about 55° F., about 50° F. to about 60° F., about 50° F. to about 65° F., about 50° F. to about 68° F., about 50° F. to about 70° F., about 50° F. to about 75° F., about 50° F. to about 80° F., about 50° F. to about 85° F., about 50° F. to about 90° F., about 50° F. to about 95° F., about 55° F. to about 60° F., about 55° F. to about 65° F., about 55° F. to about 68° F., about 55° F. to about 70° F., about 55° F. to about 75° F., about 55° F. to about 80° F., about 55° F. to about 85° F., about 55° F. to about 90° F., about 55° F. to about 95° F., about 60° F. to about 65° F., about 60° F. to about 68° F., about 60° F. to about 70° F., about 60° F. to about 75° F., about 60° F. to about 80° F., about 60° F. to about 85° F., about 60° F. to about 90° F., about 60° F. to about 95° F., about 65° F. to about 68° F., about 65° F. to about 70° F., about 65° F. to about 75° F., about 65° F. to about 80° F., about 65° F. to about 85° F., about 65° F. to about 90° F., about 65° F. to about 95° F., about 68° F. to about 70° F., about 68° F. to about 75° F., about 68° F. to about 80° F., about 68° F. to about 85° F., about 68° F. to about 90° F., about 68° F. to about 95° F., about 70° F. to about 75° F., about 70° F. to about 80° F., about 70° F. to about 85° F., about 70° F. to about 90° F., about 70° F. to about 95° F., about 75° F. to about 80° F., about 75° F. to about 85° F., about 75° F. to about 90° F., about 75° F. to about 95° F., about 80° F. to about 85° F., about 80° F. to about 90° F., about 80° F. to about 95° F., about 85° F. to about 90° F., about 85° F. to about 95° F., or about 90° F. to about 95° F. In some embodiments, the hydroponic growing conditions may comprise subjecting Arundo grass clone units to a temperature of about 45° F., about 50° F., about 55° F., about 60° F., about 65° F., about 68° F., about 70° F., about 75° F., about 80° F., about 85° F., about 90° F., or about 95° F. In some embodiments, the hydroponic growing conditions may comprise subjecting Arundo grass clone units to a temperature of at least about 45° F., about 50° F., about 55° F., about 60° F., about 65° F., about 68° F., about 70° F., about 75° F., about 80° F., about 85° F., or about 90° F. In some embodiments, the hydroponic growing conditions may comprise subjecting Arundo grass clone units to a temperature of at most about 50° F., about 55° F., about 60° F., about 65° F., about 68° F., about 70° F., about 75° F., about 80° F., about 85° F., about 90° F., or about 95° F.

In some embodiments, the root establishment duration may be about 1 day to about 30 days. In some embodiments, the root establishment duration may be about 1 day to about 2 days, about 1 day to about 3 days, about 1 day to about 4 days, about 1 day to about 5 days, about 1 day to about 6 days, about 1 day to about 7 days, about 1 day to about 10 days, about 1 day to about 14 days, about 1 day to about 19 days, about 1 day to about 21 days, about 1 day to about 30 days, about 2 days to about 3 days, about 2 days to about 4 days, about 2 days to about 5 days, about 2 days to about 6 days, about 2 days to about 7 days, about 2 days to about 10 days, about 2 days to about 14 days, about 2 days to about 19 days, about 2 days to about 21 days, about 2 days to about 30 days, about 3 days to about 4 days, about 3 days to about 5 days, about 3 days to about 6 days, about 3 days to about 7 days, about 3 days to about 10 days, about 3 days to about 14 days, about 3 days to about 19 days, about 3 days to about 21 days, about 3 days to about 30 days, about 4 days to about 5 days, about 4 days to about 6 days, about 4 days to about 7 days, about 4 days to about 10 days, about 4 days to about 14 days, about 4 days to about 19 days, about 4 days to about 21 days, about 4 days to about 30 days, about 5 days to about 6 days, about 5 days to about 7 days, about 5 days to about 10 days, about 5 days to about 14 days, about 5 days to about 19 days, about 5 days to about 21 days, about 5 days to about 30 days, about 6 days to about 7 days, about 6 days to about 10 days, about 6 days to about 14 days, about 6 days to about 19 days, about 6 days to about 21 days, about 6 days to about 30 days, about 7 days to about 10 days, about 7 days to about 14 days, about 7 days to about 19 days, about 7 days to about 21 days, about 7 days to about 30 days, about 10 days to about 14 days, about 10 days to about 19 days, about 10 days to about 21 days, about 10 days to about 30 days, about 14 days to about 19 days, about 14 days to about 21 days, about 14 days to about 30 days, about 19 days to about 21 days, about 19 days to about 30 days, or about 21 days to about 30 days. In some embodiments, the root establishment duration may be about 1 day, about 2 days, about 3 days, about 4 days, about 5 days, about 6 days, about 7 days, about 10 days, about 14 days, about 19 days, about 21 days, or about 30 days. In some embodiments, the root establishment duration may be at least about 1 day, about 2 days, about 3 days, about 4 days, about 5 days, about 6 days, about 7 days, about 10 days, about 14 days, about 19 days, or about 21 days. In some embodiments, the root establishment duration may be at most about 2 days, about 3 days, about 4 days, about 5 days, about 6 days, about 7 days, about 10 days, about 14 days, about 19 days, about 21 days, or about 30 days.

In some embodiments, the at least about 5% of the planting units may be sterile to about 99% of the planting units may be sterile. In some embodiments, the at least about 5% of the planting units may be sterile to about 10% of the planting units may be sterile, about 5% of the planting units may be sterile to about 20% of the planting units may be sterile, about 5% of the planting units may be sterile to about 30% of the planting units may be sterile, about 5% of the planting units may be sterile to about 40% of the planting units may be sterile, about 5% of the planting units may be sterile to about 50% of the planting units may be sterile, about 5% of the planting units may be sterile to about 60% of the planting units may be sterile, about 5% of the planting units may be sterile to about 70% of the planting units may be sterile, about 5% of the planting units may be sterile to about 80% of the planting units may be sterile, about 5% of the planting units may be sterile to about 90% of the planting units may be sterile, about 5% of the planting units may be sterile to about 95% of the planting units may be sterile, about 5% of the planting units may be sterile to about 99% of the planting units may be sterile, about 10% of the planting units may be sterile to about 20% of the planting units may be sterile, about 10% of the planting units may be sterile to about 30% of the planting units may be sterile, about 10% of the planting units may be sterile to about 40% of the planting units may be sterile, about 10% of the planting units may be sterile to about 50% of the planting units may be sterile, about 10% of the planting units may be sterile to about 60% of the planting units may be sterile, about 10% of the planting units may be sterile to about 70% of the planting units may be sterile, about 10% of the planting units may be sterile to about 80% of the planting units may be sterile, about 10% of the planting units may be sterile to about 90% of the planting units may be sterile, about 10% of the planting units may be sterile to about 95% of the planting units may be sterile, about 10% of the planting units may be sterile to about 99% of the planting units may be sterile, about 20% of the planting units may be sterile to about 30% of the planting units may be sterile, about 20% of the planting units may be sterile to about 40% of the planting units may be sterile, about 20% of the planting units may be sterile to about 50% of the planting units may be sterile, about 20% of the planting units may be sterile to about 60% of the planting units may be sterile, about 20% of the planting units may be sterile to about 70% of the planting units may be sterile, about 20% of the planting units may be sterile to about 80% of the planting units may be sterile, about 20% of the planting units may be sterile to about 90% of the planting units may be sterile, about 20% of the planting units may be sterile to about 95% of the planting units may be sterile, about 20% of the planting units may be sterile to about 99% of the planting units may be sterile, about 30% of the planting units may be sterile to about 40% of the planting units may be sterile, about 30% of the planting units may be sterile to about 50% of the planting units may be sterile, about 30% of the planting units may be sterile to about 60% of the planting units may be sterile, about 30% of the planting units may be sterile to about 70% of the planting units may be sterile, about 30% of the planting units may be sterile to about 80% of the planting units may be sterile, about 30% of the planting units may be sterile to about 90% of the planting units may be sterile, about 30% of the planting units may be sterile to about 95% of the planting units may be sterile, about 30% of the planting units may be sterile to about 99% of the planting units may be sterile, about 40% of the planting units may be sterile to about 50% of the planting units may be sterile, about 40% of the planting units may be sterile to about 60% of the planting units may be sterile, about 40% of the planting units may be sterile to about 70% of the planting units may be sterile, about 40% of the planting units may be sterile to about 80% of the planting units may be sterile, about 40% of the planting units may be sterile to about 90% of the planting units may be sterile, about 40% of the planting units may be sterile to about 95% of the planting units may be sterile, about 40% of the planting units may be sterile to about 99% of the planting units may be sterile, about 50% of the planting units may be sterile to about 60% of the planting units may be sterile, about 50% of the planting units may be sterile to about 70% of the planting units may be sterile, about 50% of the planting units may be sterile to about 80% of the planting units may be sterile, about 50% of the planting units may be sterile to about 90% of the planting units may be sterile, about 50% of the planting units may be sterile to about 95% of the planting units may be sterile, about 50% of the planting units may be sterile to about 99% of the planting units may be sterile, about 60% of the planting units may be sterile to about 70% of the planting units may be sterile, about 60% of the planting units may be sterile to about 80% of the planting units may be sterile, about 60% of the planting units may be sterile to about 90% of the planting units may be sterile, about 60% of the planting units may be sterile to about 95% of the planting units may be sterile, about 60% of the planting units may be sterile to about 99% of the planting units may be sterile, about 70% of the planting units may be sterile to about 80% of the planting units may be sterile, about 70% of the planting units may be sterile to about 90% of the planting units may be sterile, about 70% of the planting units may be sterile to about 95% of the planting units may be sterile, about 70% of the planting units may be sterile to about 99% of the planting units may be sterile, about 80% of the planting units may be sterile to about 90% of the planting units may be sterile, about 80% of the planting units may be sterile to about 95% of the planting units may be sterile, about 80% of the planting units may be sterile to about 99% of the planting units may be sterile, about 90% of the planting units may be sterile to about 95% of the planting units may be sterile, about 90% of the planting units may be sterile to about 99% of the planting units may be sterile, or about 95% of the planting units may be sterile to about 99% of the planting units may be sterile. In some embodiments, the at least about 5% of the planting units may be sterile, about 10% of the planting units may be sterile, about 20% of the planting units may be sterile, about 30% of the planting units may be sterile, about 40% of the planting units may be sterile, about 50% of the planting units may be sterile, about 60% of the planting units may be sterile, about 70% of the planting units may be sterile, about 80% of the planting units may be sterile, about 90% of the planting units may be sterile, about 95% of the planting units may be sterile, or about 99% of the planting units may be sterile. In some embodiments, the at least at least about 5% of the planting units may be sterile, about 10% of the planting units may be sterile, about 20% of the planting units may be sterile, about 30% of the planting units may be sterile, about 40% of the planting units may be sterile, about 50% of the planting units may be sterile, about 60% of the planting units may be sterile, about 70% of the planting units may be sterile, about 80% of the planting units may be sterile, about 90% of the planting units may be sterile, or about 95% of the planting units may be sterile. In some embodiments, the at least at most about 10% of the planting units may be sterile, about 20% of the planting units may be sterile, about 30% of the planting units may be sterile, about 40% of the planting units may be sterile, about 50% of the planting units may be sterile, about 60% of the planting units may be sterile, about 70% of the planting units may be sterile, about 80% of the planting units may be sterile, about 90% of the planting units may be sterile, about 95% of the planting units may be sterile, or about 99% of the planting units may be sterile.

In some embodiments, the planting units may comprise at least about 10% of the drought-resistant phenotype to about 100% of the drought-resistant phenotype. In some embodiments, the planting units may comprise at least about 10% of the drought-resistant phenotype to about 20% of the drought-resistant phenotype, about 10% of the drought-resistant phenotype to about 30% of the drought-resistant phenotype, about 10% of the drought-resistant phenotype to about 40% of the drought-resistant phenotype, about 10% of the drought-resistant phenotype to about 50% of the drought-resistant phenotype, about 10% of the drought-resistant phenotype to about 60% of the drought-resistant phenotype, about 10% of the drought-resistant phenotype to about 70% of the drought-resistant phenotype, about 10% of the drought-resistant phenotype to about 80% of the drought-resistant phenotype, about 10% of the drought-resistant phenotype to about 90% of the drought-resistant phenotype, about 10% of the drought-resistant phenotype to about 95% of the drought-resistant phenotype, about 10% of the drought-resistant phenotype to about 100% of the drought-resistant phenotype, about 20% of the drought-resistant phenotype to about 30% of the drought-resistant phenotype, about 20% of the drought-resistant phenotype to about 40% of the drought-resistant phenotype, about 20% of the drought-resistant phenotype to about 50% of the drought-resistant phenotype, about 20% of the drought-resistant phenotype to about 60% of the drought-resistant phenotype, about 20% of the drought-resistant phenotype to about 70% of the drought-resistant phenotype, about 20% of the drought-resistant phenotype to about 80% of the drought-resistant phenotype, about 20% of the drought-resistant phenotype to about 90% of the drought-resistant phenotype, about 20% of the drought-resistant phenotype to about 95% of the drought-resistant phenotype, about 20% of the drought-resistant phenotype to about 100% of the drought-resistant phenotype, about 30% of the drought-resistant phenotype to about 40% of the drought-resistant phenotype, about 30% of the drought-resistant phenotype to about 50% of the drought-resistant phenotype, about 30% of the drought-resistant phenotype to about 60% of the drought-resistant phenotype, about 30% of the drought-resistant phenotype to about 70% of the drought-resistant phenotype, about 30% of the drought-resistant phenotype to about 80% of the drought-resistant phenotype, about 30% of the drought-resistant phenotype to about 90% of the drought-resistant phenotype, about 30% of the drought-resistant phenotype to about 95% of the drought-resistant phenotype, about 30% of the drought-resistant phenotype to about 100% of the drought-resistant phenotype, about 40% of the drought-resistant phenotype to about 50% of the drought-resistant phenotype, about 40% of the drought-resistant phenotype to about 60% of the drought-resistant phenotype, about 40% of the drought-resistant phenotype to about 70% of the drought-resistant phenotype, about 40% of the drought-resistant phenotype to about 80% of the drought-resistant phenotype, about 40% of the drought-resistant phenotype to about 90% of the drought-resistant phenotype, about 40% of the drought-resistant phenotype to about 95% of the drought-resistant phenotype, about 40% of the drought-resistant phenotype to about 100% of the drought-resistant phenotype, about 50% of the drought-resistant phenotype to about 60% of the drought-resistant phenotype, about 50% of the drought-resistant phenotype to about 70% of the drought-resistant phenotype, about 50% of the drought-resistant phenotype to about 80% of the drought-resistant phenotype, about 50% of the drought-resistant phenotype to about 90% of the drought-resistant phenotype, about 50% of the drought-resistant phenotype to about 95% of the drought-resistant phenotype, about 50% of the drought-resistant phenotype to about 100% of the drought-resistant phenotype, about 60% of the drought-resistant phenotype to about 70% of the drought-resistant phenotype, about 60% of the drought-resistant phenotype to about 80% of the drought-resistant phenotype, about 60% of the drought-resistant phenotype to about 90% of the drought-resistant phenotype, about 60% of the drought-resistant phenotype to about 95% of the drought-resistant phenotype, about 60% of the drought-resistant phenotype to about 100% of the drought-resistant phenotype, about 70% of the drought-resistant phenotype to about 80% of the drought-resistant phenotype, about 70% of the drought-resistant phenotype to about 90% of the drought-resistant phenotype, about 70% of the drought-resistant phenotype to about 95% of the drought-resistant phenotype, about 70% of the drought-resistant phenotype to about 100% of the drought-resistant phenotype, about 80% of the drought-resistant phenotype to about 90% of the drought-resistant phenotype, about 80% of the drought-resistant phenotype to about 95% of the drought-resistant phenotype, about 80% of the drought-resistant phenotype to about 100% of the drought-resistant phenotype, about 90% of the drought-resistant phenotype to about 95% of the drought-resistant phenotype, about 90% of the drought-resistant phenotype to about 100% of the drought-resistant phenotype, or about 95% of the drought-resistant phenotype to about 100% of the drought-resistant phenotype. In some embodiments, the planting units may comprise at least about 10% of the drought-resistant phenotype, about 20% of the drought-resistant phenotype, about 30% of the drought-resistant phenotype, about 40% of the drought-resistant phenotype, about 50% of the drought-resistant phenotype, about 60% of the drought-resistant phenotype, about 70% of the drought-resistant phenotype, about 80% of the drought-resistant phenotype, about 90% of the drought-resistant phenotype, about 95% of the drought-resistant phenotype, or about 100% of the drought-resistant phenotype. In some embodiments, the planting units may comprise at least at least about 10% of the drought-resistant phenotype, about 20% of the drought-resistant phenotype, about 30% of the drought-resistant phenotype, about 40% of the drought-resistant phenotype, about 50% of the drought-resistant phenotype, about 60% of the drought-resistant phenotype, about 70% of the drought-resistant phenotype, about 80% of the drought-resistant phenotype, about 90% of the drought-resistant phenotype, or about 95% of the drought-resistant phenotype. In some embodiments, the planting units may comprise at least at most about 20% of the drought-resistant phenotype, about 30% of the drought-resistant phenotype, about 40% of the drought-resistant phenotype, about 50% of the drought-resistant phenotype, about 60% of the drought-resistant phenotype, about 70% of the drought-resistant phenotype, about 80% of the drought-resistant phenotype, about 90% of the drought-resistant phenotype, about 95% of the drought-resistant phenotype, or about 100% of the drought-resistant phenotype.

In some embodiments, the planting units may comprise at least about 10% of the high-yield phenotype to about 100% of the high-yield phenotype. In some embodiments, the planting units may comprise at least about 10% of the high-yield phenotype to about 20% of the high-yield phenotype, about 10% of the high-yield phenotype to about 30% of the high-yield phenotype, about 10% of the high-yield phenotype to about 40% of the high-yield phenotype, about 10% of the high-yield phenotype to about 50% of the high-yield phenotype, about 10% of the high-yield phenotype to about 60% of the high-yield phenotype, about 10% of the high-yield phenotype to about 70% of the high-yield phenotype, about 10% of the high-yield phenotype to about 80% of the high-yield phenotype, about 10% of the high-yield phenotype to about 90% of the high-yield phenotype, about 10% of the high-yield phenotype to about 95% of the high-yield phenotype, about 10% of the high-yield phenotype to about 100% of the high-yield phenotype, about 20% of the high-yield phenotype to about 30% of the high-yield phenotype, about 20% of the high-yield phenotype to about 40% of the high-yield phenotype, about 20% of the high-yield phenotype to about 50% of the high-yield phenotype, about 20% of the high-yield phenotype to about 60% of the high-yield phenotype, about 20% of the high-yield phenotype to about 70% of the high-yield phenotype, about 20% of the high-yield phenotype to about 80% of the high-yield phenotype, about 20% of the high-yield phenotype to about 90% of the high-yield phenotype, about 20% of the high-yield phenotype to about 95% of the high-yield phenotype, about 20% of the high-yield phenotype to about 100% of the high-yield phenotype, about 30% of the high-yield phenotype to about 40% of the high-yield phenotype, about 30% of the high-yield phenotype to about 50% of the high-yield phenotype, about 30% of the high-yield phenotype to about 60% of the high-yield phenotype, about 30% of the high-yield phenotype to about 70% of the high-yield phenotype, about 30% of the high-yield phenotype to about 80% of the high-yield phenotype, about 30% of the high-yield phenotype to about 90% of the high-yield phenotype, about 30% of the high-yield phenotype to about 95% of the high-yield phenotype, about 30% of the high-yield phenotype to about 100% of the high-yield phenotype, about 40% of the high-yield phenotype to about 50% of the high-yield phenotype, about 40% of the high-yield phenotype to about 60% of the high-yield phenotype, about 40% of the high-yield phenotype to about 70% of the high-yield phenotype, about 40% of the high-yield phenotype to about 80% of the high-yield phenotype, about 40% of the high-yield phenotype to about 90% of the high-yield phenotype, about 40% of the high-yield phenotype to about 95% of the high-yield phenotype, about 40% of the high-yield phenotype to about 100% of the high-yield phenotype, about 50% of the high-yield phenotype to about 60% of the high-yield phenotype, about 50% of the high-yield phenotype to about 70% of the high-yield phenotype, about 50% of the high-yield phenotype to about 80% of the high-yield phenotype, about 50% of the high-yield phenotype to about 90% of the high-yield phenotype, about 50% of the high-yield phenotype to about 95% of the high-yield phenotype, about 50% of the high-yield phenotype to about 100% of the high-yield phenotype, about 60% of the high-yield phenotype to about 70% of the high-yield phenotype, about 60% of the high-yield phenotype to about 80% of the high-yield phenotype, about 60% of the high-yield phenotype to about 90% of the high-yield phenotype, about 60% of the high-yield phenotype to about 95% of the high-yield phenotype, about 60% of the high-yield phenotype to about 100% of the high-yield phenotype, about 70% of the high-yield phenotype to about 80% of the high-yield phenotype, about 70% of the high-yield phenotype to about 90% of the high-yield phenotype, about 70% of the high-yield phenotype to about 95% of the high-yield phenotype, about 70% of the high-yield phenotype to about 100% of the high-yield phenotype, about 80% of the high-yield phenotype to about 90% of the high-yield phenotype, about 80% of the high-yield phenotype to about 95% of the high-yield phenotype, about 80% of the high-yield phenotype to about 100% of the high-yield phenotype, about 90% of the high-yield phenotype to about 95% of the high-yield phenotype, about 90% of the high-yield phenotype to about 100% of the high-yield phenotype, or about 95% of the high-yield phenotype to about 100% of the high-yield phenotype. In some embodiments, the planting units may comprise at least about 10% of the high-yield phenotype, about 20% of the high-yield phenotype, about 30% of the high-yield phenotype, about 40% of the high-yield phenotype, about 50% of the high-yield phenotype, about 60% of the high-yield phenotype, about 70% of the high-yield phenotype, about 80% of the high-yield phenotype, about 90% of the high-yield phenotype, about 95% of the high-yield phenotype, or about 100% of the high-yield phenotype. In some embodiments, the planting units may comprise at least at least about 10% of the high-yield phenotype, about 20% of the high-yield phenotype, about 30% of the high-yield phenotype, about 40% of the high-yield phenotype, about 50% of the high-yield phenotype, about 60% of the high-yield phenotype, about 70% of the high-yield phenotype, about 80% of the high-yield phenotype, about 90% of the high-yield phenotype, or about 95% of the high-yield phenotype. In some embodiments, the planting units may comprise at least at most about 20% of the high-yield phenotype, about 30% of the high-yield phenotype, about 40% of the high-yield phenotype, about 50% of the high-yield phenotype, about 60% of the high-yield phenotype, about 70% of the high-yield phenotype, about 80% of the high-yield phenotype, about 90% of the high-yield phenotype, about 95% of the high-yield phenotype, or about 100% of the high-yield phenotype.

In some embodiments, the planting units may comprise at least about 10% of the saline-tolerant phenotype to about 100% of the saline-tolerant phenotype. In some embodiments, the planting units may comprise at least about 10% of the saline-tolerant phenotype to about 20% of the saline-tolerant phenotype, about 10% of the saline-tolerant phenotype to about 30% of the saline-tolerant phenotype, about 10% of the saline-tolerant phenotype to about 40% of the saline-tolerant phenotype, about 10% of the saline-tolerant phenotype to about 50% of the saline-tolerant phenotype, about 10% of the saline-tolerant phenotype to about 60% of the saline-tolerant phenotype, about 10% of the saline-tolerant phenotype to about 70% of the saline-tolerant phenotype, about 10% of the saline-tolerant phenotype to about 80% of the saline-tolerant phenotype, about 10% of the saline-tolerant phenotype to about 90% of the saline-tolerant phenotype, about 10% of the saline-tolerant phenotype to about 95% of the saline-tolerant phenotype, about 10% of the saline-tolerant phenotype to about 100% of the saline-tolerant phenotype, about 20% of the saline-tolerant phenotype to about 30% of the saline-tolerant phenotype, about 20% of the saline-tolerant phenotype to about 40% of the saline-tolerant phenotype, about 20% of the saline-tolerant phenotype to about 50% of the saline-tolerant phenotype, about 20% of the saline-tolerant phenotype to about 60% of the saline-tolerant phenotype, about 20% of the saline-tolerant phenotype to about 70% of the saline-tolerant phenotype, about 20% of the saline-tolerant phenotype to about 80% of the saline-tolerant phenotype, about 20% of the saline-tolerant phenotype to about 90% of the saline-tolerant phenotype, about 20% of the saline-tolerant phenotype to about 95% of the saline-tolerant phenotype, about 20% of the saline-tolerant phenotype to about 100% of the saline-tolerant phenotype, about 30% of the saline-tolerant phenotype to about 40% of the saline-tolerant phenotype, about 30% of the saline-tolerant phenotype to about 50% of the saline-tolerant phenotype, about 30% of the saline-tolerant phenotype to about 60% of the saline-tolerant phenotype, about 30% of the saline-tolerant phenotype to about 70% of the saline-tolerant phenotype, about 30% of the saline-tolerant phenotype to about 80% of the saline-tolerant phenotype, about 30% of the saline-tolerant phenotype to about 90% of the saline-tolerant phenotype, about 30% of the saline-tolerant phenotype to about 95% of the saline-tolerant phenotype, about 30% of the saline-tolerant phenotype to about 100% of the saline-tolerant phenotype, about 40% of the saline-tolerant phenotype to about 50% of the saline-tolerant phenotype, about 40% of the saline-tolerant phenotype to about 60% of the saline-tolerant phenotype, about 40% of the saline-tolerant phenotype to about 70% of the saline-tolerant phenotype, about 40% of the saline-tolerant phenotype to about 80% of the saline-tolerant phenotype, about 40% of the saline-tolerant phenotype to about 90% of the saline-tolerant phenotype, about 40% of the saline-tolerant phenotype to about 95% of the saline-tolerant phenotype, about 40% of the saline-tolerant phenotype to about 100% of the saline-tolerant phenotype, about 50% of the saline-tolerant phenotype to about 60% of the saline-tolerant phenotype, about 50% of the saline-tolerant phenotype to about 70% of the saline-tolerant phenotype, about 50% of the saline-tolerant phenotype to about 80% of the saline-tolerant phenotype, about 50% of the saline-tolerant phenotype to about 90% of the saline-tolerant phenotype, about 50% of the saline-tolerant phenotype to about 95% of the saline-tolerant phenotype, about 50% of the saline-tolerant phenotype to about 100% of the saline-tolerant phenotype, about 60% of the saline-tolerant phenotype to about 70% of the saline-tolerant phenotype, about 60% of the saline-tolerant phenotype to about 80% of the saline-tolerant phenotype, about 60% of the saline-tolerant phenotype to about 90% of the saline-tolerant phenotype, about 60% of the saline-tolerant phenotype to about 95% of the saline-tolerant phenotype, about 60% of the saline-tolerant phenotype to about 100% of the saline-tolerant phenotype, about 70% of the saline-tolerant phenotype to about 80% of the saline-tolerant phenotype, about 70% of the saline-tolerant phenotype to about 90% of the saline-tolerant phenotype, about 70% of the saline-tolerant phenotype to about 95% of the saline-tolerant phenotype, about 70% of the saline-tolerant phenotype to about 100% of the saline-tolerant phenotype, about 80% of the saline-tolerant phenotype to about 90% of the saline-tolerant phenotype, about 80% of the saline-tolerant phenotype to about 95% of the saline-tolerant phenotype, about 80% of the saline-tolerant phenotype to about 100% of the saline-tolerant phenotype, about 90% of the saline-tolerant phenotype to about 95% of the saline-tolerant phenotype, about 90% of the saline-tolerant phenotype to about 100% of the saline-tolerant phenotype, or about 95% of the saline-tolerant phenotype to about 100% of the saline-tolerant phenotype. In some embodiments, the planting units may comprise at least about 10% of the saline-tolerant phenotype, about 20% of the saline-tolerant phenotype, about 30% of the saline-tolerant phenotype, about 40% of the saline-tolerant phenotype, about 50% of the saline-tolerant phenotype, about 60% of the saline-tolerant phenotype, about 70% of the saline-tolerant phenotype, about 80% of the saline-tolerant phenotype, about 90% of the saline-tolerant phenotype, about 95% of the saline-tolerant phenotype, or about 100% of the saline-tolerant phenotype. In some embodiments, the planting units may comprise at least at least about 10% of the saline-tolerant phenotype, about 20% of the saline-tolerant phenotype, about 30% of the saline-tolerant phenotype, about 40% of the saline-tolerant phenotype, about 50% of the saline-tolerant phenotype, about 60% of the saline-tolerant phenotype, about 70% of the saline-tolerant phenotype, about 80% of the saline-tolerant phenotype, about 90% of the saline-tolerant phenotype, or about 95% of the saline-tolerant phenotype. In some embodiments, the planting units may comprise at least at most about 20% of the saline-tolerant phenotype, about 30% of the saline-tolerant phenotype, about 40% of the saline-tolerant phenotype, about 50% of the saline-tolerant phenotype, about 60% of the saline-tolerant phenotype, about 70% of the saline-tolerant phenotype, about 80% of the saline-tolerant phenotype, about 90% of the saline-tolerant phenotype, about 95% of the saline-tolerant phenotype, or about 100% of the saline-tolerant phenotype.

In some embodiments, the planting units may comprise at least about 10% of the low nutrient requirement phenotype to about 100% of the low nutrient requirement phenotype. In some embodiments, the planting units may comprise at least about 10% of the low nutrient requirement phenotype to about 20% of the low nutrient requirement phenotype, about 10% of the low nutrient requirement phenotype to about 30% of the low nutrient requirement phenotype, about 10% of the low nutrient requirement phenotype to about 40% of the low nutrient requirement phenotype, about 10% of the low nutrient requirement phenotype to about 50% of the low nutrient requirement phenotype, about 10% of the low nutrient requirement phenotype to about 60% of the low nutrient requirement phenotype, about 10% of the low nutrient requirement phenotype to about 70% of the low nutrient requirement phenotype, about 10% of the low nutrient requirement phenotype to about 80% of the low nutrient requirement phenotype, about 10% of the low nutrient requirement phenotype to about 90% of the low nutrient requirement phenotype, about 10% of the low nutrient requirement phenotype to about 95% of the low nutrient requirement phenotype, about 10% of the low nutrient requirement phenotype to about 100% of the low nutrient requirement phenotype, about 20% of the low nutrient requirement phenotype to about 30% of the low nutrient requirement phenotype, about 20% of the low nutrient requirement phenotype to about 40% of the low nutrient requirement phenotype, about 20% of the low nutrient requirement phenotype to about 50% of the low nutrient requirement phenotype, about 20% of the low nutrient requirement phenotype to about 60% of the low nutrient requirement phenotype, about 20% of the low nutrient requirement phenotype to about 70% of the low nutrient requirement phenotype, about 20% of the low nutrient requirement phenotype to about 80% of the low nutrient requirement phenotype, about 20% of the low nutrient requirement phenotype to about 90% of the low nutrient requirement phenotype, about 20% of the low nutrient requirement phenotype to about 95% of the low nutrient requirement phenotype, about 20% of the low nutrient requirement phenotype to about 100% of the low nutrient requirement phenotype, about 30% of the low nutrient requirement phenotype to about 40% of the low nutrient requirement phenotype, about 30% of the low nutrient requirement phenotype to about 50% of the low nutrient requirement phenotype, about 30% of the low nutrient requirement phenotype to about 60% of the low nutrient requirement phenotype, about 30% of the low nutrient requirement phenotype to about 70% of the low nutrient requirement phenotype, about 30% of the low nutrient requirement phenotype to about 80% of the low nutrient requirement phenotype, about 30% of the low nutrient requirement phenotype to about 90% of the low nutrient requirement phenotype, about 30% of the low nutrient requirement phenotype to about 95% of the low nutrient requirement phenotype, about 30% of the low nutrient requirement phenotype to about 100% of the low nutrient requirement phenotype, about 40% of the low nutrient requirement phenotype to about 50% of the low nutrient requirement phenotype, about 40% of the low nutrient requirement phenotype to about 60% of the low nutrient requirement phenotype, about 40% of the low nutrient requirement phenotype to about 70% of the low nutrient requirement phenotype, about 40% of the low nutrient requirement phenotype to about 80% of the low nutrient requirement phenotype, about 40% of the low nutrient requirement phenotype to about 90% of the low nutrient requirement phenotype, about 40% of the low nutrient requirement phenotype to about 95% of the low nutrient requirement phenotype, about 40% of the low nutrient requirement phenotype to about 100% of the low nutrient requirement phenotype, about 50% of the low nutrient requirement phenotype to about 60% of the low nutrient requirement phenotype, about 50% of the low nutrient requirement phenotype to about 70% of the low nutrient requirement phenotype, about 50% of the low nutrient requirement phenotype to about 80% of the low nutrient requirement phenotype, about 50% of the low nutrient requirement phenotype to about 90% of the low nutrient requirement phenotype, about 50% of the low nutrient requirement phenotype to about 95% of the low nutrient requirement phenotype, about 50% of the low nutrient requirement phenotype to about 100% of the low nutrient requirement phenotype, about 60% of the low nutrient requirement phenotype to about 70% of the low nutrient requirement phenotype, about 60% of the low nutrient requirement phenotype to about 80% of the low nutrient requirement phenotype, about 60% of the low nutrient requirement phenotype to about 90% of the low nutrient requirement phenotype, about 60% of the low nutrient requirement phenotype to about 95% of the low nutrient requirement phenotype, about 60% of the low nutrient requirement phenotype to about 100% of the low nutrient requirement phenotype, about 70% of the low nutrient requirement phenotype to about 80% of the low nutrient requirement phenotype, about 70% of the low nutrient requirement phenotype to about 90% of the low nutrient requirement phenotype, about 70% of the low nutrient requirement phenotype to about 95% of the low nutrient requirement phenotype, about 70% of the low nutrient requirement phenotype to about 100% of the low nutrient requirement phenotype, about 80% of the low nutrient requirement phenotype to about 90% of the low nutrient requirement phenotype, about 80% of the low nutrient requirement phenotype to about 95% of the low nutrient requirement phenotype, about 80% of the low nutrient requirement phenotype to about 100% of the low nutrient requirement phenotype, about 90% of the low nutrient requirement phenotype to about 95% of the low nutrient requirement phenotype, about 90% of the low nutrient requirement phenotype to about 100% of the low nutrient requirement phenotype, or about 95% of the low nutrient requirement phenotype to about 100% of the low nutrient requirement phenotype. In some embodiments, the planting units may comprise at least about 10% of the low nutrient requirement phenotype, about 20% of the low nutrient requirement phenotype, about 30% of the low nutrient requirement phenotype, about 40% of the low nutrient requirement phenotype, about 50% of the low nutrient requirement phenotype, about 60% of the low nutrient requirement phenotype, about 70% of the low nutrient requirement phenotype, about 80% of the low nutrient requirement phenotype, about 90% of the low nutrient requirement phenotype, about 95% of the low nutrient requirement phenotype, or about 100% of the low nutrient requirement phenotype. In some embodiments, the planting units may comprise at least at least about 10% of the low nutrient requirement phenotype, about 20% of the low nutrient requirement phenotype, about 30% of the low nutrient requirement phenotype, about 40% of the low nutrient requirement phenotype, about 50% of the low nutrient requirement phenotype, about 60% of the low nutrient requirement phenotype, about 70% of the low nutrient requirement phenotype, about 80% of the low nutrient requirement phenotype, about 90% of the low nutrient requirement phenotype, or about 95% of the low nutrient requirement phenotype. In some embodiments, the planting units may comprise at least at most about 20% of the low nutrient requirement phenotype, about 30% of the low nutrient requirement phenotype, about 40% of the low nutrient requirement phenotype, about 50% of the low nutrient requirement phenotype, about 60% of the low nutrient requirement phenotype, about 70% of the low nutrient requirement phenotype, about 80% of the low nutrient requirement phenotype, about 90% of the low nutrient requirement phenotype, about 95% of the low nutrient requirement phenotype, or about 100% of the low nutrient requirement phenotype.

In some embodiments, at least about 5% of the Arundo grass planting units may comprise a root structure to about 99% of the Arundo grass planting units may comprise a root structure. In some embodiments, at least about 5% of the Arundo grass planting units may comprise a root structure to about 10% of the Arundo grass planting units may comprise a root structure, about 5% of the Arundo grass planting units may comprise a root structure to about 20% of the Arundo grass planting units may comprise a root structure, about 5% of the Arundo grass planting units may comprise a root structure to about 30% of the Arundo grass planting units may comprise a root structure, about 5% of the Arundo grass planting units may comprise a root structure to about 40% of the Arundo grass planting units may comprise a root structure, about 5% of the Arundo grass planting units may comprise a root structure to about 50% of the Arundo grass planting units may comprise a root structure, about 5% of the Arundo grass planting units may comprise a root structure to about 60% of the Arundo grass planting units may comprise a root structure, about 5% of the Arundo grass planting units may comprise a root structure to about 70% of the Arundo grass planting units may comprise a root structure, about 5% of the Arundo grass planting units may comprise a root structure to about 80% of the Arundo grass planting units may comprise a root structure, about 5% of the Arundo grass planting units may comprise a root structure to about 90% of the Arundo grass planting units may comprise a root structure, about 5% of the Arundo grass planting units may comprise a root structure to about 95% of the Arundo grass planting units may comprise a root structure, about 5% of the Arundo grass planting units may comprise a root structure to about 99% of the Arundo grass planting units may comprise a root structure, about 10% of the Arundo grass planting units may comprise a root structure to about 20% of the Arundo grass planting units may comprise a root structure, about 10% of the Arundo grass planting units may comprise a root structure to about 30% of the Arundo grass planting units may comprise a root structure, about 10% of the Arundo grass planting units may comprise a root structure to about 40% of the Arundo grass planting units may comprise a root structure, about 10% of the Arundo grass planting units may comprise a root structure to about 50% of the Arundo grass planting units may comprise a root structure, about 10% of the Arundo grass planting units may comprise a root structure to about 60% of the Arundo grass planting units may comprise a root structure, about 10% of the Arundo grass planting units may comprise a root structure to about 70% of the Arundo grass planting units may comprise a root structure, about 10% of the Arundo grass planting units may comprise a root structure to about 80% of the Arundo grass planting units may comprise a root structure, about 10% of the Arundo grass planting units may comprise a root structure to about 90% of the Arundo grass planting units may comprise a root structure, about 10% of the Arundo grass planting units may comprise a root structure to about 95% of the Arundo grass planting units may comprise a root structure, about 10% of the Arundo grass planting units may comprise a root structure to about 99% of the Arundo grass planting units may comprise a root structure, about 20% of the Arundo grass planting units may comprise a root structure to about 30% of the Arundo grass planting units may comprise a root structure, about 20% of the Arundo grass planting units may comprise a root structure to about 40% of the Arundo grass planting units may comprise a root structure, about 20% of the Arundo grass planting units may comprise a root structure to about 50% of the Arundo grass planting units may comprise a root structure, about 20% of the Arundo grass planting units may comprise a root structure to about 60% of the Arundo grass planting units may comprise a root structure, about 20% of the Arundo grass planting units may comprise a root structure to about 70% of the Arundo grass planting units may comprise a root structure, about 20% of the Arundo grass planting units may comprise a root structure to about 80% of the Arundo grass planting units may comprise a root structure, about 20% of the Arundo grass planting units may comprise a root structure to about 90% of the Arundo grass planting units may comprise a root structure, about 20% of the Arundo grass planting units may comprise a root structure to about 95% of the Arundo grass planting units may comprise a root structure, about 20% of the Arundo grass planting units may comprise a root structure to about 99% of the Arundo grass planting units may comprise a root structure, about 30% of the Arundo grass planting units may comprise a root structure to about 40% of the Arundo grass planting units may comprise a root structure, about 30% of the Arundo grass planting units may comprise a root structure to about 50% of the Arundo grass planting units may comprise a root structure, about 30% of the Arundo grass planting units may comprise a root structure to about 60% of the Arundo grass planting units may comprise a root structure, about 30% of the Arundo grass planting units may comprise a root structure to about 70% of the Arundo grass planting units may comprise a root structure, about 30% of the Arundo grass planting units may comprise a root structure to about 80% of the Arundo grass planting units may comprise a root structure, about 30% of the Arundo grass planting units may comprise a root structure to about 90% of the Arundo grass planting units may comprise a root structure, about 30% of the Arundo grass planting units may comprise a root structure to about 95% of the Arundo grass planting units may comprise a root structure, about 30% of the Arundo grass planting units may comprise a root structure to about 99% of the Arundo grass planting units may comprise a root structure, about 40% of the Arundo grass planting units may comprise a root structure to about 50% of the Arundo grass planting units may comprise a root structure, about 40% of the Arundo grass planting units may comprise a root structure to about 60% of the Arundo grass planting units may comprise a root structure, about 40% of the Arundo grass planting units may comprise a root structure to about 70% of the Arundo grass planting units may comprise a root structure, about 40% of the Arundo grass planting units may comprise a root structure to about 80% of the Arundo grass planting units may comprise a root structure, about 40% of the Arundo grass planting units may comprise a root structure to about 90% of the Arundo grass planting units may comprise a root structure, about 40% of the Arundo grass planting units may comprise a root structure to about 95% of the Arundo grass planting units may comprise a root structure, about 40% of the Arundo grass planting units may comprise a root structure to about 99% of the Arundo grass planting units may comprise a root structure, about 50% of the Arundo grass planting units may comprise a root structure to about 60% of the Arundo grass planting units may comprise a root structure, about 50% of the Arundo grass planting units may comprise a root structure to about 70% of the Arundo grass planting units may comprise a root structure, about 50% of the Arundo grass planting units may comprise a root structure to about 80% of the Arundo grass planting units may comprise a root structure, about 50% of the Arundo grass planting units may comprise a root structure to about 90% of the Arundo grass planting units may comprise a root structure, about 50% of the Arundo grass planting units may comprise a root structure to about 95% of the Arundo grass planting units may comprise a root structure, about 50% of the Arundo grass planting units may comprise a root structure to about 99% of the Arundo grass planting units may comprise a root structure, about 60% of the Arundo grass planting units may comprise a root structure to about 70% of the Arundo grass planting units may comprise a root structure, about 60% of the Arundo grass planting units may comprise a root structure to about 80% of the Arundo grass planting units may comprise a root structure, about 60% of the Arundo grass planting units may comprise a root structure to about 90% of the Arundo grass planting units may comprise a root structure, about 60% of the Arundo grass planting units may comprise a root structure to about 95% of the Arundo grass planting units may comprise a root structure, about 60% of the Arundo grass planting units may comprise a root structure to about 99% of the Arundo grass planting units may comprise a root structure, about 70% of the Arundo grass planting units may comprise a root structure to about 80% of the Arundo grass planting units may comprise a root structure, about 70% of the Arundo grass planting units may comprise a root structure to about 90% of the Arundo grass planting units may comprise a root structure, about 70% of the Arundo grass planting units may comprise a root structure to about 95% of the Arundo grass planting units may comprise a root structure, about 70% of the Arundo grass planting units may comprise a root structure to about 99% of the Arundo grass planting units may comprise a root structure, about 80% of the Arundo grass planting units may comprise a root structure to about 90% of the Arundo grass planting units may comprise a root structure, about 80% of the Arundo grass planting units may comprise a root structure to about 95% of the Arundo grass planting units may comprise a root structure, about 80% of the Arundo grass planting units may comprise a root structure to about 99% of the Arundo grass planting units may comprise a root structure, about 90% of the Arundo grass planting units may comprise a root structure to about 95% of the Arundo grass planting units may comprise a root structure, about 90% of the Arundo grass planting units may comprise a root structure to about 99% of the Arundo grass planting units may comprise a root structure, or about 95% of the Arundo grass planting units may comprise a root structure to about 99% of the Arundo grass planting units may comprise a root structure. In some embodiments, at least about 5% of the Arundo grass planting units may comprise a root structure, about 10% of the Arundo grass planting units may comprise a root structure, about 20% of the Arundo grass planting units may comprise a root structure, about 30% of the Arundo grass planting units may comprise a root structure, about 40% of the Arundo grass planting units may comprise a root structure, about 50% of the Arundo grass planting units may comprise a root structure, about 60% of the Arundo grass planting units may comprise a root structure, about 70% of the Arundo grass planting units may comprise a root structure, about 80% of the Arundo grass planting units may comprise a root structure, about 90% of the Arundo grass planting units may comprise a root structure, about 95% of the Arundo grass planting units may comprise a root structure, or about 99% of the Arundo grass planting units may comprise a root structure. In some embodiments, at least at least about 5% of the Arundo grass planting units may comprise a root structure, about 10% of the Arundo grass planting units may comprise a root structure, about 20% of the Arundo grass planting units may comprise a root structure, about 30% of the Arundo grass planting units may comprise a root structure, about 40% of the Arundo grass planting units may comprise a root structure, about 50% of the Arundo grass planting units may comprise a root structure, about 60% of the Arundo grass planting units may comprise a root structure, about 70% of the Arundo grass planting units may comprise a root structure, about 80% of the Arundo grass planting units may comprise a root structure, about 90% of the Arundo grass planting units may comprise a root structure, or about 95% of the Arundo grass planting units may comprise a root structure. In some embodiments, at least at most about 10% of the Arundo grass planting units may comprise a root structure, about 20% of the Arundo grass planting units may comprise a root structure, about 30% of the Arundo grass planting units may comprise a root structure, about 40% of the Arundo grass planting units may comprise a root structure, about 50% of the Arundo grass planting units may comprise a root structure, about 60% of the Arundo grass planting units may comprise a root structure, about 70% of the Arundo grass planting units may comprise a root structure, about 80% of the Arundo grass planting units may comprise a root structure, about 90% of the Arundo grass planting units may comprise a root structure, about 95% of the Arundo grass planting units may comprise a root structure, or about 99% of the Arundo grass planting units may comprise a root structure.

In some embodiments, at least about 5% of the Arundo grass planting units may comprise a shoot structure to about 99% of the Arundo grass planting units may comprise a shoot structure. In some embodiments, at least about 5% of the Arundo grass planting units may comprise a shoot structure to about 10% of the Arundo grass planting units may comprise a shoot structure, about 5% of the Arundo grass planting units may comprise a shoot structure to about 20% of the Arundo grass planting units may comprise a shoot structure, about 5% of the Arundo grass planting units may comprise a shoot structure to about 30% of the Arundo grass planting units may comprise a shoot structure, about 5% of the Arundo grass planting units may comprise a shoot structure to about 40% of the Arundo grass planting units may comprise a shoot structure, about 5% of the Arundo grass planting units may comprise a shoot structure to about 50% of the Arundo grass planting units may comprise a shoot structure, about 5% of the Arundo grass planting units may comprise a shoot structure to about 60% of the Arundo grass planting units may comprise a shoot structure, about 5% of the Arundo grass planting units may comprise a shoot structure to about 70% of the Arundo grass planting units may comprise a shoot structure, about 5% of the Arundo grass planting units may comprise a shoot structure to about 80% of the Arundo grass planting units may comprise a shoot structure, about 5% of the Arundo grass planting units may comprise a shoot structure to about 90% of the Arundo grass planting units may comprise a shoot structure, about 5% of the Arundo grass planting units may comprise a shoot structure to about 95% of the Arundo grass planting units may comprise a shoot structure, about 5% of the Arundo grass planting units may comprise a shoot structure to about 99% of the Arundo grass planting units may comprise a shoot structure, about 10% of the Arundo grass planting units may comprise a shoot structure to about 20% of the Arundo grass planting units may comprise a shoot structure, about 10% of the Arundo grass planting units may comprise a shoot structure to about 30% of the Arundo grass planting units may comprise a shoot structure, about 10% of the Arundo grass planting units may comprise a shoot structure to about 40% of the Arundo grass planting units may comprise a shoot structure, about 10% of the Arundo grass planting units may comprise a shoot structure to about 50% of the Arundo grass planting units may comprise a shoot structure, about 10% of the Arundo grass planting units may comprise a shoot structure to about 60% of the Arundo grass planting units may comprise a shoot structure, about 10% of the Arundo grass planting units may comprise a shoot structure to about 70% of the Arundo grass planting units may comprise a shoot structure, about 10% of the Arundo grass planting units may comprise a shoot structure to about 80% of the Arundo grass planting units may comprise a shoot structure, about 10% of the Arundo grass planting units may comprise a shoot structure to about 90% of the Arundo grass planting units may comprise a shoot structure, about 10% of the Arundo grass planting units may comprise a shoot structure to about 95% of the Arundo grass planting units may comprise a shoot structure, about 10% of the Arundo grass planting units may comprise a shoot structure to about 99% of the Arundo grass planting units may comprise a shoot structure, about 20% of the Arundo grass planting units may comprise a shoot structure to about 30% of the Arundo grass planting units may comprise a shoot structure, about 20% of the Arundo grass planting units may comprise a shoot structure to about 40% of the Arundo grass planting units may comprise a shoot structure, about 20% of the Arundo grass planting units may comprise a shoot structure to about 50% of the Arundo grass planting units may comprise a shoot structure, about 20% of the Arundo grass planting units may comprise a shoot structure to about 60% of the Arundo grass planting units may comprise a shoot structure, about 20% of the Arundo grass planting units may comprise a shoot structure to about 70% of the Arundo grass planting units may comprise a shoot structure, about 20% of the Arundo grass planting units may comprise a shoot structure to about 80% of the Arundo grass planting units may comprise a shoot structure, about 20% of the Arundo grass planting units may comprise a shoot structure to about 90% of the Arundo grass planting units may comprise a shoot structure, about 20% of the Arundo grass planting units may comprise a shoot structure to about 95% of the Arundo grass planting units may comprise a shoot structure, about 20% of the Arundo grass planting units may comprise a shoot structure to about 99% of the Arundo grass planting units may comprise a shoot structure, about 30% of the Arundo grass planting units may comprise a shoot structure to about 40% of the Arundo grass planting units may comprise a shoot structure, about 30% of the Arundo grass planting units may comprise a shoot structure to about 50% of the Arundo grass planting units may comprise a shoot structure, about 30% of the Arundo grass planting units may comprise a shoot structure to about 60% of the Arundo grass planting units may comprise a shoot structure, about 30% of the Arundo grass planting units may comprise a shoot structure to about 70% of the Arundo grass planting units may comprise a shoot structure, about 30% of the Arundo grass planting units may comprise a shoot structure to about 80% of the Arundo grass planting units may comprise a shoot structure, about 30% of the Arundo grass planting units may comprise a shoot structure to about 90% of the Arundo grass planting units may comprise a shoot structure, about 30% of the Arundo grass planting units may comprise a shoot structure to about 95% of the Arundo grass planting units may comprise a shoot structure, about 30% of the Arundo grass planting units may comprise a shoot structure to about 99% of the Arundo grass planting units may comprise a shoot structure, about 40% of the Arundo grass planting units may comprise a shoot structure to about 50% of the Arundo grass planting units may comprise a shoot structure, about 40% of the Arundo grass planting units may comprise a shoot structure to about 60% of the Arundo grass planting units may comprise a shoot structure, about 40% of the Arundo grass planting units may comprise a shoot structure to about 70% of the Arundo grass planting units may comprise a shoot structure, about 40% of the Arundo grass planting units may comprise a shoot structure to about 80% of the Arundo grass planting units may comprise a shoot structure, about 40% of the Arundo grass planting units may comprise a shoot structure to about 90% of the Arundo grass planting units may comprise a shoot structure, about 40% of the Arundo grass planting units may comprise a shoot structure to about 95% of the Arundo grass planting units may comprise a shoot structure, about 40% of the Arundo grass planting units may comprise a shoot structure to about 99% of the Arundo grass planting units may comprise a shoot structure, about 50% of the Arundo grass planting units may comprise a shoot structure to about 60% of the Arundo grass planting units may comprise a shoot structure, about 50% of the Arundo grass planting units may comprise a shoot structure to about 70% of the Arundo grass planting units may comprise a shoot structure, about 50% of the Arundo grass planting units may comprise a shoot structure to about 80% of the Arundo grass planting units may comprise a shoot structure, about 50% of the Arundo grass planting units may comprise a shoot structure to about 90% of the Arundo grass planting units may comprise a shoot structure, about 50% of the Arundo grass planting units may comprise a shoot structure to about 95% of the Arundo grass planting units may comprise a shoot structure, about 50% of the Arundo grass planting units may comprise a shoot structure to about 99% of the Arundo grass planting units may comprise a shoot structure, about 60% of the Arundo grass planting units may comprise a shoot structure to about 70% of the Arundo grass planting units may comprise a shoot structure, about 60% of the Arundo grass planting units may comprise a shoot structure to about 80% of the Arundo grass planting units may comprise a shoot structure, about 60% of the Arundo grass planting units may comprise a shoot structure to about 90% of the Arundo grass planting units may comprise a shoot structure, about 60% of the Arundo grass planting units may comprise a shoot structure to about 95% of the Arundo grass planting units may comprise a shoot structure, about 60% of the Arundo grass planting units may comprise a shoot structure to about 99% of the Arundo grass planting units may comprise a shoot structure, about 70% of the Arundo grass planting units may comprise a shoot structure to about 80% of the Arundo grass planting units may comprise a shoot structure, about 70% of the Arundo grass planting units may comprise a shoot structure to about 90% of the Arundo grass planting units may comprise a shoot structure, about 70% of the Arundo grass planting units may comprise a shoot structure to about 95% of the Arundo grass planting units may comprise a shoot structure, about 70% of the Arundo grass planting units may comprise a shoot structure to about 99% of the Arundo grass planting units may comprise a shoot structure, about 80% of the Arundo grass planting units may comprise a shoot structure to about 90% of the Arundo grass planting units may comprise a shoot structure, about 80% of the Arundo grass planting units may comprise a shoot structure to about 95% of the Arundo grass planting units may comprise a shoot structure, about 80% of the Arundo grass planting units may comprise a shoot structure to about 99% of the Arundo grass planting units may comprise a shoot structure, about 90% of the Arundo grass planting units may comprise a shoot structure to about 95% of the Arundo grass planting units may comprise a shoot structure, about 90% of the Arundo grass planting units may comprise a shoot structure to about 99% of the Arundo grass planting units may comprise a shoot structure, or about 95% of the Arundo grass planting units may comprise a shoot structure to about 99% of the Arundo grass planting units may comprise a shoot structure. In some embodiments, at least about 5% of the Arundo grass planting units may comprise a shoot structure, about 10% of the Arundo grass planting units may comprise a shoot structure, about 20% of the Arundo grass planting units may comprise a shoot structure, about 30% of the Arundo grass planting units may comprise a shoot structure, about 40% of the Arundo grass planting units may comprise a shoot structure, about 50% of the Arundo grass planting units may comprise a shoot structure, about 60% of the Arundo grass planting units may comprise a shoot structure, about 70% of the Arundo grass planting units may comprise a shoot structure, about 80% of the Arundo grass planting units may comprise a shoot structure, about 90% of the Arundo grass planting units may comprise a shoot structure, about 95% of the Arundo grass planting units may comprise a shoot structure, or about 99% of the Arundo grass planting units may comprise a shoot structure. In some embodiments, at least at least about 5% of the Arundo grass planting units may comprise a shoot structure, about 10% of the Arundo grass planting units may comprise a shoot structure, about 20% of the Arundo grass planting units may comprise a shoot structure, about 30% of the Arundo grass planting units may comprise a shoot structure, about 40% of the Arundo grass planting units may comprise a shoot structure, about 50% of the Arundo grass planting units may comprise a shoot structure, about 60% of the Arundo grass planting units may comprise a shoot structure, about 70% of the Arundo grass planting units may comprise a shoot structure, about 80% of the Arundo grass planting units may comprise a shoot structure, about 90% of the Arundo grass planting units may comprise a shoot structure, or about 95% of the Arundo grass planting units may comprise a shoot structure. In some embodiments, at least at most about 10% of the Arundo grass planting units may comprise a shoot structure, about 20% of the Arundo grass planting units may comprise a shoot structure, about 30% of the Arundo grass planting units may comprise a shoot structure, about 40% of the Arundo grass planting units may comprise a shoot structure, about 50% of the Arundo grass planting units may comprise a shoot structure, about 60% of the Arundo grass planting units may comprise a shoot structure, about 70% of the Arundo grass planting units may comprise a shoot structure, about 80% of the Arundo grass planting units may comprise a shoot structure, about 90% of the Arundo grass planting units may comprise a shoot structure, about 95% of the Arundo grass planting units may comprise a shoot structure, or about 99% of the Arundo grass planting units may comprise a shoot structure.

In some embodiments, the Arundo grass planting units are each independently about 1 cm in height to about 50 cm in height. In some embodiments, the Arundo grass planting units are each independently about 1 cm in height to about 2 cm in height, about 1 cm in height to about 3 cm in height, about 1 cm in height to about 4 cm in height, about 1 cm in height to about 5 cm in height, about 1 cm in height to about 6 cm in height, about 1 cm in height to about 7 cm in height, about 1 cm in height to about 8 cm in height, about 1 cm in height to about 9 cm in height, about 1 cm in height to about 10 cm in height, about 1 cm in height to about 30 cm in height, about 1 cm in height to about 50 cm in height, about 2 cm in height to about 3 cm in height, about 2 cm in height to about 4 cm in height, about 2 cm in height to about 5 cm in height, about 2 cm in height to about 6 cm in height, about 2 cm in height to about 7 cm in height, about 2 cm in height to about 8 cm in height, about 2 cm in height to about 9 cm in height, about 2 cm in height to about 10 cm in height, about 2 cm in height to about 30 cm in height, about 2 cm in height to about 50 cm in height, about 3 cm in height to about 4 cm in height, about 3 cm in height to about 5 cm in height, about 3 cm in height to about 6 cm in height, about 3 cm in height to about 7 cm in height, about 3 cm in height to about 8 cm in height, about 3 cm in height to about 9 cm in height, about 3 cm in height to about 10 cm in height, about 3 cm in height to about 30 cm in height, about 3 cm in height to about 50 cm in height, about 4 cm in height to about 5 cm in height, about 4 cm in height to about 6 cm in height, about 4 cm in height to about 7 cm in height, about 4 cm in height to about 8 cm in height, about 4 cm in height to about 9 cm in height, about 4 cm in height to about 10 cm in height, about 4 cm in height to about 30 cm in height, about 4 cm in height to about 50 cm in height, about 5 cm in height to about 6 cm in height, about 5 cm in height to about 7 cm in height, about 5 cm in height to about 8 cm in height, about 5 cm in height to about 9 cm in height, about 5 cm in height to about 10 cm in height, about 5 cm in height to about 30 cm in height, about 5 cm in height to about 50 cm in height, about 6 cm in height to about 7 cm in height, about 6 cm in height to about 8 cm in height, about 6 cm in height to about 9 cm in height, about 6 cm in height to about 10 cm in height, about 6 cm in height to about 30 cm in height, about 6 cm in height to about 50 cm in height, about 7 cm in height to about 8 cm in height, about 7 cm in height to about 9 cm in height, about 7 cm in height to about 10 cm in height, about 7 cm in height to about 30 cm in height, about 7 cm in height to about 50 cm in height, about 8 cm in height to about 9 cm in height, about 8 cm in height to about 10 cm in height, about 8 cm in height to about 30 cm in height, about 8 cm in height to about 50 cm in height, about 9 cm in height to about 10 cm in height, about 9 cm in height to about 30 cm in height, about 9 cm in height to about 50 cm in height, about 10 cm in height to about 30 cm in height, about 10 cm in height to about 50 cm in height, or about 30 cm in height to about 50 cm in height. In some embodiments, the Arundo grass planting units are each independently about 1 cm in height, about 2 cm in height, about 3 cm in height, about 4 cm in height, about 5 cm in height, about 6 cm in height, about 7 cm in height, about 8 cm in height, about 9 cm in height, about 10 cm in height, about 30 cm in height, or about 50 cm in height. In some embodiments, the Arundo grass planting units are each independently at least about 1 cm in height, about 2 cm in height, about 3 cm in height, about 4 cm in height, about 5 cm in height, about 6 cm in height, about 7 cm in height, about 8 cm in height, about 9 cm in height, about 10 cm in height, or about 30 cm in height. In some embodiments, the Arundo grass planting units are each independently at most about 2 cm in height, about 3 cm in height, about 4 cm in height, about 5 cm in height, about 6 cm in height, about 7 cm in height, about 8 cm in height, about 9 cm in height, about 10 cm in height, about 30 cm in height, or about 50 cm in height.

In some embodiments, the Arundo grass planting units may independently have about 1 node to about 30 nodes. In some embodiments, the Arundo grass planting units may independently have about 1 node to about 2 nodes, about 1 node to about 3 nodes, about 1 node to about 4 nodes, about 1 node to about 5 nodes, about 1 node to about 6 nodes, about 1 node to about 7 nodes, about 1 node to about 8 nodes, about 1 node to about 9 nodes, about 1 node to about 10 nodes, about 1 node to about 15 nodes, about 1 node to about 30 nodes, about 2 nodes to about 3 nodes, about 2 nodes to about 4 nodes, about 2 nodes to about 5 nodes, about 2 nodes to about 6 nodes, about 2 nodes to about 7 nodes, about 2 nodes to about 8 nodes, about 2 nodes to about 9 nodes, about 2 nodes to about 10 nodes, about 2 nodes to about 15 nodes, about 2 nodes to about 30 nodes, about 3 nodes to about 4 nodes, about 3 nodes to about 5 nodes, about 3 nodes to about 6 nodes, about 3 nodes to about 7 nodes, about 3 nodes to about 8 nodes, about 3 nodes to about 9 nodes, about 3 nodes to about 10 nodes, about 3 nodes to about 15 nodes, about 3 nodes to about 30 nodes, about 4 nodes to about 5 nodes, about 4 nodes to about 6 nodes, about 4 nodes to about 7 nodes, about 4 nodes to about 8 nodes, about 4 nodes to about 9 nodes, about 4 nodes to about 10 nodes, about 4 nodes to about 15 nodes, about 4 nodes to about 30 nodes, about 5 nodes to about 6 nodes, about 5 nodes to about 7 nodes, about 5 nodes to about 8 nodes, about 5 nodes to about 9 nodes, about 5 nodes to about 10 nodes, about 5 nodes to about 15 nodes, about 5 nodes to about 30 nodes, about 6 nodes to about 7 nodes, about 6 nodes to about 8 nodes, about 6 nodes to about 9 nodes, about 6 nodes to about 10 nodes, about 6 nodes to about 15 nodes, about 6 nodes to about 30 nodes, about 7 nodes to about 8 nodes, about 7 nodes to about 9 nodes, about 7 nodes to about 10 nodes, about 7 nodes to about 15 nodes, about 7 nodes to about 30 nodes, about 8 nodes to about 9 nodes, about 8 nodes to about 10 nodes, about 8 nodes to about 15 nodes, about 8 nodes to about 30 nodes, about 9 nodes to about 10 nodes, about 9 nodes to about 15 nodes, about 9 nodes to about 30 nodes, about 10 nodes to about 15 nodes, about 10 nodes to about 30 nodes, or about 15 nodes to about 30 nodes. In some embodiments, the Arundo grass planting units may independently have about 1 node, about 2 nodes, about 3 nodes, about 4 nodes, about 5 nodes, about 6 nodes, about 7 nodes, about 8 nodes, about 9 nodes, about 10 nodes, about 15 nodes, or about 30 nodes. In some embodiments, the Arundo grass planting units may independently have at least about 1 node, about 2 nodes, about 3 nodes, about 4 nodes, about 5 nodes, about 6 nodes, about 7 nodes, about 8 nodes, about 9 nodes, about 10 nodes, or about 15 nodes. In some embodiments, the Arundo grass planting units may independently have at most about 2 nodes, about 3 nodes, about 4 nodes, about 5 nodes, about 6 nodes, about 7 nodes, about 8 nodes, about 9 nodes, about 10 nodes, about 15 nodes, or about 30 nodes.

In some embodiments, the Arundo grass planting units may each independently be about 1 week old to about 32 weeks old. In some embodiments, the Arundo grass planting units may each independently be about 1 week old to about 2 weeks old, about 1 week old to about 3 weeks old, about 1 week old to about 4 weeks old, about 1 week old to about 5 weeks old, about 1 week old to about 6 weeks old, about 1 week old to about 7 weeks old, about 1 week old to about 8 weeks old, about 1 week old to about 9 weeks old, about 1 week old to about 10 weeks old, about 1 week old to about 16 weeks old, about 1 week old to about 32 weeks old, about 2 weeks old to about 3 weeks old, about 2 weeks old to about 4 weeks old, about 2 weeks old to about 5 weeks old, about 2 weeks old to about 6 weeks old, about 2 weeks old to about 7 weeks old, about 2 weeks old to about 8 weeks old, about 2 weeks old to about 9 weeks old, about 2 weeks old to about 10 weeks old, about 2 weeks old to about 16 weeks old, about 2 weeks old to about 32 weeks old, about 3 weeks old to about 4 weeks old, about 3 weeks old to about 5 weeks old, about 3 weeks old to about 6 weeks old, about 3 weeks old to about 7 weeks old, about 3 weeks old to about 8 weeks old, about 3 weeks old to about 9 weeks old, about 3 weeks old to about 10 weeks old, about 3 weeks old to about 16 weeks old, about 3 weeks old to about 32 weeks old, about 4 weeks old to about 5 weeks old, about 4 weeks old to about 6 weeks old, about 4 weeks old to about 7 weeks old, about 4 weeks old to about 8 weeks old, about 4 weeks old to about 9 weeks old, about 4 weeks old to about 10 weeks old, about 4 weeks old to about 16 weeks old, about 4 weeks old to about 32 weeks old, about 5 weeks old to about 6 weeks old, about 5 weeks old to about 7 weeks old, about 5 weeks old to about 8 weeks old, about 5 weeks old to about 9 weeks old, about 5 weeks old to about 10 weeks old, about 5 weeks old to about 16 weeks old, about 5 weeks old to about 32 weeks old, about 6 weeks old to about 7 weeks old, about 6 weeks old to about 8 weeks old, about 6 weeks old to about 9 weeks old, about 6 weeks old to about 10 weeks old, about 6 weeks old to about 16 weeks old, about 6 weeks old to about 32 weeks old, about 7 weeks old to about 8 weeks old, about 7 weeks old to about 9 weeks old, about 7 weeks old to about 10 weeks old, about 7 weeks old to about 16 weeks old, about 7 weeks old to about 32 weeks old, about 8 weeks old to about 9 weeks old, about 8 weeks old to about 10 weeks old, about 8 weeks old to about 16 weeks old, about 8 weeks old to about 32 weeks old, about 9 weeks old to about 10 weeks old, about 9 weeks old to about 16 weeks old, about 9 weeks old to about 32 weeks old, about 10 weeks old to about 16 weeks old, about 10 weeks old to about 32 weeks old, or about 16 weeks old to about 32 weeks old. In some embodiments, the Arundo grass planting units may each independently be about 1 week old, about 2 weeks old, about 3 weeks old, about 4 weeks old, about 5 weeks old, about 6 weeks old, about 7 weeks old, about 8 weeks old, about 9 weeks old, about 10 weeks old, about 16 weeks old, or about 32 weeks old. In some embodiments, the Arundo grass planting units may each independently be at least about 1 week old, about 2 weeks old, about 3 weeks old, about 4 weeks old, about 5 weeks old, about 6 weeks old, about 7 weeks old, about 8 weeks old, about 9 weeks old, about 10 weeks old, or about 16 weeks old. In some embodiments, the Arundo grass planting units may each independently be at most about 2 weeks old, about 3 weeks old, about 4 weeks old, about 5 weeks old, about 6 weeks old, about 7 weeks old, about 8 weeks old, about 9 weeks old, about 10 weeks old, about 16 weeks old, or about 32 weeks old.

### Field Production

In certain aspects, described herein are methods of producing Arundo grass biomass from planting units. Production of biomass may comprise contacting the planting units with soil. In some embodiments the contacting may be manual planting. In some embodiments, the contacting may be accomplished by mechanical planting approaches.

In some embodiments, the distance between planting units may be less than about 0.01 m to about 5 m. In some embodiments, the distance between planting units may be less than about 0.01 m to about 0.05 m, about 0.01 m to about 0.1 m, about 0.01 m to about 0.5 m, about 0.01 m to about 1 m, about 0.01 m to about 1.5 m, about 0.01 m to about 2 m, about 0.01 m to about 2.5 m, about 0.01 m to about 3 m, about 0.01 m to about 3.5 m, about 0.01 m to about 4 m, about 0.01 m to about 5 m, about 0.05 m to about 0.1 m, about 0.05 m to about 0.5 m, about 0.05 m to about 1 m, about 0.05 m to about 1.5 m, about 0.05 m to about 2 m, about 0.05 m to about 2.5 m, about 0.05 m to about 3 m, about 0.05 m to about 3.5 m, about 0.05 m to about 4 m, about 0.05 m to about 5 m, about 0.1 m to about 0.5 m, about 0.1 m to about 1 m, about 0.1 m to about 1.5 m, about 0.1 m to about 2 m, about 0.1 m to about 2.5 m, about 0.1 m to about 3 m, about 0.1 m to about 3.5 m, about 0.1 m to about 4 m, about 0.1 m to about 5 m, about 0.5 m to about 1 m, about 0.5 m to about 1.5 m, about 0.5 m to about 2 m, about 0.5 m to about 2.5 m, about 0.5 m to about 3 m, about 0.5 m to about 3.5 m, about 0.5 m to about 4 m, about 0.5 m to about 5 m, about 1 m to about 1.5 m, about 1 m to about 2 m, about 1 m to about 2.5 m, about 1 m to about 3 m, about 1 m to about 3.5 m, about 1 m to about 4 m, about 1 m to about 5 m, about 1.5 m to about 2 m, about 1.5 m to about 2.5 m, about 1.5 m to about 3 m, about 1.5 m to about 3.5 m, about 1.5 m to about 4 m, about 1.5 m to about 5 m, about 2 m to about 2.5 m, about 2 m to about 3 m, about 2 m to about 3.5 m, about 2 m to about 4 m, about 2 m to about 5 m, about 2.5 m to about 3 m, about 2.5 m to about 3.5 m, about 2.5 m to about 4 m, about 2.5 m to about 5 m, about 3 m to about 3.5 m, about 3 m to about 4 m, about 3 m to about 5 m, about 3.5 m to about 4 m, about 3.5 m to about 5 m, or about 4 m to about 5 m. In some embodiments, the distance between planting units may be less than about 0.01 m, about 0.05 m, about 0.1 m, about 0.5 m, about 1 m, about 1.5 m, about 2 m, about 2.5 m, about 3 m, about 3.5 m, about 4 m, or about 5 m. In some embodiments, the distance between planting units may be less than at least about 0.01 m, about 0.05 m, about 0.1 m, about 0.5 m, about 1 m, about 1.5 m, about 2 m, about 2.5 m, about 3 m, about 3.5 m, or about 4 m. In some embodiments, the distance between planting units may be less than at most about 0.05 m, about 0.1 m, about 0.5 m, about 1 m, about 1.5 m, about 2 m, about 2.5 m, about 3 m, about 3.5 m, about 4 m, or about 5 m.

In some embodiments, the planting units may be planted at a depth of at least about 5 mm to about 300 mm. In some embodiments, the planting units may be planted at a depth of at least about 5 mm to about 10 mm, about 5 mm to about 15 mm, about 5 mm to about 20 mm, about 5 mm to about 25 mm, about 5 mm to about 30 mm, about 5 mm to about 35 mm, about 5 mm to about 40 mm, about 5 mm to about 45 mm, about 5 mm to about 50 mm, about 5 mm to about 100 mm, about 5 mm to about 300 mm, about 10 mm to about 15 mm, about 10 mm to about 20 mm, about 10 mm to about 25 mm, about 10 mm to about 30 mm, about 10 mm to about 35 mm, about 10 mm to about 40 mm, about 10 mm to about 45 mm, about 10 mm to about 50 mm, about 10 mm to about 100 mm, about 10 mm to about 300 mm, about 15 mm to about 20 mm, about 15 mm to about 25 mm, about 15 mm to about 30 mm, about 15 mm to about 35 mm, about 15 mm to about 40 mm, about 15 mm to about 45 mm, about 15 mm to about 50 mm, about 15 mm to about 100 mm, about 15 mm to about 300 mm, about 20 mm to about 25 mm, about 20 mm to about 30 mm, about 20 mm to about 35 mm, about 20 mm to about 40 mm, about 20 mm to about 45 mm, about 20 mm to about 50 mm, about 20 mm to about 100 mm, about 20 mm to about 300 mm, about 25 mm to about 30 mm, about 25 mm to about 35 mm, about 25 mm to about 40 mm, about 25 mm to about 45 mm, about 25 mm to about 50 mm, about 25 mm to about 100 mm, about 25 mm to about 300 mm, about 30 mm to about 35 mm, about 30 mm to about 40 mm, about 30 mm to about 45 mm, about 30 mm to about 50 mm, about 30 mm to about 100 mm, about 30 mm to about 300 mm, about 35 mm to about 40 mm, about 35 mm to about 45 mm, about 35 mm to about 50 mm, about 35 mm to about 100 mm, about 35 mm to about 300 mm, about 40 mm to about 45 mm, about 40 mm to about 50 mm, about 40 mm to about 100 mm, about 40 mm to about 300 mm, about 45 mm to about 50 mm, about 45 mm to about 100 mm, about 45 mm to about 300 mm, about 50 mm to about 100 mm, about 50 mm to about 300 mm, or about 100 mm to about 300 mm. In some embodiments, the planting units may be planted at a depth of at least about 5 mm, about 10 mm, about 15 mm, about 20 mm, about 25 mm, about 30 mm, about 35 mm, about 40 mm, about 45 mm, about 50 mm, about 100 mm, or about 300 mm. In some embodiments, the planting units may be planted at a depth of at least at least about 5 mm, about 10 mm, about 15 mm, about 20 mm, about 25 mm, about 30 mm, about 35 mm, about 40 mm, about 45 mm, about 50 mm, or about 100 mm. In some embodiments, the planting units may be planted at a depth of at least at most about 10 mm, about 15 mm, about 20 mm, about 25 mm, about 30 mm, about 35 mm, about 40 mm, about 45 mm, about 50 mm, about 100 mm, or about 300 mm.

In some embodiments, the soil may have a moisture level from about 1% to about 90%. In some embodiments, the soil may have a moisture level from about 1% to about 5%, about 1% to about 10%, about 1% to about 20%, about 1% to about 30%, about 1% to about 40%, about 1% to about 50%, about 1% to about 60%, about 1% to about 70%, about 1% to about 80%, about 1% to about 85%, about 1% to about 90%, about 5% to about 10%, about 5% to about 20%, about 5% to about 30%, about 5% to about 40%, about 5% to about 50%, about 5% to about 60%, about 5% to about 70%, about 5% to about 80%, about 5% to about 85%, about 5% to about 90%, about 10% to about 20%, about 10% to about 30%, about 10% to about 40%, about 10% to about 50%, about 10% to about 60%, about 10% to about 70%, about 10% to about 80%, about 10% to about 85%, about 10% to about 90%, about 20% to about 30%, about 20% to about 40%, about 20% to about 50%, about 20% to about 60%, about 20% to about 70%, about 20% to about 80%, about 20% to about 85%, about 20% to about 90%, about 30% to about 40%, about 30% to about 50%, about 30% to about 60%, about 30% to about 70%, about 30% to about 80%, about 30% to about 85%, about 30% to about 90%, about 40% to about 50%, about 40% to about 60%, about 40% to about 70%, about 40% to about 80%, about 40% to about 85%, about 40% to about 90%, about 50% to about 60%, about 50% to about 70%, about 50% to about 80%, about 50% to about 85%, about 50% to about 90%, about 60% to about 70%, about 60% to about 80%, about 60% to about 85%, about 60% to about 90%, about 70% to about 80%, about 70% to about 85%, about 70% to about 90%, about 80% to about 85%, about 80% to about 90%, or about 85% to about 90%. In some embodiments, the soil may have a moisture level from about 1%, about 5%, about 10%, about 20%, about 30%, about 40%, about 50%, about 60%, about 70%, about 80%, about 85%, or about 90%. In some embodiments, the soil may have a moisture level from at least about 1%, about 5%, about 10%, about 20%, about 30%, about 40%, about 50%, about 60%, about 70%, about 80%, or about 85%. In some embodiments, the soil may have a moisture level from at most about 5%, about 10%, about 20%, about 30%, about 40%, about 50%, about 60%, about 70%, about 80%, about 85%, or about 90%.

In some embodiments, the plurality of Arundo grass plants have a density in surface soil of at least about 1 U/m² to about 20,000 U/m². In some embodiments, the plurality of Arundo grass plants have a density in surface soil of at least about 1 U/m² to about 300 U/m², about 1 U/m² to about 500 U/m², about 1 U/m² to about 700 U/m², about 1 U/m² to about 900 U/m², about 1 U/m² to about 1,000 U/m², about 1 U/m² to about 3,000 U/m², about 1 U/m² to about 5,000 U/m², about 1 U/m² to about 7,000 U/m², about 1 U/m² to about 9,000 U/m², about 1 U/m² to about 10,000 U/m², about 1 U/m² to about 20,000 U/m², about 300 U/m² to about 500 U/m², about 300 U/m² to about 700 U/m², about 300 U/m² to about 900 U/m², about 300 U/m² to about 1,000 U/m², about 300 U/m² to about 3,000 U/m², about 300 U/m² to about 5,000 U/m², about 300 U/m² to about 7,000 U/m², about 300 U/m² to about 9,000 U/m², about 300 U/m² to about 10,000 U/m², about 300 U/m² to about 20,000 U/m², about 500 U/m² to about 700 U/m², about 500 U/m² to about 900 U/m², about 500 U/m² to about 1,000 U/m², about 500 U/m² to about 3,000 U/m², about 500 U/m² to about 5,000 U/m², about 500 U/m² to about 7,000 U/m², about 500 U/m² to about 9,000 U/m², about 500 U/m² to about 10,000 U/m², about 500 U/m² to about 20,000 U/m², about 700 U/m² to about 900 U/m², about 700 U/m² to about 1,000 U/m², about 700 U/m² to about 3,000 U/m², about 700 U/m² to about 5,000 U/m², about 700 U/m² to about 7,000 U/m², about 700 U/m² to about 9,000 U/m², about 700 U/m² to about 10,000 U/m², about 700 U/m² to about 20,000 U/m², about 900 U/m² to about 1,000 U/m², about 900 U/m² to about 3,000 U/m², about 900 U/m² to about 5,000 U/m², about 900 U/m² to about 7,000 U/m², about 900 U/m² to about 9,000 U/m², about 900 U/m² to about 10,000 U/m², about 900 U/m² to about 20,000 U/m², about 1,000 U/m² to about 3,000 U/m², about 1,000 U/m² to about 5,000 U/m², about 1,000 U/m² to about 7,000 U/m², about 1,000 U/m² to about 9,000 U/m², about 1,000 U/m² to about 10,000 U/m², about 1,000 U/m² to about 20,000 U/m², about 3,000 U/m² to about 5,000 U/m², about 3,000 U/m² to about 7,000 U/m², about 3,000 U/m² to about 9,000 U/m², about 3,000 U/m² to about 10,000 U/m², about 3,000 U/m² to about 20,000 U/m², about 5,000 U/m² to about 7,000 U/m², about 5,000 U/m² to about 9,000 U/m², about 5,000 U/m² to about 10,000 U/m², about 5,000 U/m² to about 20,000 U/m², about 7,000 U/m² to about 9,000 U/m², about 7,000 U/m² to about 10,000 U/m², about 7,000 U/m² to about 20,000 U/m², about 9,000 U/m² to about 10,000 U/m², about 9,000 U/m² to about 20,000 U/m², or about 10,000 U/m² to about 20,000 U/m². In some embodiments, the plurality of Arundo grass plants have a density in surface soil of at least about 1 U/m², about 300 U/m², about 500 U/m², about 700 U/m², about 900 U/m², about 1,000 U/m², about 3,000 U/m², about 5,000 U/m², about 7,000 U/m², about 9,000 U/m², about 10,000 U/m², or about 20,000 U/m². In some embodiments, the plurality of Arundo grass plants have a density in surface soil of at least at least about 1 U/m², about 300 U/m², about 500 U/m², about 700 U/m², about 900 U/m², about 1,000 U/m², about 3,000 U/m², about 5,000 U/m², about 7,000 U/m², about 9,000 U/m², or about 10,000 U/m². In some embodiments, the plurality of Arundo grass plants have a density in surface soil of at least at most about 300 U/m², about 500 U/m², about 700 U/m², about 900 U/m², about 1,000 U/m², about 3,000 U/m², about 5,000 U/m², about 7,000 U/m², about 9,000 U/m², about 10,000 U/m², or about 20,000 U/m².

### Harvesting

In another aspect, disclosed herein are methods of harvesting Arundo grass plants. The grass plants may be manually harvested. The grass plants may be harvested mechanically. In some embodiments, the harvesting may be accomplished by forage harvesting. In some embodiments, the mechanical harvesting may be accomplished using a sugarcane harvester. In some embodiments, the mechanical harvesting may be accomplished by disc mowing, using a fell buncher, through boom harvesting, or using combinations thereof. Arundo grass stalks may be manually or mechanically separated from leaves. The grass stalks may be cut into specific lengths.

In some embodiments, Arundo grass plants are each independently allowed to grow to heights of about 3 m to about 12 m. In some embodiments, Arundo grass plants are each independently allowed to grow to heights of about 3 m to about 3.5 m, about 3 m to about 4 m, about 3 m to about 4.5 m, about 3 m to about 5 m, about 3 m to about 6 m, about 3 m to about 7 m, about 3 m to about 8 m, about 3 m to about 9 m, about 3 m to about 10 m, about 3 m to about 11 m, about 3 m to about 12 m, about 3.5 m to about 4 m, about 3.5 m to about 4.5 m, about 3.5 m to about 5 m, about 3.5 m to about 6 m, about 3.5 m to about 7 m, about 3.5 m to about 8 m, about 3.5 m to about 9 m, about 3.5 m to about 10 m, about 3.5 m to about 11 m, about 3.5 m to about 12 m, about 4 m to about 4.5 m, about 4 m to about 5 m, about 4 m to about 6 m, about 4 m to about 7 m, about 4 m to about 8 m, about 4 m to about 9 m, about 4 m to about 10 m, about 4 m to about 11 m, about 4 m to about 12 m, about 4.5 m to about 5 m, about 4.5 m to about 6 m, about 4.5 m to about 7 m, about 4.5 m to about 8 m, about 4.5 m to about 9 m, about 4.5 m to about 10 m, about 4.5 m to about 11 m, about 4.5 m to about 12 m, about 5 m to about 6 m, about 5 m to about 7 m, about 5 m to about 8 m, about 5 m to about 9 m, about 5 m to about 10 m, about 5 m to about 11 m, about 5 m to about 12 m, about 6 m to about 7 m, about 6 m to about 8 m, about 6 m to about 9 m, about 6 m to about 10 m, about 6 m to about 11 m, about 6 m to about 12 m, about 7 m to about 8 m, about 7 m to about 9 m, about 7 m to about 10 m, about 7 m to about 11 m, about 7 m to about 12 m, about 8 m to about 9 m, about 8 m to about 10 m, about 8 m to about 11 m, about 8 m to about 12 m, about 9 m to about 10 m, about 9 m to about 11 m, about 9 m to about 12 m, about 10 m to about 11 m, about 10 m to about 12 m, or about 11 m to about 12 m. In some embodiments, Arundo grass plants are each independently allowed to grow to heights of about 3 m, about 3.5 m, about 4 m, about 4.5 m, about 5 m, about 6 m, about 7 m, about 8 m, about 9 m, about 10 m, about 11 m, or about 12 m. In some embodiments, Arundo grass plants are each independently allowed to grow to heights of at least about 3 m, about 3.5 m, about 4 m, about 4.5 m, about 5 m, about 6 m, about 7 m, about 8 m, about 9 m, about 10 m, or about 11 m. In some embodiments, Arundo grass plants are each independently allowed to grow to heights of at most about 3.5 m, about 4 m, about 4.5 m, about 5 m, about 6 m, about 7 m, about 8 m, about 9 m, about 10 m, about 11 m, or about 12 m.

In some embodiments, harvested Arundo grass may have a moisture content of about 1% to about 90%. In some embodiments, harvested Arundo grass may have a moisture content of about 1% to about 5%, about 1% to about 10%, about 1% to about 20%, about 1% to about 30%, about 1% to about 40%, about 1% to about 50%, about 1% to about 60%, about 1% to about 70%, about 1% to about 80%, about 1% to about 85%, about 1% to about 90%, about 5% to about 10%, about 5% to about 20%, about 5% to about 30%, about 5% to about 40%, about 5% to about 50%, about 5% to about 60%, about 5% to about 70%, about 5% to about 80%, about 5% to about 85%, about 5% to about 90%, about 10% to about 20%, about 10% to about 30%, about 10% to about 40%, about 10% to about 50%, about 10% to about 60%, about 10% to about 70%, about 10% to about 80%, about 10% to about 85%, about 10% to about 90%, about 20% to about 30%, about 20% to about 40%, about 20% to about 50%, about 20% to about 60%, about 20% to about 70%, about 20% to about 80%, about 20% to about 85%, about 20% to about 90%, about 30% to about 40%, about 30% to about 50%, about 30% to about 60%, about 30% to about 70%, about 30% to about 80%, about 30% to about 85%, about 30% to about 90%, about 40% to about 50%, about 40% to about 60%, about 40% to about 70%, about 40% to about 80%, about 40% to about 85%, about 40% to about 90%, about 50% to about 60%, about 50% to about 70%, about 50% to about 80%, about 50% to about 85%, about 50% to about 90%, about 60% to about 70%, about 60% to about 80%, about 60% to about 85%, about 60% to about 90%, about 70% to about 80%, about 70% to about 85%, about 70% to about 90%, about 80% to about 85%, about 80% to about 90%, or about 85% to about 90%. In some embodiments, harvested Arundo grass may have a moisture content of about 1%, about 5%, about 10%, about 20%, about 30%, about 40%, about 50%, about 60%, about 70%, about 80%, about 85%, or about 90%. In some embodiments, harvested Arundo grass may have a moisture content of at least about 1%, about 5%, about 10%, about 20%, about 30%, about 40%, about 50%, about 60%, about 70%, about 80%, or about 85%. In some embodiments, harvested Arundo grass may have a moisture content of at most about 5%, about 10%, about 20%, about 30%, about 40%, about 50%, about 60%, about 70%, about 80%, about 85%, or about 90%.

In some embodiments, harvested Arundo grass stalks may be cut to lengths of no more than about 10 mm to about 1,500 mm. In some embodiments, harvested Arundo grass stalks may be cut to lengths of no more than about 10 mm to about 20 mm, about 10 mm to about 30 mm, about 10 mm to about 40 mm, about 10 mm to about 50 mm, about 10 mm to about 100 mm, about 10 mm to about 150 mm, about 10 mm to about 200 mm, about 10 mm to about 300 mm, about 10 mm to about 400 mm, about 10 mm to about 500 mm, about 10 mm to about 1,500 mm, about 20 mm to about 30 mm, about 20 mm to about 40 mm, about 20 mm to about 50 mm, about 20 mm to about 100 mm, about 20 mm to about 150 mm, about 20 mm to about 200 mm, about 20 mm to about 300 mm, about 20 mm to about 400 mm, about 20 mm to about 500 mm, about 20 mm to about 1,500 mm, about 30 mm to about 40 mm, about 30 mm to about 50 mm, about 30 mm to about 100 mm, about 30 mm to about 150 mm, about 30 mm to about 200 mm, about 30 mm to about 300 mm, about 30 mm to about 400 mm, about 30 mm to about 500 mm, about 30 mm to about 1,500 mm, about 40 mm to about 50 mm, about 40 mm to about 100 mm, about 40 mm to about 150 mm, about 40 mm to about 200 mm, about 40 mm to about 300 mm, about 40 mm to about 400 mm, about 40 mm to about 500 mm, about 40 mm to about 1,500 mm, about 50 mm to about 100 mm, about 50 mm to about 150 mm, about 50 mm to about 200 mm, about 50 mm to about 300 mm, about 50 mm to about 400 mm, about 50 mm to about 500 mm, about 50 mm to about 1,500 mm, about 100 mm to about 150 mm, about 100 mm to about 200 mm, about 100 mm to about 300 mm, about 100 mm to about 400 mm, about 100 mm to about 500 mm, about 100 mm to about 1,500 mm, about 150 mm to about 200 mm, about 150 mm to about 300 mm, about 150 mm to about 400 mm, about 150 mm to about 500 mm, about 150 mm to about 1,500 mm, about 200 mm to about 300 mm, about 200 mm to about 400 mm, about 200 mm to about 500 mm, about 200 mm to about 1,500 mm, about 300 mm to about 400 mm, about 300 mm to about 500 mm, about 300 mm to about 1,500 mm, about 400 mm to about 500 mm, about 400 mm to about 1,500 mm, or about 500 mm to about 1,500 mm. In some embodiments, harvested Arundo grass stalks may be cut to lengths of no more than about 10 mm, about 20 mm, about 30 mm, about 40 mm, about 50 mm, about 100 mm, about 150 mm, about 200 mm, about 300 mm, about 400 mm, about 500 mm, or about 1,500 mm. In some embodiments, harvested Arundo grass stalks may be cut to lengths of no more than at least about 10 mm, about 20 mm, about 30 mm, about 40 mm, about 50 mm, about 100 mm, about 150 mm, about 200 mm, about 300 mm, about 400 mm, or about 500 mm. In some embodiments, harvested Arundo grass stalks may be cut to lengths of no more than at most about 20 mm, about 30 mm, about 40 mm, about 50 mm, about 100 mm, about 150 mm, about 200 mm, about 300 mm, about 400 mm, about 500 mm, or about 1,500 mm.

### Production of Fibers, Pellets, Chips, or Strips

In some aspects, disclosed herein, are methods of producing fibers, pellets, or chips from Arundo grass plants. Harvested Arundo stalks may be cut, ground, shredded, mechanically processed, compressed, or any combination thereof to yield Arundo grass fibers, pellets, chips, or full-length strips (e.g., for use in flooring). Arundo grass fibers, pellets, chips, or full-length strips may comprise particles having a variety of shapes and sizes, such as flakes, strands, fines, dust, powders, and combinations thereof. Harvested Arundo stalks may be treated with a defoliant such as ethephon to remove leaves, or leaves may be manually or mechanically removed. Harvested Arundo stalks may be washed with water or HCl to reduce inorganic matter content.

In some embodiments, the plurality of Arundo grass chips may each independently have a length about 1 mm to about 150 mm. In some embodiments, the plurality of Arundo grass chips may each independently have a length about 1 mm to about 5 mm, about 1 mm to about 10 mm, about 1 mm to about 15 mm, about 1 mm to about 20 mm, about 1 mm to about 25 mm, about 1 mm to about 30 mm, about 1 mm to about 35 mm, about 1 mm to about 40 mm, about 1 mm to about 50 mm, about 1 mm to about 100 mm, about 1 mm to about 150 mm, about 5 mm to about 10 mm, about 5 mm to about 15 mm, about 5 mm to about 20 mm, about 5 mm to about 25 mm, about 5 mm to about 30 mm, about 5 mm to about 35 mm, about 5 mm to about 40 mm, about 5 mm to about 50 mm, about 5 mm to about 100 mm, about 5 mm to about 150 mm, about 10 mm to about 15 mm, about 10 mm to about 20 mm, about 10 mm to about 25 mm, about 10 mm to about 30 mm, about 10 mm to about 35 mm, about 10 mm to about 40 mm, about 10 mm to about 50 mm, about 10 mm to about 100 mm, about 10 mm to about 150 mm, about 15 mm to about 20 mm, about 15 mm to about 25 mm, about 15 mm to about 30 mm, about 15 mm to about 35 mm, about 15 mm to about 40 mm, about 15 mm to about 50 mm, about 15 mm to about 100 mm, about 15 mm to about 150 mm, about 20 mm to about 25 mm, about 20 mm to about 30 mm, about 20 mm to about 35 mm, about 20 mm to about 40 mm, about 20 mm to about 50 mm, about 20 mm to about 100 mm, about 20 mm to about 150 mm, about 25 mm to about 30 mm, about 25 mm to about 35 mm, about 25 mm to about 40 mm, about 25 mm to about 50 mm, about 25 mm to about 100 mm, about 25 mm to about 150 mm, about 30 mm to about 35 mm, about 30 mm to about 40 mm, about 30 mm to about 50 mm, about 30 mm to about 100 mm, about 30 mm to about 150 mm, about 35 mm to about 40 mm, about 35 mm to about 50 mm, about 35 mm to about 100 mm, about 35 mm to about 150 mm, about 40 mm to about 50 mm, about 40 mm to about 100 mm, about 40 mm to about 150 mm, about 50 mm to about 100 mm, about 50 mm to about 150 mm, or about 100 mm to about 150 mm. In some embodiments, the plurality of Arundo grass chips may each independently have a length about 1 mm, about 5 mm, about 10 mm, about 15 mm, about 20 mm, about 25 mm, about 30 mm, about 35 mm, about 40 mm, about 50 mm, about 100 mm, or about 150 mm. In some embodiments, the plurality of Arundo grass chips may each independently have a length at least about 1 mm, about 5 mm, about 10 mm, about 15 mm, about 20 mm, about 25 mm, about 30 mm, about 35 mm, about 40 mm, about 50 mm, or about 100 mm. In some embodiments, the plurality of Arundo grass chips may each independently have a length at most about 5 mm, about 10 mm, about 15 mm, about 20 mm, about 25 mm, about 30 mm, about 35 mm, about 40 mm, about 50 mm, about 100 mm, or about 150 mm.

### Biomass Products

In some aspects, described herein, are engineered Arundo grass material compositions and products comprising the same. The product may be a renewable natural gas, a biogas, a biochemical, a bioplastic, pulp, a paper product (e.g., packaging, toilet paper, paper towels, tissue, or a combination thereof), a bioremediation kit, a bio-composite reinforcement, animal bedding, packaging, textiles, a fiberboard, an absorptive pellet, a fuel composition, an energy pellet, a biofuel such as biodiesel, jet fuel, heating oil, or ethanol, a fabric, a weaving, a biochar, a bamboo substitute, a corn substitute, a wood substitute, an aggregate, a flame retardant, a weed control mat, an absorptive pellet, a combustion pellet, a flooring material, a structural beam, a fiber-reinforced composite, a particle board, an animal feed, an oriented strand board (OSB), a bioplastic, an insulation material, and a reinforcement material or any combination of two or more thereof.

In some embodiments, the composition may comprise by weight at least about 5% Arundo fibers to about 99% Arundo fibers. In some embodiments, the composition may comprise by weight at least about 5% Arundo fibers to about 10% Arundo fibers, about 5% Arundo fibers to about 20% Arundo fibers, about 5% Arundo fibers to about 30% Arundo fibers, about 5% Arundo fibers to about 40% Arundo fibers, about 5% Arundo fibers to about 50% Arundo fibers, about 5% Arundo fibers to about 60% Arundo fibers, about 5% Arundo fibers to about 70% Arundo fibers, about 5% Arundo fibers to about 80% Arundo fibers, about 5% Arundo fibers to about 90% Arundo fibers, about 5% Arundo fibers to about 95% Arundo fibers, about 5% Arundo fibers to about 99% Arundo fibers, about 10% Arundo fibers to about 20% Arundo fibers, about 10% Arundo fibers to about 30% Arundo fibers, about 10% Arundo fibers to about 40% Arundo fibers, about 10% Arundo fibers to about 50% Arundo fibers, about 10% Arundo fibers to about 60% Arundo fibers, about 10% Arundo fibers to about 70% Arundo fibers, about 10% Arundo fibers to about 80% Arundo fibers, about 10% Arundo fibers to about 90% Arundo fibers, about 10% Arundo fibers to about 95% Arundo fibers, about 10% Arundo fibers to about 99% Arundo fibers, about 20% Arundo fibers to about 30% Arundo fibers, about 20% Arundo fibers to about 40% Arundo fibers, about 20% Arundo fibers to about 50% Arundo fibers, about 20% Arundo fibers to about 60% Arundo fibers, about 20% Arundo fibers to about 70% Arundo fibers, about 20% Arundo fibers to about 80% Arundo fibers, about 20% Arundo fibers to about 90% Arundo fibers, about 20% Arundo fibers to about 95% Arundo fibers, about 20% Arundo fibers to about 99% Arundo fibers, about 30% Arundo fibers to about 40% Arundo fibers, about 30% Arundo fibers to about 50% Arundo fibers, about 30% Arundo fibers to about 60% Arundo fibers, about 30% Arundo fibers to about 70% Arundo fibers, about 30% Arundo fibers to about 80% Arundo fibers, about 30% Arundo fibers to about 90% Arundo fibers, about 30% Arundo fibers to about 95% Arundo fibers, about 30% Arundo fibers to about 99% Arundo fibers, about 40% Arundo fibers to about 50% Arundo fibers, about 40% Arundo fibers to about 60% Arundo fibers, about 40% Arundo fibers to about 70% Arundo fibers, about 40% Arundo fibers to about 80% Arundo fibers, about 40% Arundo fibers to about 90% Arundo fibers, about 40% Arundo fibers to about 95% Arundo fibers, about 40% Arundo fibers to about 99% Arundo fibers, about 50% Arundo fibers to about 60% Arundo fibers, about 50% Arundo fibers to about 70% Arundo fibers, about 50% Arundo fibers to about 80% Arundo fibers, about 50% Arundo fibers to about 90% Arundo fibers, about 50% Arundo fibers to about 95% Arundo fibers, about 50% Arundo fibers to about 99% Arundo fibers, about 60% Arundo fibers to about 70% Arundo fibers, about 60% Arundo fibers to about 80% Arundo fibers, about 60% Arundo fibers to about 90% Arundo fibers, about 60% Arundo fibers to about 95% Arundo fibers, about 60% Arundo fibers to about 99% Arundo fibers, about 70% Arundo fibers to about 80% Arundo fibers, about 70% Arundo fibers to about 90% Arundo fibers, about 70% Arundo fibers to about 95% Arundo fibers, about 70% Arundo fibers to about 99% Arundo fibers, about 80% Arundo fibers to about 90% Arundo fibers, about 80% Arundo fibers to about 95% Arundo fibers, about 80% Arundo fibers to about 99% Arundo fibers, about 90% Arundo fibers to about 95% Arundo fibers, about 90% Arundo fibers to about 99% Arundo fibers, or about 95% Arundo fibers to about 99% Arundo fibers. In some embodiments, the composition may comprise by weight at least about 5% Arundo fibers, about 10% Arundo fibers, about 20% Arundo fibers, about 30% Arundo fibers, about 40% Arundo fibers, about 50% Arundo fibers, about 60% Arundo fibers, about 70% Arundo fibers, about 80% Arundo fibers, about 90% Arundo fibers, about 95% Arundo fibers, or about 99% Arundo fibers. In some embodiments, the composition may comprise by weight at least at least about 5% Arundo fibers, about 10% Arundo fibers, about 20% Arundo fibers, about 30% Arundo fibers, about 40% Arundo fibers, about 50% Arundo fibers, about 60% Arundo fibers, about 70% Arundo fibers, about 80% Arundo fibers, about 90% Arundo fibers, or about 95% Arundo fibers. In some embodiments, the composition may comprise by weight at least at most about 10% Arundo fibers, about 20% Arundo fibers, about 30% Arundo fibers, about 40% Arundo fibers, about 50% Arundo fibers, about 60% Arundo fibers, about 70% Arundo fibers, about 80% Arundo fibers, about 90% Arundo fibers, about 95% Arundo fibers, or about 99% Arundo fibers.

In some embodiments, the Arundo stalks, fibers, leaves, or chips may comprise by weight a sugar content of about 1% to about 45%. In some embodiments, the Arundo stalks, fibers, leaves, or chips may comprise by weight a sugar content of about 1% to about 3%, about 1% to about 5%, about 1% to about 10%, about 1% to about 15%, about 1% to about 20%, about 1% to about 25%, about 1% to about 30%, about 1% to about 32%, about 1% to about 35%, about 1% to about 40%, about 1% to about 45%, about 3% to about 5%, about 3% to about 10%, about 3% to about 15%, about 3% to about 20%, about 3% to about 25%, about 3% to about 30%, about 3% to about 32%, about 3% to about 35%, about 3% to about 40%, about 3% to about 45%, about 5% to about 10%, about 5% to about 15%, about 5% to about 20%, about 5% to about 25%, about 5% to about 30%, about 5% to about 32%, about 5% to about 35%, about 5% to about 40%, about 5% to about 45%, about 10% to about 15%, about 10% to about 20%, about 10% to about 25%, about 10% to about 30%, about 10% to about 32%, about 10% to about 35%, about 10% to about 40%, about 10% to about 45%, about 15% to about 20%, about 15% to about 25%, about 15% to about 30%, about 15% to about 32%, about 15% to about 35%, about 15% to about 40%, about 15% to about 45%, about 20% to about 25%, about 20% to about 30%, about 20% to about 32%, about 20% to about 35%, about 20% to about 40%, about 20% to about 45%, about 25% to about 30%, about 25% to about 32%, about 25% to about 35%, about 25% to about 40%, about 25% to about 45%, about 30% to about 32%, about 30% to about 35%, about 30% to about 40%, about 30% to about 45%, about 32% to about 35%, about 32% to about 40%, about 32% to about 45%, about 35% to about 40%, about 35% to about 45%, or about 40% to about 45%. In some embodiments, the Arundo stalks, fibers, leaves, or chips may comprise by weight a sugar content of about 1%, about 3%, about 5%, about 10%, about 15%, about 20%, about 25%, about 30%, about 32%, about 35%, about 40%, or about 45%. In some embodiments, the Arundo stalks, fibers, leaves, or chips may comprise by weight a sugar content of at least about 1%, about 3%, about 5%, about 10%, about 15%, about 20%, about 25%, about 30%, about 32%, about 35%, or about 40%. In some embodiments, the Arundo stalks, fibers, leaves, or chips may comprise by weight a sugar content of at most about 3%, about 5%, about 10%, about 15%, about 20%, about 25%, about 30%, about 32%, about 35%, about 40%, or about 45%.

In some embodiments, the Arundo stalks, fibers, leaves, or chips may comprise by weight a hemicellulose content of about 20% to about 40%. In some embodiments, the Arundo stalks, fibers, leaves, or chips may comprise by weight a hemicellulose content of about 20% to about 23%, about 20% to about 24%, about 20% to about 25%, about 20% to about 26%, about 20% to about 27%, about 20% to about 28%, about 20% to about 29%, about 20% to about 30%, about 20% to about 32%, about 20% to about 35%, about 20% to about 40%, about 23% to about 24%, about 23% to about 25%, about 23% to about 26%, about 23% to about 27%, about 23% to about 28%, about 23% to about 29%, about 23% to about 30%, about 23% to about 32%, about 23% to about 35%, about 23% to about 40%, about 24% to about 25%, about 24% to about 26%, about 24% to about 27%, about 24% to about 28%, about 24% to about 29%, about 24% to about 30%, about 24% to about 32%, about 24% to about 35%, about 24% to about 40%, about 25% to about 26%, about 25% to about 27%, about 25% to about 28%, about 25% to about 29%, about 25% to about 30%, about 25% to about 32%, about 25% to about 35%, about 25% to about 40%, about 26% to about 27%, about 26% to about 28%, about 26% to about 29%, about 26% to about 30%, about 26% to about 32%, about 26% to about 35%, about 26% to about 40%, about 27% to about 28%, about 27% to about 29%, about 27% to about 30%, about 27% to about 32%, about 27% to about 35%, about 27% to about 40%, about 28% to about 29%, about 28% to about 30%, about 28% to about 32%, about 28% to about 35%, about 28% to about 40%, about 29% to about 30%, about 29% to about 32%, about 29% to about 35%, about 29% to about 40%, about 30% to about 32%, about 30% to about 35%, about 30% to about 40%, about 32% to about 35%, about 32% to about 40%, or about 35% to about 40%. In some embodiments, the Arundo stalks, fibers, leaves, or chips may comprise by weight a hemicellulose content of about 20%, about 23%, about 24%, about 25%, about 26%, about 27%, about 28%, about 29%, about 30%, about 32%, about 35%, or about 40%. In some embodiments, the Arundo stalks, fibers, leaves, or chips may comprise by weight a hemicellulose content of at least about 20%, about 23%, about 24%, about 25%, about 26%, about 27%, about 28%, about 29%, about 30%, about 32%, or about 35%. In some embodiments, the Arundo stalks, fibers, leaves, or chips may comprise by weight a hemicellulose content of at most about 23%, about 24%, about 25%, about 26%, about 27%, about 28%, about 29%, about 30%, about 32%, about 35%, or about 40%.

In some embodiments, the Arundo stalks, fibers, leaves, or chips may comprise by weight a cellulose content of about 20% to about 50%. In some embodiments, the Arundo stalks, fibers, leaves, or chips may comprise by weight a cellulose content of about 20% to about 25%, about 20% to about 27%, about 20% to about 30%, about 20% to about 32%, about 20% to about 35%, about 20% to about 37%, about 20% to about 40%, about 20% to about 42%, about 20% to about 44%, about 20% to about 45%, about 20% to about 50%, about 25% to about 27%, about 25% to about 30%, about 25% to about 32%, about 25% to about 35%, about 25% to about 37%, about 25% to about 40%, about 25% to about 42%, about 25% to about 44%, about 25% to about 45%, about 25% to about 50%, about 27% to about 30%, about 27% to about 32%, about 27% to about 35%, about 27% to about 37%, about 27% to about 40%, about 27% to about 42%, about 27% to about 44%, about 27% to about 45%, about 27% to about 50%, about 30% to about 32%, about 30% to about 35%, about 30% to about 37%, about 30% to about 40%, about 30% to about 42%, about 30% to about 44%, about 30% to about 45%, about 30% to about 50%, about 32% to about 35%, about 32% to about 37%, about 32% to about 40%, about 32% to about 42%, about 32% to about 44%, about 32% to about 45%, about 32% to about 50%, about 35% to about 37%, about 35% to about 40%, about 35% to about 42%, about 35% to about 44%, about 35% to about 45%, about 35% to about 50%, about 37% to about 40%, about 37% to about 42%, about 37% to about 44%, about 37% to about 45%, about 37% to about 50%, about 40% to about 42%, about 40% to about 44%, about 40% to about 45%, about 40% to about 50%, about 42% to about 44%, about 42% to about 45%, about 42% to about 50%, about 44% to about 45%, about 44% to about 50%, or about 45% to about 50%. In some embodiments, the Arundo stalks, fibers, leaves, or chips may comprise by weight a cellulose content of about 20%, about 25%, about 27%, about 30%, about 32%, about 35%, about 37%, about 40%, about 42%, about 44%, about 45%, or about 50%. In some embodiments, the Arundo stalks, fibers, leaves, or chips may comprise by weight a cellulose content of at least about 20%, about 25%, about 27%, about 30%, about 32%, about 35%, about 37%, about 40%, about 42%, about 44%, or about 45%. In some embodiments, the Arundo stalks, fibers, leaves, or chips may comprise by weight a cellulose content of at most about 25%, about 27%, about 30%, about 32%, about 35%, about 37%, about 40%, about 42%, about 44%, about 45%, or about 50%.

In some embodiments, the Arundo stalks, fibers, leaves, or chips may comprise by weight a lignin content of about 10% to about 29%. In some embodiments, the Arundo stalks, fibers, leaves, or chips may comprise by weight a lignin content of about 10% to about 12%, about 10% to about 14%, about 10% to about 15%, about 10% to about 16%, about 10% to about 17%, about 10% to about 18%, about 10% to about 19%, about 10% to about 29%, about 10% to about 22%, about 10% to about 24%, about 10% to about 25%, about 12% to about 14%, about 12% to about 15%, about 12% to about 16%, about 12% to about 17%, about 12% to about 18%, about 12% to about 19%, about 12% to about 29%, about 12% to about 22%, about 12% to about 24%, about 12% to about 25%, about 14% to about 15%, about 14% to about 16%, about 14% to about 17%, about 14% to about 18%, about 14% to about 19%, about 14% to about 29%, about 14% to about 22%, about 14% to about 24%, about 14% to about 25%, about 15% to about 16%, about 15% to about 17%, about 15% to about 18%, about 15% to about 19%, about 15% to about 29%, about 15% to about 22%, about 15% to about 24%, about 15% to about 25%, about 16% to about 17%, about 16% to about 18%, about 16% to about 19%, about 16% to about 29%, about 16% to about 22%, about 16% to about 24%, about 16% to about 25%, about 17% to about 18%, about 17% to about 19%, about 17% to about 29%, about 17% to about 22%, about 17% to about 24%, about 17% to about 25%, about 18% to about 19%, about 18% to about 29%, about 18% to about 22%, about 18% to about 24%, about 18% to about 25%, about 19% to about 29%, about 19% to about 22%, about 19% to about 24%, about 19% to about 25%, about 29% to about 22%, about 29% to about 24%, about 29% to about 25%, about 22% to about 24%, about 22% to about 25%, or about 24% to about 25%. In some embodiments, the Arundo stalks, fibers, leaves, or chips may comprise by weight a lignin content of about 10%, about 12%, about 14%, about 15%, about 16%, about 17%, about 18%, about 19%, about 29%, about 22%, about 24%, or about 25%. In some embodiments, the Arundo stalks, fibers, leaves, or chips may comprise by weight a lignin content of at least about 10%, about 12%, about 14%, about 15%, about 16%, about 17%, about 18%, about 19%, about 29%, about 22%, or about 24%. In some embodiments, the Arundo stalks, fibers, leaves, or chips may comprise by weight a lignin content of at most about 12%, about 14%, about 15%, about 16%, about 17%, about 18%, about 19%, about 29%, about 22%, about 24%, or about 25%.

In some embodiments, the Arundo stalks, fibers, leaves, or chips may comprise by weight no more than about 0.05% chlorine content to about 1% chlorine content. In some embodiments, the Arundo stalks, fibers, leaves, or chips may comprise by weight no more than about 0.05% chlorine content to about 0.06% chlorine content, about 0.05% chlorine content to about 0.07% chlorine content, about 0.05% chlorine content to about 0.08% chlorine content, about 0.05% chlorine content to about 0.09% chlorine content, about 0.05% chlorine content to about 0.1% chlorine content, about 0.05% chlorine content to about 0.11% chlorine content, about 0.05% chlorine content to about 0.12% chlorine content, about 0.05% chlorine content to about 0.13% chlorine content, about 0.05% chlorine content to about 0.14% chlorine content, about 0.05% chlorine content to about 0.15% chlorine content, about 0.05% chlorine content to about 1% chlorine content, about 0.06% chlorine content to about 0.07% chlorine content, about 0.06% chlorine content to about 0.08% chlorine content, about 0.06% chlorine content to about 0.09% chlorine content, about 0.06% chlorine content to about 0.1% chlorine content, about 0.06% chlorine content to about 0.11% chlorine content, about 0.06% chlorine content to about 0.12% chlorine content, about 0.06% chlorine content to about 0.13% chlorine content, about 0.06% chlorine content to about 0.14% chlorine content, about 0.06% chlorine content to about 0.15% chlorine content, about 0.06% chlorine content to about 1% chlorine content, about 0.07% chlorine content to about 0.08% chlorine content, about 0.07% chlorine content to about 0.09% chlorine content, about 0.07% chlorine content to about 0.1% chlorine content, about 0.07% chlorine content to about 0.11% chlorine content, about 0.07% chlorine content to about 0.12% chlorine content, about 0.07% chlorine content to about 0.13% chlorine content, about 0.07% chlorine content to about 0.14% chlorine content, about 0.07% chlorine content to about 0.15% chlorine content, about 0.07% chlorine content to about 1% chlorine content, about 0.08% chlorine content to about 0.09% chlorine content, about 0.08% chlorine content to about 0.1% chlorine content, about 0.08% chlorine content to about 0.11% chlorine content, about 0.08% chlorine content to about 0.12% chlorine content, about 0.08% chlorine content to about 0.13% chlorine content, about 0.08% chlorine content to about 0.14% chlorine content, about 0.08% chlorine content to about 0.15% chlorine content, about 0.08% chlorine content to about 1% chlorine content, about 0.09% chlorine content to about 0.1% chlorine content, about 0.09% chlorine content to about 0.11% chlorine content, about 0.09% chlorine content to about 0.12% chlorine content, about 0.09% chlorine content to about 0.13% chlorine content, about 0.09% chlorine content to about 0.14% chlorine content, about 0.09% chlorine content to about 0.15% chlorine content, about 0.09% chlorine content to about 1% chlorine content, about 0.1% chlorine content to about 0.11% chlorine content, about 0.1% chlorine content to about 0.12% chlorine content, about 0.1% chlorine content to about 0.13% chlorine content, about 0.1% chlorine content to about 0.14% chlorine content, about 0.1% chlorine content to about 0.15% chlorine content, about 0.1% chlorine content to about 1% chlorine content, about 0.11% chlorine content to about 0.12% chlorine content, about 0.11% chlorine content to about 0.13% chlorine content, about 0.11% chlorine content to about 0.14% chlorine content, about 0.11% chlorine content to about 0.15% chlorine content, about 0.11% chlorine content to about 1% chlorine content, about 0.12% chlorine content to about 0.13% chlorine content, about 0.12% chlorine content to about 0.14% chlorine content, about 0.12% chlorine content to about 0.15% chlorine content, about 0.12% chlorine content to about 1% chlorine content, about 0.13% chlorine content to about 0.14% chlorine content, about 0.13% chlorine content to about 0.15% chlorine content, about 0.13% chlorine content to about 1% chlorine content, about 0.14% chlorine content to about 0.15% chlorine content, about 0.14% chlorine content to about 1% chlorine content, or about 0.15% chlorine content to about 1% chlorine content. In some embodiments, the Arundo stalks, fibers, leaves, or chips may comprise by weight no more than about 0.05% chlorine content, about 0.06% chlorine content, about 0.07% chlorine content, about 0.08% chlorine content, about 0.09% chlorine content, about 0.1% chlorine content, about 0.11% chlorine content, about 0.12% chlorine content, about 0.13% chlorine content, about 0.14% chlorine content, about 0.15% chlorine content, or about 1% chlorine content. In some embodiments, the Arundo stalks, fibers, leaves, or chips may comprise by weight no more than at least about 0.05% chlorine content, about 0.06% chlorine content, about 0.07% chlorine content, about 0.08% chlorine content, about 0.09% chlorine content, about 0.1% chlorine content, about 0.11% chlorine content, about 0.12% chlorine content, about 0.13% chlorine content, about 0.14% chlorine content, or about 0.15% chlorine content. In some embodiments, the Arundo stalks, fibers, leaves, or chips may comprise by weight no more than at most about 0.06% chlorine content, about 0.07% chlorine content, about 0.08% chlorine content, about 0.09% chlorine content, about 0.1% chlorine content, about 0.11% chlorine content, about 0.12% chlorine content, about 0.13% chlorine content, about 0.14% chlorine content, about 0.15% chlorine content, or about 1% chlorine content.

In some embodiments, the Arundo stalks, fibers, leaves, or chips may have a Young's modulus of about 1 GPa to about 35 GPa. In some embodiments, the Arundo stalks, fibers, leaves, or chips may have a Young's modulus of about 1 GPa to about 5 GPa, about 1 GPa to about 7 GPa, about 1 GPa to about 10 GPa, about 1 GPa to about 12 GPa, about 1 GPa to about 15 GPa, about 1 GPa to about 17 GPa, about 1 GPa to about 20 GPa, about 1 GPa to about 22 GPa, about 1 GPa to about 25 GPa, about 1 GPa to about 30 GPa, about 1 GPa to about 35 GPa, about 5 GPa to about 7 GPa, about 5 GPa to about 10 GPa, about 5 GPa to about 12 GPa, about 5 GPa to about 15 GPa, about 5 GPa to about 17 GPa, about 5 GPa to about 20 GPa, about 5 GPa to about 22 GPa, about 5 GPa to about 25 GPa, about 5 GPa to about 30 GPa, about 5 GPa to about 35 GPa, about 7 GPa to about 10 GPa, about 7 GPa to about 12 GPa, about 7 GPa to about 15 GPa, about 7 GPa to about 17 GPa, about 7 GPa to about 20 GPa, about 7 GPa to about 22 GPa, about 7 GPa to about 25 GPa, about 7 GPa to about 30 GPa, about 7 GPa to about 35 GPa, about 10 GPa to about 12 GPa, about 10 GPa to about 15 GPa, about 10 GPa to about 17 GPa, about 10 GPa to about 20 GPa, about 10 GPa to about 22 GPa, about 10 GPa to about 25 GPa, about 10 GPa to about 30 GPa, about 10 GPa to about 35 GPa, about 12 GPa to about 15 GPa, about 12 GPa to about 17 GPa, about 12 GPa to about 20 GPa, about 12 GPa to about 22 GPa, about 12 GPa to about 25 GPa, about 12 GPa to about 30 GPa, about 12 GPa to about 35 GPa, about 15 GPa to about 17 GPa, about 15 GPa to about 20 GPa, about 15 GPa to about 22 GPa, about 15 GPa to about 25 GPa, about 15 GPa to about 30 GPa, about 15 GPa to about 35 GPa, about 17 GPa to about 20 GPa, about 17 GPa to about 22 GPa, about 17 GPa to about 25 GPa, about 17 GPa to about 30 GPa, about 17 GPa to about 35 GPa, about 20 GPa to about 22 GPa, about 20 GPa to about 25 GPa, about 20 GPa to about 30 GPa, about 20 GPa to about 35 GPa, about 22 GPa to about 25 GPa, about 22 GPa to about 30 GPa, about 22 GPa to about 35 GPa, about 25 GPa to about 30 GPa, about 25 GPa to about 35 GPa, or about 30 GPa to about 35 GPa. In some embodiments, the Arundo stalks, fibers, leaves, or chips may have a Young's modulus of about 1 GPa, about 5 GPa, about 7 GPa, about 10 GPa, about 12 GPa, about 15 GPa, about 17 GPa, about 20 GPa, about 22 GPa, about 25 GPa, about 30 GPa, or about 35 GPa. In some embodiments, the Arundo stalks, fibers, leaves, or chips may have a Young's modulus of at least about 1 GPa, about 5 GPa, about 7 GPa, about 10 GPa, about 12 GPa, about 15 GPa, about 17 GPa, about 20 GPa, about 22 GPa, about 25 GPa, or about 30 GPa. In some embodiments, the Arundo stalks, fibers, leaves, or chips may have a Young's modulus of at most about 5 GPa, about 7 GPa, about 10 GPa, about 12 GPa, about 15 GPa, about 17 GPa, about 20 GPa, about 22 GPa, about 25 GPa, about 30 GPa, or about 35 GPa.

In some embodiments, the Arundo stalks, fibers, leaves, or chips may have a Shear modulus of about 0.1 GPa to about 12 GPa. In some embodiments, the Arundo stalks, fibers, leaves, or chips may have a Shear modulus of about 0.1 GPa to about 0.8 GPa, about 0.1 GPa to about 1 GPa, about 0.1 GPa to about 2 GPa, about 0.1 GPa to about 3 GPa, about 0.1 GPa to about 4 GPa, about 0.1 GPa to about 5 GPa, about 0.1 GPa to about 7 GPa, about 0.1 GPa to about 9 GPa, about 0.1 GPa to about 10 GPa, about 0.1 GPa to about 11 GPa, about 0.1 GPa to about 12 GPa, about 0.8 GPa to about 1 GPa, about 0.8 GPa to about 2 GPa, about 0.8 GPa to about 3 GPa, about 0.8 GPa to about 4 GPa, about 0.8 GPa to about 5 GPa, about 0.8 GPa to about 7 GPa, about 0.8 GPa to about 9 GPa, about 0.8 GPa to about 10 GPa, about 0.8 GPa to about 11 GPa, about 0.8 GPa to about 12 GPa, about 1 GPa to about 2 GPa, about 1 GPa to about 3 GPa, about 1 GPa to about 4 GPa, about 1 GPa to about 5 GPa, about 1 GPa to about 7 GPa, about 1 GPa to about 9 GPa, about 1 GPa to about 10 GPa, about 1 GPa to about 11 GPa, about 1 GPa to about 12 GPa, about 2 GPa to about 3 GPa, about 2 GPa to about 4 GPa, about 2 GPa to about 5 GPa, about 2 GPa to about 7 GPa, about 2 GPa to about 9 GPa, about 2 GPa to about 10 GPa, about 2 GPa to about 11 GPa, about 2 GPa to about 12 GPa, about 3 GPa to about 4 GPa, about 3 GPa to about 5 GPa, about 3 GPa to about 7 GPa, about 3 GPa to about 9 GPa, about 3 GPa to about 10 GPa, about 3 GPa to about 11 GPa, about 3 GPa to about 12 GPa, about 4 GPa to about 5 GPa, about 4 GPa to about 7 GPa, about 4 GPa to about 9 GPa, about 4 GPa to about 10 GPa, about 4 GPa to about 11 GPa, about 4 GPa to about 12 GPa, about 5 GPa to about 7 GPa, about 5 GPa to about 9 GPa, about 5 GPa to about 10 GPa, about 5 GPa to about 11 GPa, about 5 GPa to about 12 GPa, about 7 GPa to about 9 GPa, about 7 GPa to about 10 GPa, about 7 GPa to about 11 GPa, about 7 GPa to about 12 GPa, about 9 GPa to about 10 GPa, about 9 GPa to about 11 GPa, about 9 GPa to about 12 GPa, about 10 GPa to about 11 GPa, about 10 GPa to about 12 GPa, or about 11 GPa to about 12 GPa. In some embodiments, the Arundo stalks, fibers, leaves, or chips may have a Shear modulus of about 0.1 GPa, about 0.8 GPa, about 1 GPa, about 2 GPa, about 3 GPa, about 4 GPa, about 5 GPa, about 7 GPa, about 9 GPa, about 10 GPa, about 11 GPa, or about 12 GPa. In some embodiments, the Arundo stalks, fibers, leaves, or chips may have a Shear modulus of at least about 0.1 GPa, about 0.8 GPa, about 1 GPa, about 2 GPa, about 3 GPa, about 4 GPa, about 5 GPa, about 7 GPa, about 9 GPa, about 10 GPa, or about 11 GPa. In some embodiments, the Arundo stalks, fibers, leaves, or chips may have a Shear modulus of at most about 0.8 GPa, about 1 GPa, about 2 GPa, about 3 GPa, about 4 GPa, about 5 GPa, about 7 GPa, about 9 GPa, about 10 GPa, about 11 GPa, or about 12 GPa.

In some embodiments, the Arundo stalks, fibers, leaves, or chips may comprise by weight no more than about 0.05% sodium content to about 3% sodium content. In some embodiments, the Arundo stalks, fibers, leaves, or chips may comprise by weight no more than about 0.05% sodium content to about 0.1% sodium content, about 0.05% sodium content to about 0.2% sodium content, about 0.05% sodium content to about 0.5% sodium content, about 0.05% sodium content to about 0.7% sodium content, about 0.05% sodium content to about 0.9% sodium content, about 0.05% sodium content to about 1% sodium content, about 0.05% sodium content to about 1.5% sodium content, about 0.05% sodium content to about 2% sodium content, about 0.05% sodium content to about 2.5% sodium content, about 0.05% sodium content to about 3% sodium content, about 0.1% sodium content to about 0.2% sodium content, about 0.1% sodium content to about 0.5% sodium content, about 0.1% sodium content to about 0.7% sodium content, about 0.1% sodium content to about 0.9% sodium content, about 0.1% sodium content to about 1% sodium content, about 0.1% sodium content to about 1.5% sodium content, about 0.1% sodium content to about 2% sodium content, about 0.1% sodium content to about 2.5% sodium content, about 0.1% sodium content to about 3% sodium content, about 0.2% sodium content to about 0.5% sodium content, about 0.2% sodium content to about 0.7% sodium content, about 0.2% sodium content to about 0.9% sodium content, about 0.2% sodium content to about 1% sodium content, about 0.2% sodium content to about 1.5% sodium content, about 0.2% sodium content to about 2% sodium content, about 0.2% sodium content to about 2.5% sodium content, about 0.2% sodium content to about 3% sodium content, about 0.5% sodium content to about 0.7% sodium content, about 0.5% sodium content to about 0.9% sodium content, about 0.5% sodium content to about 1% sodium content, about 0.5% sodium content to about 1.5% sodium content, about 0.5% sodium content to about 2% sodium content, about 0.5% sodium content to about 2.5% sodium content, about 0.5% sodium content to about 3% sodium content, about 0.7% sodium content to about 0.9% sodium content, about 0.7% sodium content to about 1% sodium content, about 0.7% sodium content to about 1.5% sodium content, about 0.7% sodium content to about 2% sodium content, about 0.7% sodium content to about 2.5% sodium content, about 0.7% sodium content to about 3% sodium content, about 0.9% sodium content to about 1% sodium content, about 0.9% sodium content to about 1.5% sodium content, about 0.9% sodium content to about 2% sodium content, about 0.9% sodium content to about 2.5% sodium content, about 0.9% sodium content to about 3% sodium content, about 1% sodium content to about 1.5% sodium content, about 1% sodium content to about 2% sodium content, about 1% sodium content to about 2.5% sodium content, about 1% sodium content to about 3% sodium content, about 1.5% sodium content to about 2% sodium content, about 1.5% sodium content to about 2.5% sodium content, about 1.5% sodium content to about 3% sodium content, about 2% sodium content to about 2.5% sodium content, about 2% sodium content to about 3% sodium content, or about 2.5% sodium content to about 3% sodium content. In some embodiments, the Arundo stalks, fibers, leaves, or chips may comprise by weight no more than about 0.05% sodium content, about 0.1% sodium content, about 0.2% sodium content, about 0.5% sodium content, about 0.7% sodium content, about 0.9% sodium content, about 1% sodium content, about 1.5% sodium content, about 2% sodium content, about 2.5% sodium content, or about 3% sodium content. In some embodiments, the Arundo stalks, fibers, leaves, or chips may comprise by weight no more than at least about 0.05% sodium content, about 0.1% sodium content, about 0.2% sodium content, about 0.5% sodium content, about 0.7% sodium content, about 0.9% sodium content, about 1% sodium content, about 1.5% sodium content, about 2% sodium content, or about 2.5% sodium content. In some embodiments, the Arundo stalks, fibers, leaves, or chips may comprise by weight no more than at most about 0.1% sodium content, about 0.2% sodium content, about 0.5% sodium content, about 0.7% sodium content, about 0.9% sodium content, about 1% sodium content, about 1.5% sodium content, about 2% sodium content, about 2.5% sodium content, or about 3% sodium content.

In some embodiments, the Arundo stalks, fibers, leaves, or chips may comprise by weight no more than about 0.05% potassium content to about 3% potassium content. In some embodiments, the Arundo stalks, fibers, leaves, or chips may comprise by weight no more than about 0.05% potassium content to about 0.1% potassium content, about 0.05% potassium content to about 0.2% potassium content, about 0.05% potassium content to about 0.5% potassium content, about 0.05% potassium content to about 0.7% potassium content, about 0.05% potassium content to about 0.9% potassium content, about 0.05% potassium content to about 1% potassium content, about 0.05% potassium content to about 1.5% potassium content, about 0.05% potassium content to about 2% potassium content, about 0.05% potassium content to about 2.5% potassium content, about 0.05% potassium content to about 3% potassium content, about 0.1% potassium content to about 0.2% potassium content, about 0.1% potassium content to about 0.5% potassium content, about 0.1% potassium content to about 0.7% potassium content, about 0.1% potassium content to about 0.9% potassium content, about 0.1% potassium content to about 1% potassium content, about 0.1% potassium content to about 1.5% potassium content, about 0.1% potassium content to about 2% potassium content, about 0.1% potassium content to about 2.5% potassium content, about 0.1% potassium content to about 3% potassium content, about 0.2% potassium content to about 0.5% potassium content, about 0.2% potassium content to about 0.7% potassium content, about 0.2% potassium content to about 0.9% potassium content, about 0.2% potassium content to about 1% potassium content, about 0.2% potassium content to about 1.5% potassium content, about 0.2% potassium content to about 2% potassium content, about 0.2% potassium content to about 2.5% potassium content, about 0.2% potassium content to about 3% potassium content, about 0.5% potassium content to about 0.7% potassium content, about 0.5% potassium content to about 0.9% potassium content, about 0.5% potassium content to about 1% potassium content, about 0.5% potassium content to about 1.5% potassium content, about 0.5% potassium content to about 2% potassium content, about 0.5% potassium content to about 2.5% potassium content, about 0.5% potassium content to about 3% potassium content, about 0.7% potassium content to about 0.9% potassium content, about 0.7% potassium content to about 1% potassium content, about 0.7% potassium content to about 1.5% potassium content, about 0.7% potassium content to about 2% potassium content, about 0.7% potassium content to about 2.5% potassium content, about 0.7% potassium content to about 3% potassium content, about 0.9% potassium content to about 1% potassium content, about 0.9% potassium content to about 1.5% potassium content, about 0.9% potassium content to about 2% potassium content, about 0.9% potassium content to about 2.5% potassium content, about 0.9% potassium content to about 3% potassium content, about 1% potassium content to about 1.5% potassium content, about 1% potassium content to about 2% potassium content, about 1% potassium content to about 2.5% potassium content, about 1% potassium content to about 3% potassium content, about 1.5% potassium content to about 2% potassium content, about 1.5% potassium content to about 2.5% potassium content, about 1.5% potassium content to about 3% potassium content, about 2% potassium content to about 2.5% potassium content, about 2% potassium content to about 3% potassium content, or about 2.5% potassium content to about 3% potassium content. In some embodiments, the Arundo stalks, fibers, leaves, or chips may comprise by weight no more than about 0.05% potassium content, about 0.1% potassium content, about 0.2% potassium content, about 0.5% potassium content, about 0.7% potassium content, about 0.9% potassium content, about 1% potassium content, about 1.5% potassium content, about 2% potassium content, about 2.5% potassium content, or about 3% potassium content. In some embodiments, the Arundo stalks, fibers, leaves, or chips may comprise by weight no more than at least about 0.05% potassium content, about 0.1% potassium content, about 0.2% potassium content, about 0.5% potassium content, about 0.7% potassium content, about 0.9% potassium content, about 1% potassium content, about 1.5% potassium content, about 2% potassium content, or about 2.5% potassium content. In some embodiments, the Arundo stalks, fibers, leaves, or chips may comprise by weight no more than at most about 0.1% potassium content, about 0.2% potassium content, about 0.5% potassium content, about 0.7% potassium content, about 0.9% potassium content, about 1% potassium content, about 1.5% potassium content, about 2% potassium content, about 2.5% potassium content, or about 3% potassium content.

In some embodiments, the Arundo stalks, fibers, leaves, or chips may comprise by weight no more than about 0.05% ash content to about 8% ash content. In some embodiments, the Arundo stalks, fibers, leaves, or chips may comprise by weight no more than about 0.05% ash content to about 0.1% ash content, about 0.05% ash content to about 0.2% ash content, about 0.05% ash content to about 0.5% ash content, about 0.05% ash content to about 0.7% ash content, about 0.05% ash content to about 0.9% ash content, about 0.05% ash content to about 1% ash content, about 0.05% ash content to about 1.5% ash content, about 0.05% ash content to about 2% ash content, about 0.05% ash content to about 2.5% ash content, about 0.05% ash content to about 3% ash content, about 0.05% ash content to about 6% ash content, about 0.1% ash content to about 0.2% ash content, about 0.1% ash content to about 0.5% ash content, about 0.1% ash content to about 0.7% ash content, about 0.1% ash content to about 0.9% ash content, about 0.1% ash content to about 1% ash content, about 0.1% ash content to about 1.5% ash content, about 0.1% ash content to about 2% ash content, about 0.1% ash content to about 2.5% ash content, about 0.1% ash content to about 3% ash content, about 0.1% ash content to about 6% ash content, about 0.2% ash content to about 0.5% ash content, about 0.2% ash content to about 0.7% ash content, about 0.2% ash content to about 0.9% ash content, about 0.2% ash content to about 1% ash content, about 0.2% ash content to about 1.5% ash content, about 0.2% ash content to about 2% ash content, about 0.2% ash content to about 2.5% ash content, about 0.2% ash content to about 3% ash content, about 0.2% ash content to about 6% ash content, about 0.5% ash content to about 0.7% ash content, about 0.5% ash content to about 0.9% ash content, about 0.5% ash content to about 1% ash content, about 0.5% ash content to about 1.5% ash content, about 0.5% ash content to about 2% ash content, about 0.5% ash content to about 2.5% ash content, about 0.5% ash content to about 3% ash content, about 0.5% ash content to about 6% ash content, about 0.7% ash content to about 0.9% ash content, about 0.7% ash content to about 1% ash content, about 0.7% ash content to about 1.5% ash content, about 0.7% ash content to about 2% ash content, about 0.7% ash content to about 2.5% ash content, about 0.7% ash content to about 3% ash content, about 0.7% ash content to about 6% ash content, about 0.9% ash content to about 1% ash content, about 0.9% ash content to about 1.5% ash content, about 0.9% ash content to about 2% ash content, about 0.9% ash content to about 2.5% ash content, about 0.9% ash content to about 3% ash content, about 0.9% ash content to about 6% ash content, about 1% ash content to about 1.5% ash content, about 1% ash content to about 2% ash content, about 1% ash content to about 2.5% ash content, about 1% ash content to about 3% ash content, about 1% ash content to about 6% ash content, about 1.5% ash content to about 2% ash content, about 1.5% ash content to about 2.5% ash content, about 1.5% ash content to about 3% ash content, about 1.5% ash content to about 6% ash content, about 2% ash content to about 2.5% ash content, about 2% ash content to about 3% ash content, about 2% ash content to about 6% ash content, about 2.5% ash content to about 3% ash content, about 2.5% ash content to about 6% ash content, or about 3% ash content to about 6% ash content. In some embodiments, the Arundo stalks, fibers, leaves, or chips may comprise by weight no more than about 0.05% ash content, about 0.1% ash content, about 0.2% ash content, about 0.5% ash content, about 0.7% ash content, about 0.9% ash content, about 1% ash content, about 1.5% ash content, about 2% ash content, about 2.5% ash content, about 3% ash content, or about 6% ash content. In some embodiments, the Arundo stalks, fibers, leaves, or chips may comprise by weight no more than at least about 0.05% ash content, about 0.1% ash content, about 0.2% ash content, about 0.5% ash content, about 0.7% ash content, about 0.9% ash content, about 1% ash content, about 1.5% ash content, about 2% ash content, about 2.5% ash content, or about 3% ash content. In some embodiments, the Arundo stalks, fibers, leaves, or chips may comprise by weight no more than at most about 0.1% ash content, about 0.2% ash content, about 0.5% ash content, about 0.7% ash content, about 0.9% ash content, about 1% ash content, about 1.5% ash content, about 2% ash content, about 2.5% ash content, about 3% ash content, or about 8% ash content.

In some embodiments, the Arundo stalks, fibers, leaves, or chips may comprise by no more than about 1 mg/kg of potassium to about 30,000 mg/kg of potassium. In some embodiments, the Arundo stalks, fibers, leaves, or chips may comprise by no more than about 1 mg/kg of potassium to about 100 mg/kg of potassium, about 1 mg/kg of potassium to about 500 mg/kg of potassium, about 1 mg/kg of potassium to about 1,000 mg/kg of potassium, about 1 mg/kg of potassium to about 2,000 mg/kg of potassium, about 1 mg/kg of potassium to about 3,000 mg/kg of potassium, about 1 mg/kg of potassium to about 4,000 mg/kg of potassium, about 1 mg/kg of potassium to about 5,000 mg/kg of potassium, about 1 mg/kg of potassium to about 7,500 mg/kg of potassium, about 1 mg/kg of potassium to about 10,000 mg/kg of potassium, about 1 mg/kg of potassium to about 15,500 mg/kg of potassium, about 1 mg/kg of potassium to about 30,000 mg/kg of potassium, about 100 mg/kg of potassium to about 500 mg/kg of potassium, about 100 mg/kg of potassium to about 1,000 mg/kg of potassium, about 100 mg/kg of potassium to about 2,000 mg/kg of potassium, about 100 mg/kg of potassium to about 3,000 mg/kg of potassium, about 100 mg/kg of potassium to about 4,000 mg/kg of potassium, about 100 mg/kg of potassium to about 5,000 mg/kg of potassium, about 100 mg/kg of potassium to about 7,500 mg/kg of potassium, about 100 mg/kg of potassium to about 10,000 mg/kg of potassium, about 100 mg/kg of potassium to about 15,500 mg/kg of potassium, about 100 mg/kg of potassium to about 30,000 mg/kg of potassium, about 500 mg/kg of potassium to about 1,000 mg/kg of potassium, about 500 mg/kg of potassium to about 2,000 mg/kg of potassium, about 500 mg/kg of potassium to about 3,000 mg/kg of potassium, about 500 mg/kg of potassium to about 4,000 mg/kg of potassium, about 500 mg/kg of potassium to about 5,000 mg/kg of potassium, about 500 mg/kg of potassium to about 7,500 mg/kg of potassium, about 500 mg/kg of potassium to about 10,000 mg/kg of potassium, about 500 mg/kg of potassium to about 15,500 mg/kg of potassium, about 500 mg/kg of potassium to about 30,000 mg/kg of potassium, about 1,000 mg/kg of potassium to about 2,000 mg/kg of potassium, about 1,000 mg/kg of potassium to about 3,000 mg/kg of potassium, about 1,000 mg/kg of potassium to about 4,000 mg/kg of potassium, about 1,000 mg/kg of potassium to about 5,000 mg/kg of potassium, about 1,000 mg/kg of potassium to about 7,500 mg/kg of potassium, about 1,000 mg/kg of potassium to about 10,000 mg/kg of potassium, about 1,000 mg/kg of potassium to about 15,500 mg/kg of potassium, about 1,000 mg/kg of potassium to about 30,000 mg/kg of potassium, about 2,000 mg/kg of potassium to about 3,000 mg/kg of potassium, about 2,000 mg/kg of potassium to about 4,000 mg/kg of potassium, about 2,000 mg/kg of potassium to about 5,000 mg/kg of potassium, about 2,000 mg/kg of potassium to about 7,500 mg/kg of potassium, about 2,000 mg/kg of potassium to about 10,000 mg/kg of potassium, about 2,000 mg/kg of potassium to about 15,500 mg/kg of potassium, about 2,000 mg/kg of potassium to about 30,000 mg/kg of potassium, about 3,000 mg/kg of potassium to about 4,000 mg/kg of potassium, about 3,000 mg/kg of potassium to about 5,000 mg/kg of potassium, about 3,000 mg/kg of potassium to about 7,500 mg/kg of potassium, about 3,000 mg/kg of potassium to about 10,000 mg/kg of potassium, about 3,000 mg/kg of potassium to about 15,500 mg/kg of potassium, about 3,000 mg/kg of potassium to about 30,000 mg/kg of potassium, about 4,000 mg/kg of potassium to about 5,000 mg/kg of potassium, about 4,000 mg/kg of potassium to about 7,500 mg/kg of potassium, about 4,000 mg/kg of potassium to about 10,000 mg/kg of potassium, about 4,000 mg/kg of potassium to about 15,500 mg/kg of potassium, about 4,000 mg/kg of potassium to about 30,000 mg/kg of potassium, about 5,000 mg/kg of potassium to about 7,500 mg/kg of potassium, about 5,000 mg/kg of potassium to about 10,000 mg/kg of potassium, about 5,000 mg/kg of potassium to about 15,500 mg/kg of potassium, about 5,000 mg/kg of potassium to about 30,000 mg/kg of potassium, about 7,500 mg/kg of potassium to about 10,000 mg/kg of potassium, about 7,500 mg/kg of potassium to about 15,500 mg/kg of potassium, about 7,500 mg/kg of potassium to about 30,000 mg/kg of potassium, about 10,000 mg/kg of potassium to about 15,500 mg/kg of potassium, about 10,000 mg/kg of potassium to about 30,000 mg/kg of potassium, or about 15,500 mg/kg of potassium to about 30,000 mg/kg of potassium. In some embodiments, the Arundo stalks, fibers, leaves, or chips may comprise by no more than about 1 mg/kg of potassium, about 100 mg/kg of potassium, about 500 mg/kg of potassium, about 1,000 mg/kg of potassium, about 2,000 mg/kg of potassium, about 3,000 mg/kg of potassium, about 4,000 mg/kg of potassium, about 5,000 mg/kg of potassium, about 7,500 mg/kg of potassium, about 10,000 mg/kg of potassium, about 15,500 mg/kg of potassium, or about 30,000 mg/kg of potassium.

In some embodiments, the Arundo stalks, fibers, leaves, or chips may comprise by no more than about 1 mg/kg of sodium to about 1,000 mg/kg of sodium. In some embodiments, the Arundo stalks, fibers, leaves, or chips may comprise by no more than about 1 mg/kg of sodium to about 50 mg/kg of sodium, about 1 mg/kg of sodium to about 100 mg/kg of sodium, about 1 mg/kg of sodium to about 200 mg/kg of sodium, about 1 mg/kg of sodium to about 300 mg/kg of sodium, about 1 mg/kg of sodium to about 400 mg/kg of sodium, about 1 mg/kg of sodium to about 500 mg/kg of sodium, about 1 mg/kg of sodium to about 600 mg/kg of sodium, about 1 mg/kg of sodium to about 700 mg/kg of sodium, about 1 mg/kg of sodium to about 800 mg/kg of sodium, about 1 mg/kg of sodium to about 900 mg/kg of sodium, about 1 mg/kg of sodium to about 1,000 mg/kg of sodium, about 50 mg/kg of sodium to about 100 mg/kg of sodium, about 50 mg/kg of sodium to about 200 mg/kg of sodium, about 50 mg/kg of sodium to about 300 mg/kg of sodium, about 50 mg/kg of sodium to about 400 mg/kg of sodium, about 50 mg/kg of sodium to about 500 mg/kg of sodium, about 50 mg/kg of sodium to about 600 mg/kg of sodium, about 50 mg/kg of sodium to about 700 mg/kg of sodium, about 50 mg/kg of sodium to about 800 mg/kg of sodium, about 50 mg/kg of sodium to about 900 mg/kg of sodium, about 50 mg/kg of sodium to about 1,000 mg/kg of sodium, about 100 mg/kg of sodium to about 200 mg/kg of sodium, about 100 mg/kg of sodium to about 300 mg/kg of sodium, about 100 mg/kg of sodium to about 400 mg/kg of sodium, about 100 mg/kg of sodium to about 500 mg/kg of sodium, about 100 mg/kg of sodium to about 600 mg/kg of sodium, about 100 mg/kg of sodium to about 700 mg/kg of sodium, about 100 mg/kg of sodium to about 800 mg/kg of sodium, about 100 mg/kg of sodium to about 900 mg/kg of sodium, about 100 mg/kg of sodium to about 1,000 mg/kg of sodium, about 200 mg/kg of sodium to about 300 mg/kg of sodium, about 200 mg/kg of sodium to about 400 mg/kg of sodium, about 200 mg/kg of sodium to about 500 mg/kg of sodium, about 200 mg/kg of sodium to about 600 mg/kg of sodium, about 200 mg/kg of sodium to about 700 mg/kg of sodium, about 200 mg/kg of sodium to about 800 mg/kg of sodium, about 200 mg/kg of sodium to about 900 mg/kg of sodium, about 200 mg/kg of sodium to about 1,000 mg/kg of sodium, about 300 mg/kg of sodium to about 400 mg/kg of sodium, about 300 mg/kg of sodium to about 500 mg/kg of sodium, about 300 mg/kg of sodium to about 600 mg/kg of sodium, about 300 mg/kg of sodium to about 700 mg/kg of sodium, about 300 mg/kg of sodium to about 800 mg/kg of sodium, about 300 mg/kg of sodium to about 900 mg/kg of sodium, about 300 mg/kg of sodium to about 1,000 mg/kg of sodium, about 400 mg/kg of sodium to about 500 mg/kg of sodium, about 400 mg/kg of sodium to about 600 mg/kg of sodium, about 400 mg/kg of sodium to about 700 mg/kg of sodium, about 400 mg/kg of sodium to about 800 mg/kg of sodium, about 400 mg/kg of sodium to about 900 mg/kg of sodium, about 400 mg/kg of sodium to about 1,000 mg/kg of sodium, about 500 mg/kg of sodium to about 600 mg/kg of sodium, about 500 mg/kg of sodium to about 700 mg/kg of sodium, about 500 mg/kg of sodium to about 800 mg/kg of sodium, about 500 mg/kg of sodium to about 900 mg/kg of sodium, about 500 mg/kg of sodium to about 1,000 mg/kg of sodium, about 600 mg/kg of sodium to about 700 mg/kg of sodium, about 600 mg/kg of sodium to about 800 mg/kg of sodium, about 600 mg/kg of sodium to about 900 mg/kg of sodium, about 600 mg/kg of sodium to about 1,000 mg/kg of sodium, about 700 mg/kg of sodium to about 800 mg/kg of sodium, about 700 mg/kg of sodium to about 900 mg/kg of sodium, about 700 mg/kg of sodium to about 1,000 mg/kg of sodium, about 800 mg/kg of sodium to about 900 mg/kg of sodium, about 800 mg/kg of sodium to about 1,000 mg/kg of sodium, or about 900 mg/kg of sodium to about 1,000 mg/kg of sodium. In some embodiments, the Arundo stalks, fibers, leaves, or chips may comprise by no more than about 1 mg/kg of sodium, about 50 mg/kg of sodium, about 100 mg/kg of sodium, about 200 mg/kg of sodium, about 300 mg/kg of sodium, about 400 mg/kg of sodium, about 500 mg/kg of sodium, about 600 mg/kg of sodium, about 700 mg/kg of sodium, about 800 mg/kg of sodium, about 900 mg/kg of sodium, or about 1,000 mg/kg of sodium.

In some embodiments, the Arundo stalks, fibers, leaves, or chips may comprise by weight no more than about 1% ash content to about 12% ash content. In some embodiments, the Arundo stalks, fibers, leaves, or chips may comprise by weight no more than about 1% ash content to about 2% ash content, about 1% ash content to about 3% ash content, about 1% ash content to about 4% ash content, about 1% ash content to about 5% ash content, about 1% ash content to about 6% ash content, about 1% ash content to about 7% ash content, about 1% ash content to about 8% ash content, about 1% ash content to about 9% ash content, about 1% ash content to about 10% ash content, about 1% ash content to about 11% ash content, about 1% ash content to about 12% ash content, about 2% ash content to about 3% ash content, about 2% ash content to about 4% ash content, about 2% ash content to about 5% ash content, about 2% ash content to about 6% ash content, about 2% ash content to about 7% ash content, about 2% ash content to about 8% ash content, about 2% ash content to about 9% ash content, about 2% ash content to about 10% ash content, about 2% ash content to about 11% ash content, about 2% ash content to about 12% ash content, about 3% ash content to about 4% ash content, about 3% ash content to about 5% ash content, about 3% ash content to about 6% ash content, about 3% ash content to about 7% ash content, about 3% ash content to about 8% ash content, about 3% ash content to about 9% ash content, about 3% ash content to about 10% ash content, about 3% ash content to about 11% ash content, about 3% ash content to about 12% ash content, about 4% ash content to about 5% ash content, about 4% ash content to about 6% ash content, about 4% ash content to about 7% ash content, about 4% ash content to about 8% ash content, about 4% ash content to about 9% ash content, about 4% ash content to about 10% ash content, about 4% ash content to about 11% ash content, about 4% ash content to about 12% ash content, about 5% ash content to about 6% ash content, about 5% ash content to about 7% ash content, about 5% ash content to about 8% ash content, about 5% ash content to about 9% ash content, about 5% ash content to about 10% ash content, about 5% ash content to about 11% ash content, about 5% ash content to about 12% ash content, about 6% ash content to about 7% ash content, about 6% ash content to about 8% ash content, about 6% ash content to about 9% ash content, about 6% ash content to about 10% ash content, about 6% ash content to about 11% ash content, about 6% ash content to about 12% ash content, about 7% ash content to about 8% ash content, about 7% ash content to about 9% ash content, about 7% ash content to about 10% ash content, about 7% ash content to about 11% ash content, about 7% ash content to about 12% ash content, about 8% ash content to about 9% ash content, about 8% ash content to about 10% ash content, about 8% ash content to about 11% ash content, about 8% ash content to about 12% ash content, about 9% ash content to about 10% ash content, about 9% ash content to about 11% ash content, about 9% ash content to about 12% ash content, about 10% ash content to about 11% ash content, about 10% ash content to about 12% ash content, or about 11% ash content to about 12% ash content. In some embodiments, the Arundo stalks, fibers, leaves, or chips may comprise by weight no more than about 1% ash content, about 2% ash content, about 3% ash content, about 4% ash content, about 5% ash content, about 6% ash content, about 7% ash content, about 8% ash content, about 9% ash content, about 10% ash content, about 11% ash content, or about 12% ash content.

In some embodiments, the fuel composition may comprise an energy content of about 7,000 BTU/lb to about 11,000 BTU/lb. In some embodiments, the fuel composition may comprise an energy content of about 7,000 BTU/lb to about 8,000 BTU/lb, about 7,000 BTU/lb to about 9,000 BTU/lb, about 7,000 BTU/lb to about 10,000 BTU/lb, about 7,000 BTU/lb to about 11,000 BTU/lb, about 8,000 BTU/lb to about 9,000 BTU/lb, about 8,000 BTU/lb to about 10,000 BTU/lb, about 8,000 BTU/lb to about 11,000 BTU/lb, about 9,000 BTU/lb to about 10,000 BTU/lb, about 9,000 BTU/lb to about 11,000 BTU/lb, or about 10,000 BTU/lb to about 11,000 BTU/lb. In some embodiments, the fuel composition may comprise an energy content of about 7,000 BTU/lb, about 8,000 BTU/lb, about 9,000 BTU/lb, about 10,000 BTU/lb, or about 11,000 BTU/lb. In some embodiments, the fuel composition may comprise an energy content of at least about 7,000 BTU/lb, about 8,000 BTU/lb, about 9,000 BTU/lb, or about 10,000 BTU/lb. In some embodiments, the fuel composition may comprise an energy content of at most about 8,000 BTU/lb, about 9,000 BTU/lb, about 10,000 BTU/lb, or about 11,000 BTU/lb.

In some embodiments, the absorptive pellets may absorb at least about 90% of their weight of liquid to about 350% of their weight of liquid. In some embodiments, the absorptive pellets may absorb at least about 90% of their weight of liquid to about 100% of their weight of liquid, about 90% of their weight of liquid to about 150% of their weight of liquid, about 90% of their weight of liquid to about 200% of their weight of liquid, about 90% of their weight of liquid to about 225% of their weight of liquid, about 90% of their weight of liquid to about 250% of their weight of liquid, about 90% of their weight of liquid to about 275% of their weight of liquid, about 90% of their weight of liquid to about 285% of their weight of liquid, about 90% of their weight of liquid to about 300% of their weight of liquid, about 90% of their weight of liquid to about 350% of their weight of liquid, about 100% of their weight of liquid to about 150% of their weight of liquid, about 100% of their weight of liquid to about 200% of their weight of liquid, about 100% of their weight of liquid to about 225% of their weight of liquid, about 100% of their weight of liquid to about 250% of their weight of liquid, about 100% of their weight of liquid to about 275% of their weight of liquid, about 100% of their weight of liquid to about 285% of their weight of liquid, about 100% of their weight of liquid to about 300% of their weight of liquid, about 100% of their weight of liquid to about 350% of their weight of liquid, about 150% of their weight of liquid to about 200% of their weight of liquid, about 150% of their weight of liquid to about 225% of their weight of liquid, about 150% of their weight of liquid to about 250% of their weight of liquid, about 150% of their weight of liquid to about 275% of their weight of liquid, about 150% of their weight of liquid to about 285% of their weight of liquid, about 150% of their weight of liquid to about 300% of their weight of liquid, about 150% of their weight of liquid to about 350% of their weight of liquid, about 200% of their weight of liquid to about 225% of their weight of liquid, about 200% of their weight of liquid to about 250% of their weight of liquid, about 200% of their weight of liquid to about 275% of their weight of liquid, about 200% of their weight of liquid to about 285% of their weight of liquid, about 200% of their weight of liquid to about 300% of their weight of liquid, about 200% of their weight of liquid to about 350% of their weight of liquid, about 225% of their weight of liquid to about 250% of their weight of liquid, about 225% of their weight of liquid to about 275% of their weight of liquid, about 225% of their weight of liquid to about 285% of their weight of liquid, about 225% of their weight of liquid to about 300% of their weight of liquid, about 225% of their weight of liquid to about 350% of their weight of liquid, about 250% of their weight of liquid to about 275% of their weight of liquid, about 250% of their weight of liquid to about 285% of their weight of liquid, about 250% of their weight of liquid to about 300% of their weight of liquid, about 250% of their weight of liquid to about 350% of their weight of liquid, about 275% of their weight of liquid to about 285% of their weight of liquid, about 275% of their weight of liquid to about 300% of their weight of liquid, about 275% of their weight of liquid to about 350% of their weight of liquid, about 285% of their weight of liquid to about 300% of their weight of liquid, about 285% of their weight of liquid to about 350% of their weight of liquid, or about 300% of their weight of liquid to about 350% of their weight of liquid. In some embodiments, the absorptive pellets may absorb at least about 90% of their weight of liquid, about 100% of their weight of liquid, about 150% of their weight of liquid, about 200% of their weight of liquid, about 225% of their weight of liquid, about 250% of their weight of liquid, about 275% of their weight of liquid, about 285% of their weight of liquid, about 300% of their weight of liquid, or about 350% of their weight of liquid. In some embodiments, the absorptive pellets may absorb at least at least about 90% of their weight of liquid, about 100% of their weight of liquid, about 150% of their weight of liquid, about 200% of their weight of liquid, about 225% of their weight of liquid, about 250% of their weight of liquid, about 275% of their weight of liquid, about 285% of their weight of liquid, or about 300% of their weight of liquid. In some embodiments, the absorptive pellets may absorb at least at most about 100% of their weight of liquid, about 150% of their weight of liquid, about 200% of their weight of liquid, about 225% of their weight of liquid, about 250% of their weight of liquid, about 275% of their weight of liquid, about 285% of their weight of liquid, about 300% of their weight of liquid, or about 350% of their weight of liquid.

### EXAMPLES

### Greenhouse Acclimatization of Tissue Cloned Arundo Grass Plants

Clone units arrive at a greenhouse in light proof containers. If the clone units are transported in agar gel, the gel is removed prior to planting. Clone units are not be exposed to direct sunlight and are handled with gloves and curved forceps to prevent damage to the plants. Each clone unit is placed in the cell of a 1-inch circular plug tray containing a planting medium, for example, sterile potting soil. The plug tray is irrigated to moisten the soil. Misting of the planting units is avoided to reduce leaf decay. Clone units are shaded (not placed in direct sunlight) for 7-14 days of root establishment at between 300-600 foot candles of light. The greenhouse temperature is kept at least 68° F. to encourage rapid root establishment and shoot growth. Roots of new plantlets are established by day 21.

### Storage of Planting Units

Planting units are stored in 200-300 foot candles of light at 45-50° F. to cause growth cessation. Planting unit soil should be moist but planting units are not watered during storage to prevent mold and over saturation of soil.

### Shoot Separation

Shoot separation to create additional planting units is performed by planting clone units in sterile potting soil in 3-4″ pots to encourage multiple shoot production. After 4-6 weeks, new shoots from the original planting unit are sliced with care to include root material with the sliced sections of shoot to assure viability. New shoots are planted in 1-inch circular plug trays and returned to the greenhouse for 6-8 weeks for maturation of plant and roots prior to planting in a field.

### Chip Production

For certain end-use applications, Arundo grass is harvested using a sugar cane harvester or the like. The resulting post-harvest feedstock is 190-460 mm pieces of Arundo grass stalks without the leaves attached. These stalks are processed into 10-40 mm chips. Preferably, the moisture content of the stalks is above 40% to assist cutting and minimization of material loss in the form of sawdust, for example. Arundo grass stalks are harvested in mesh bins. The 190-460 mm pieces of Arundo grass stalks are dumped on to a conveyer and fed through a sand and leaf separator with waste material collected below the apparatus. Cleaned stalks are rinsed in a drum washer to remove inorganic material that may cause additional wear of processing equipment and to reduce the ash, Cl, K, and Na levels in the material. A roller grader separates stalk sizes with the smallest diameter stalks sorted out. The diameter used is determined based on application. Remaining stalks are conveyed onto to corrugated orienting vibration conveyer that orients the stalks in a single direction in preparation for cutting. Oriented stalks are conveyed towards a slicer with ceiling rollers to maintain orientation. Stalks are pushed into mesh grate to section stalks evenly and then sliced using rotating slicer to cut the stalks to a predetermine length. The resulting chips are optionally conveyed to a drum washer if they will be used to produce chips that need a lower ash, Na, Cl, and/or K level (e.g., for use in or as fuel compositions). Otherwise, chips are conveyed directly to mesh bins for drying or shipping.

### Bioremediation of Soil

Arundo plant chips produced by methods described herein were tested for the content of several elements, resulting in the following values: Calcium 800 mg/kg, Magnesium-1200 mg/kg, Phosphorus-1000 mg/kg, Chlorine-5000 mg/kg. Additional elements were tested and results are shown below in Table 1A.

TABLE 1A
Results of testing Arundo donax fiber
from Arundo donax plants used to
bioremediate soil.

| | (μg/g) |
|---|---|
| Aluminum | 1 |
| Antimony | <5 |
| Arsenic | <5 |
| Barium | 1.68 |
| Beryllium | <0.1 |
| Boron | <1 |
| Cadmium | <0.5 |
| Chromium | 4.1 |
| Cobalt | 6.7 |
| Copper | 1.6 |
| Iron | 18 |
| Lead | <5 |
| Lithium | <0.5 |
| Magnesium | 1090 |
| Molybdenum | <1 |
| Nickel | 5.6 |
| Phosphorus | 514 |
| Potassium | 15200 |
| Selenium | <5 |
| Silicon | 234 |
| Silver | <0.5 |
| Strontium | 4.51 |
| Sulfur | 2350 |
| Thallium | <5 |
| Tin | <5 |
| Titanium | <0.5 |
| Vanadium | 0.7 |
| Zinc | 8.2 |

The fiber from giant perennial grass sample was ground prior to analysis. Loss on drying was determined in air at 105 degrees C. overnight using ground sample. All results were determined on dried ground sample weight basis and calculated to and reported on an as received sample basis. 58−Ash percentage was determined after stage ashing to 750 degrees C. in air and holding at temperature for 8 hours. 61−Oxygen by difference is calculated as (100−C−H−N−S−ash) % and may be in error due to oxidation of inorganic components during ashing, double subtraction of components such as sulfur remaining in the ash, or volatilization of other species (such as halogens) not measured or subtracted.

These same tests demonstrated that the plant can take up the following elements which are not naturally occurring in the plant: Aluminum, Antimony, Arsenic, Barium, Beryllium, Boron, Cadmium, Chromium, Cobalt, Copper, Iron, Magnesium, Manganese, Nickel, and Phosphorus.

Bioremediation of soil is conducted by planting an Arundo grass plant in soil contaminated with, for example, Cadmium using a method described herein. The plants are harvested and used for fuel applications. After several planting and harvesting cycles, the soil is substantially free of Cadmium and rendered safe for food production.

Bioremediation of soil is conducted by planting an Arundo grass plant in soil contaminated with, for example, Mercury (Hg) using a method described herein. The plants are harvested and used for fuel applications. After several planting and harvesting cycles, the soil is substantially free of Mercury (Hg) and rendered safe for food production.

### Harvesting for Sugar Applications

Arundo plants produced by methods described herein are harvested prior to the plants entering dormancy/cessation, such as by harvesting during the new moon. Harvesting the plants at this stage increases the sugar content of the stalks and leaves compared to harvesting the plants at other times.

### Effect of Plant Spacing on Annual Yield

A single phenotype was tested by row plantings in test plots with spacings of 0.25, 0.5, 1.0, and 2.0 meters between each plant. All test plots received the same irrigation and external Nitrogen (N) dosage (added as a nitrate fertilizer). Annual yields reported measured for stalk material only (meaning leaves and leaf-stems were not included in the weights). Results are shown in Table 1b.

TABLE 1b
Annual stalk yield as a function of spacing between adjacent
plants using an example Arundo donax phenotype grown
according to methods described herein and
resulting annual tonnage.

| BDT*/Hectare/Year | 0.25 m | 0.5 m | 1.0 m | 2.0 m |
|---|---|---|---|---|
| Year 1 BDT | 32.4 | 34.3 | 37.3 | 37.1 |
| Year 2 BDT | 43.0 | 42.2 | 55.1 | 55.3 |
| Year 3 BDT | 41.5 | 43.0 | 65.0 | 66.9 |
| Year 4 BDT | 39.5 | 46.2 | 67.4 | 69.4 |

*BDT = bone dry metric ton

### Stalk Yield of Example Phenotypes of Arundo Donax

Eight selected example phenotypes of Arundo donax were grown using methods described herein. Results are shown in Table 2.

TABLE 2
Phenotype volume testing. Production volume of eight
(8) selectively bred phenotypes of Arundo donax.

| | Year 1 | | Year 2 | | Year 3 | | Year 4 | |
|---|---|---|---|---|---|---|---|---|
| | Avg. | | Avg. | | Avg. | | Avg. | |
| | Height | | Height | | Height | | Height | |
| | (m) | BDT* | (m) | BDT | (m) | BDT | (m) | BDT |
| Phenotype 1 | 5.89 | 37.3 | 6.1 | 55.1 | 7.2 | 65.0 | 7.1 | 67.4 |
| Phenotype 2 | 3.40 | 14.5 | 3.7 | 16.7 | 4.2 | 22.6 | 4.6 | 24.6 |
| Phenotype 3 | 3.89 | 17.1 | 4.3 | 24.7 | 4.7 | 27.8 | 5.0 | 31.4 |
| Phenotype 4 | 4.22 | 20.0 | 5.1 | 31.1 | 5.1 | 29.0 | 5.4 | 32.3 |
| Phenotype 5 | 6.01 | 25.2 | 6.0 | 39.6 | 6.3 | 45.6 | 6.3 | 46.1 |
| Phenotype 6 | 5.64 | 26.1 | 5.6 | 34.8 | 6.1 | 45.8 | 7.1 | 50.2 |
| Phenotype 7 | 4.95 | 24.8 | 4.0 | 30.1 | 5.7 | 50.2 | 7.4 | 68.3 |
| Phenotype 8 | 6.21 | 28.5 | 6.7 | 36.6 | 6.8 | 56.4 | 7.8 | 75.1 |

*BDT = bone dry metric ton

All test plots received the same irrigation and N dosage. Eight (8) stalks were selected from each plant for height measurement.

### Effect of External Nitrogen (Added as Nitrate Fertilizer) on Annual Stalk Yield

Three samples each of selected example phenotypes of Arundo donax were grown using methods described herein and different amounts of added N (as nitrate fertilizer). Results are shown in Table 3.

TABLE 3
Production volume of five (5) samples of three (3)
selectively bred phenotypes of Arundo donax.

| | N | | N | | N | | N | |
|---|---|---|---|---|---|---|---|---|
| | (kg/ha) | BDT* | (kg/ha) | BDT | (kg/ha) | BDT | (kg/ha) | Tons |
| Phenotype 1 | | | | | | | | |
| Sample 1 | 0 | 14.5 | 0 | 16.7 | 0 | 17.0 | 0 | 16.9 |
| Sample 2 | 20 | 17.1 | 20 | 24.7 | 20 | 25.7 | 20 | 24.9 |
| Sample 3 | 40 | 20.0 | 40 | 35.1 | 40 | 38.9 | 40 | 42.3 |
| Sample 4 | 60 | 25.2 | 60 | 39.6 | 60 | 56.8 | 60 | 59.7 |
| Sample 5** | 80 | 26.1 | 80 | 42.8 | 80 | 60.1 | 80 | 61.0 |
| Phenotype 2 | | | | | | | | |
| Sample 1 | 0 | 12.1 | 0 | 16.7 | 0 | 22.6 | 0 | 25.4 |
| Sample 2 | 20 | 15.4 | 20 | 22.2 | 20 | 24.7 | 20 | 23.4 |
| Sample 3 | 40 | 18.9 | 40 | 27.3 | 40 | 29.1 | 40 | 31.0 |
| Sample 4 | 60 | 24.7 | 60 | 30.1 | 60 | 36.6 | 60 | 36.1 |
| Sample 5** | 80 | 28.5 | 80 | 34.6 | 80 | 44.4 | 80 | 47.5 |
| Phenotype 3 | | | | | | | | |
| Sample 1 | 0 | 17.4 | 10 | 24.1 | 10 | 31.3 | 10 | 32.3 |
| Sample 2 | 20 | 21.3 | 20 | 36.6 | 20 | 45.7 | 20 | 46.1 |
| Sample 3 | 40 | 25.8 | 40 | 42.8 | 40 | 49.3 | 40 | 50.2 |
| Sample 4 | 60 | 31.2 | 60 | 50.2 | 60 | 66.7 | 60 | 68.0 |
| Sample 5** | 80 | 30.1 | 80 | 56.4 | 80 | 69.2 | 80 | 71.2 |

**Control with application of 80 kg of N.

All test plots received the same irrigation but different N dosage. For each phenotype, five representative plots were planted and varying levels of N applied to each. Annual yields measure for stalk material only.

### Composition of Samples of Arundo Donax Grown and Harvested by Methods Described Herein

Four (4) samples of one selectively bred phenotype of Arundo donax were measured for Cellulose, hemicellulose, and lignin content determined using NREL Laboratory Analytical Procedure NREL/TP-2800-76724 and NREL/TP-510-42618. Results are shown in Table 4.

TABLE 4
Example Cellulose, Hemicellulose, and Lignin
for four (4) Arundo donax samples

| | Cellulose | Hemicellulose | Lignin |
|---|---|---|---|
| | (% wt) | (% wt) | (% wt) |
| Sample 1 | 27.47 | 27.04 | 18.55 |
| Sample 2 | 43.20 | 20.50 | 17.20 |
| Sample 3 | 31.10 | 35.27 | 18.49 |
| Sample 4 | 35.52 | 26.81 | 19.80 |

### Water Absorption of Arundo Pellets Made by Methods Described Herein

Ten replicate pellets were dried at 60° C. overnight and weighed. The dried samples were covered with approximately 400 mL deionized water. The samples were allowed to sit in the deionized water for 24 hours based on ASTM D570. A determination was made by slowly adding water to dried pellets in a plastic container until they may no longer adsorb additional water. The pellets were allowed to sit for 24 hours, and additional water was added dropwise to ensure the pellets were completely saturated. Any water not adsorbed by the pellets was removed from the container and then the wet sample weight was determined, and Water Adsorption calculated. Results are shown below in Table 5.

TABLE 5
Arundo donax pellet water absorption testing.

| | | | Water | |
|---|---|---|---|---|
| | Sample wt | Wet sample | Absorption % | Average |
| Sample | grams | wt grams | w/w | Adsorption |
| 1 | 0.5434 | 2.0063 | 269.2 | 270.3 +/− 12.7 |
| 2 | 0.6528 | 2.3162 | 254.8 | |
| 3 | 0.6264 | 2.4167 | 285.8 | |
| 4 | 0.5627 | 2.0886 | 271.2 | |

### Oriented Strand Board Produced by Methods Described Herein

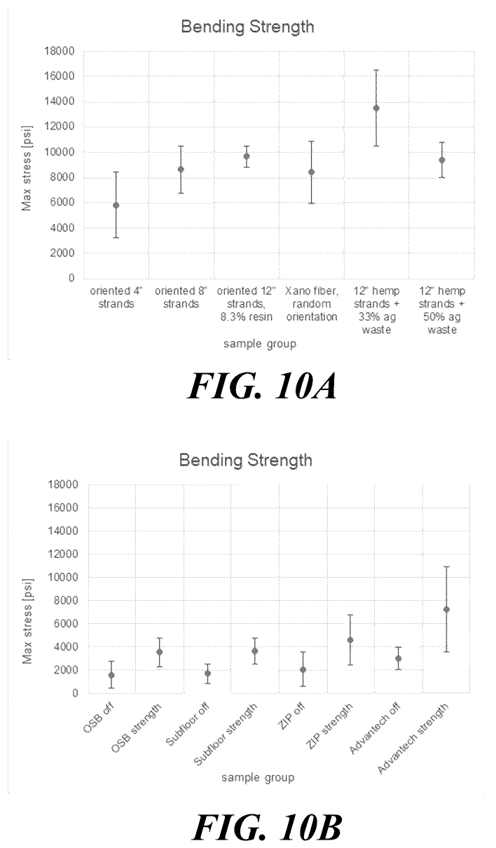

Testing was conducted on 5 sample oriented strand boards made from Arundo strands produced by methods described herein. The testing was performed using ASTM D1037-12 (2020)-“Standard Test Methods for Evaluating Properties of Wood-Base Fiber and Particle Panel Materials.” Results are shown in Table 6. Bending strength of the example Arundo donax oriented strand board was measured and compared to oriented strand boards using other materials as shown in FIG. 10A and FIG. 10B.

TABLE 6
Production of OSB with Arundo donax fiber strands in random orientation.

| | | | | | | | | Stress |
|---|---|---|---|---|---|---|---|---|
| OSB | | | | | | | M | max |
| Sample | W (in) | H (in) | L (in) | I (in\hat{ }4) | c (in) | F (lbf) | (lbf-in) | (psi) |
| 1 | 1.02 | 0.3535 | 10 | 0.004 | 0.17675 | 33.5 | 83.75 | 3942.37 |
| 2 | 1.021 | 0.3385 | 10 | 0.003 | 0.16925 | 54 | 135 | 6923.76 |
| 3 | 1.091 | 0.3305 | 10 | 0.003 | 0.16525 | 67 | 167.5 | 8433.32 |
| 4 | 1.006 | 0.3270 | 10 | 0.003 | 0.16350 | 59 | 147.5 | 8227.16 |
| 5 | 1.009 | 0.3360 | 10 | 0.003 | 0.16800 | 75.5 | 188.75 | 9941.88 |
| | | | | | | | average | 8381.53 |
| | | | | | | | stdev | 1236.40 |

### Particle Board Produced by Methods Described Herein

Samples of particle boards containing Arundo particles and produced using methods described herein were tested for physical and mechanical properties. Physical (density and water sorption) and mechanical (tension perpendicular to surface or internal bonding and flexural) testing were performed based upon ASTM D1037-2012. Formulas for these calculations can be seen in ASTM D1037-2012. The specimens were allowed to condition in a 50% RH 70° F. environment for a minimum of 48 hours prior to testing. Results are shown below in Tables 7 (a)-7 (e).

TABLE 7(a)
Composition of Arundo Donax and Arundo Donax/wood hybrid particle board samples.

| | | | Arundo (XG) | | | | | | Furnishing | | | |
|---|---|---|---|---|---|---|---|---|---|---|---|---|
| | | Target | and Wood (W) | | Core and face | | | | moisture | | Press | Press |
| | | density | Composition (%) | | composition (%) | | Adhesive (%) | | content (%) | | time | temp |
| Formula | Replicates | (lb/ft²) | XG | W | Core | Face | Core | Face | Core | Face | (sec) | (° F.) |
| 100% Wood | 4 | 45 | 0 | 100 | 50 | 50 | 2.5 | 3 | 7.7 | 12 | 225 | 350 |
| 90% W | 4 | 45 | 10 | 90 | 50 | 50 | 2.5 | 3 | 7.7 | 12 | 225 | 350 |
| 10% XG* | | | | | | | | | | | | |
| 85% W | 4 | 45 | 15 | 85 | 50 | 50 | 2.5 | 3 | 7.7 | 12 | 225 | 350 |
| 15% XG | | | | | | | | | | | | |
| 80% W | 4 | 45 | 20 | 80 | 50 | 50 | 2.5 | 3 | 7.7 | 12 | 225 | 350 |
| 20% XG | | | | | | | | | | | | |
| 100% XG | 4 | 45 | 100 | 0 | 50 | 50 | 2.5 | 3 | 7.7 | 12 | 225 | 350 |

*W = wood. XG = (proprietary varieties of Arundo donax).

Adhesive was pMDI (Polymeric 4,4′-diphenylmethane diisocyanate; brand name: Huntsman Rubinate M).
1. The composition applied to both core and face materials, for instance, formula 2 has 10% giant reed and 90% of wood materials for both core and face.
2. Adhesive was pMDI (Polymeric 4,4′-diphenylmethane diisocyanate; brand name: Huntsman Rubinate M).
3. Both the Arundo donax and wood materials had a moisture content (MC) of 7.7%, so we used “as-is”.

TABLE 7(b)
Density test results for Arundo Donax and Arundo
Donax/wood hybrid particle board samples.

| | Calculated | | Density |
|---|---|---|---|
| | Mean | | profile |
| Formula | (lb/ft²) | COV (%) | (lb/ft²) |
| 100% Wood | 41.8 | 4.71 | 48.1 |
| 90% W 10% XG | 44.3 | 1.42 | 50.5 |
| 85% W 15% XG | 40.2 | 2.47 | 47.6 |
| 80% W 20% XG | 41.4 | 4.39 | 48.5 |
| 100% XG | 40.2 | 1.63 | 51.2 |

Adhesive was pMDI (Polymeric 4,4′-diphenylmethane diisocyanate; brand name: Huntsman Rubinate M).

TABLE 7(c)
Flexural Properties test results for Arundo donax and
Arundo donax/wood hybrid particle board samples.

| | Modulus of | | Modulus of | | Strain @ | |
|---|---|---|---|---|---|---|
| | Elasticity | | Rupture | | Break | |
| | Mean | COV | Mean | COV | Mean | COV |
| Formula | (psi) | (%) | (psi) | (%) | (%) | (%) |
| 100% Wood | 214879 | 11.78 | 1051 | 10.85 | 0.006 | 9.44 |
| 90% W 10% XG | 280233 | 10.79 | 1609 | 17.97 | 0.007 | 13.92 |
| 85% W 15% XG | 242917 | 19.29 | 1249 | 28.85 | 0.007 | 11.04 |
| 80% W 20% XG | 246197 | 14.54 | 1273 | 20.36 | 0.005 | 50.04 |
| 100% XG | 342654 | 11.88 | 1856 | 14.4 | 0.007 | 6.75 |

TABLE 7(d)
Internal Bonding test results for Arundo donax and
Arundo donax/wood hybrid particle board samples.

| | Mean | COV | Failure |
|---|---|---|---|
| Formula | (psi) | (%) | region |
| 100% Wood | 71.9 | 10.12 | Core |
| 90% W 10% XG | 67 | 20.61 | Core |
| 85% W 15% XG | 65.1 | 15.19 | Core |
| 80% W 20% XG | 66.5 | 19.17 | Core |
| 100% XG | 53.9 | 11.46 | Core |

TABLE 7(e)
Water absorption test results for Arundo donax and
Arundo donax/wood hybrid particle board samples.

| | 2 hrs | | 24 hrs | | 2 hrs | | 24 hrs | |
|---|---|---|---|---|---|---|---|---|
| | Mean | COV | Mean | COV | Mean | COV | Mean | COV |
| Formula | (%) | (%) | (%) | (%) | (%) | (%) | (%) | (%) |
| 100% Wood | 8.85 | 14.78 | 45.39 | 16.08 | 1.24 | 38.1 | 10.14 | 28.67 |
| 90% W | 8.8 | 4.1 | 36.28 | 9.21 | 1.43 | 32.55 | 10.47 | 30.64 |
| 10% XG | | | | | | | | |
| 85% W | 11.05 | 23.28 | 46.1 | 18.27 | 1.36 | 29.92 | 11.57 | 23.93 |
| 15% XG | | | | | | | | |
| 80% W | 11.86 | 25.96 | 50.72 | 21.21 | 1.44 | 34.34 | 10.02 | 18.23 |
| 20% XG | | | | | | | | |
| 100% XG | 8.33 | 7.25 | 22.99 | 4 | 1.51 | 22.14 | 5.06 | 8.64 |

Example Products Made from Arundo donax Produced by Methods Described Herein

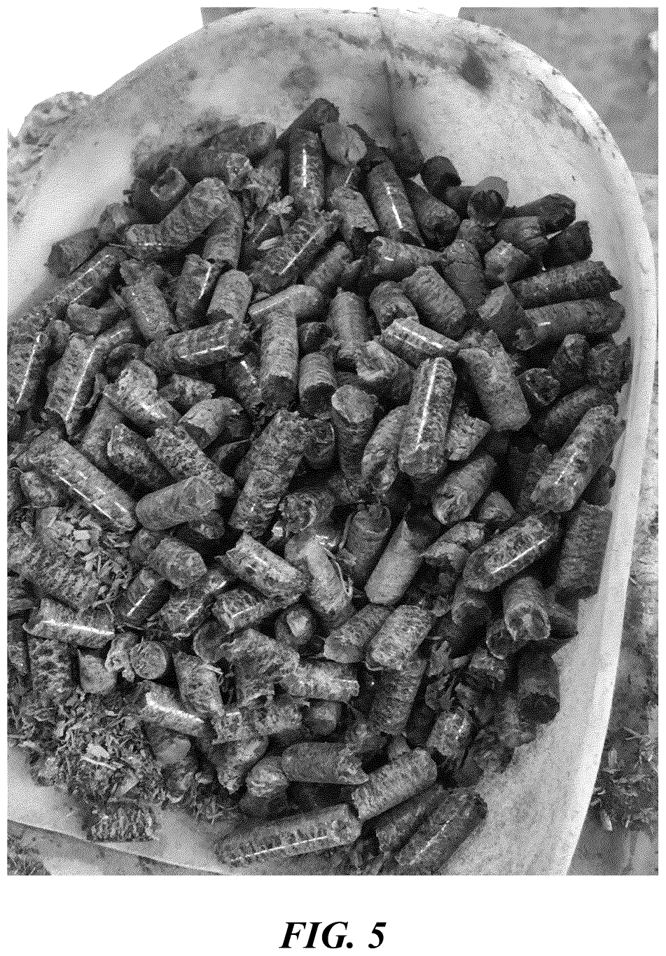

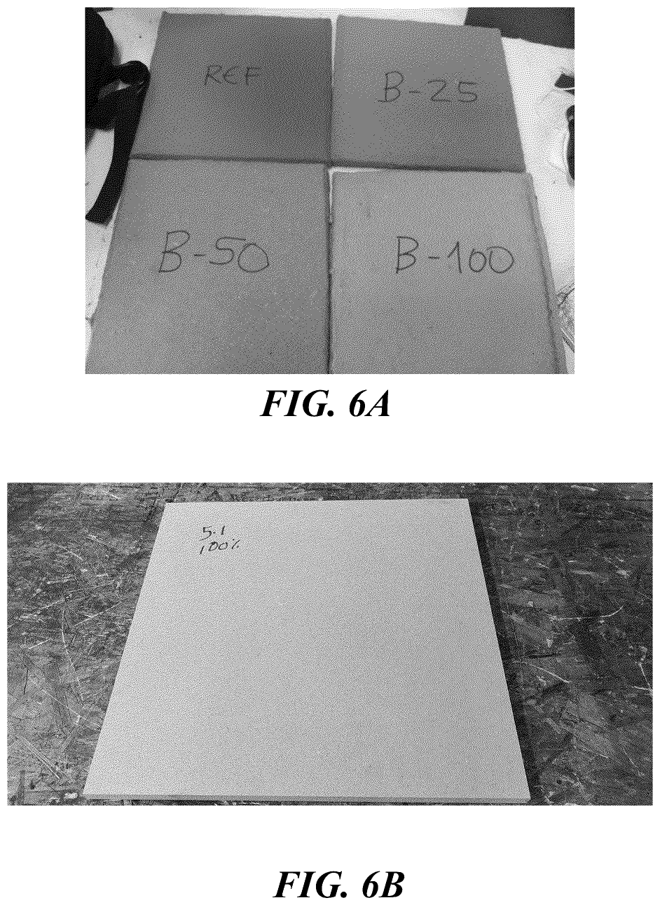

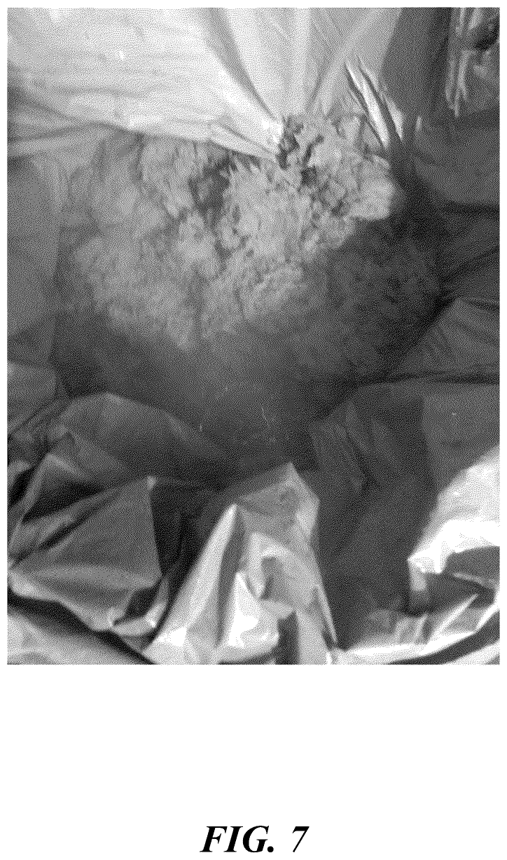

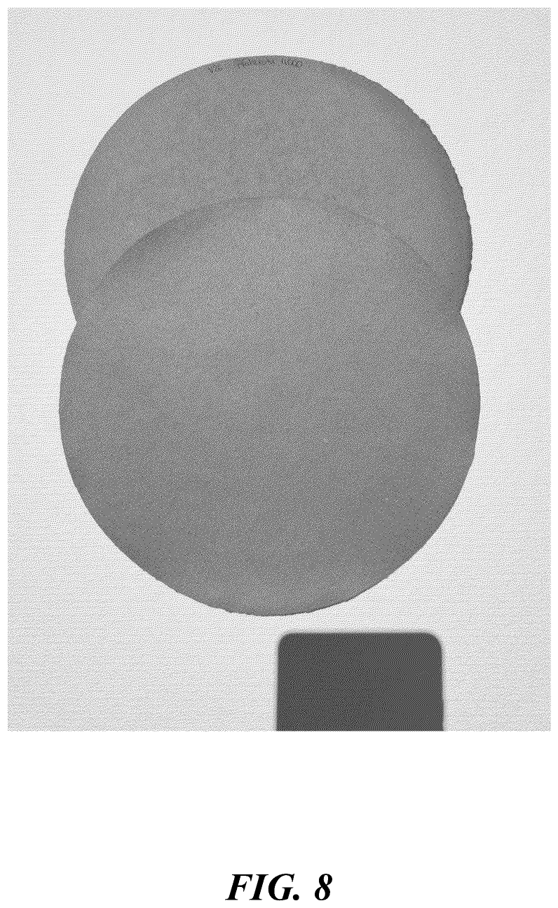

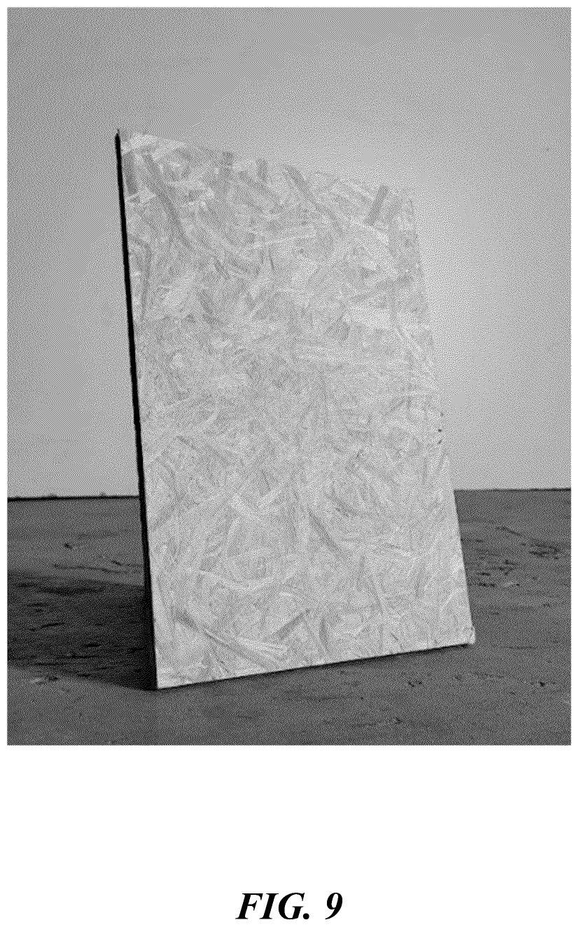

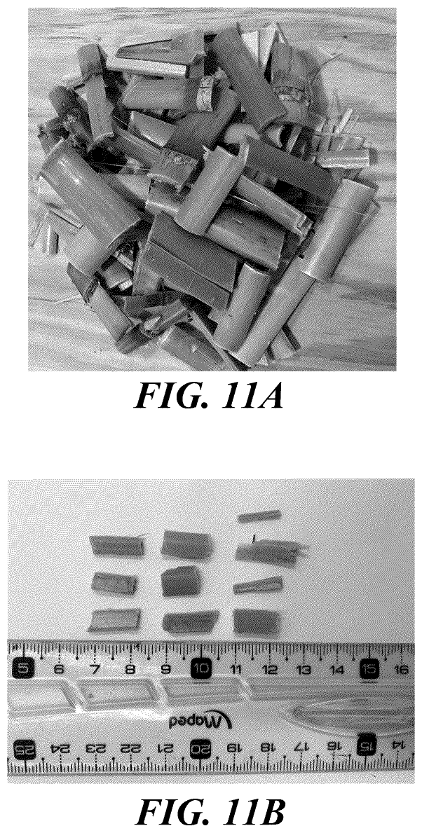

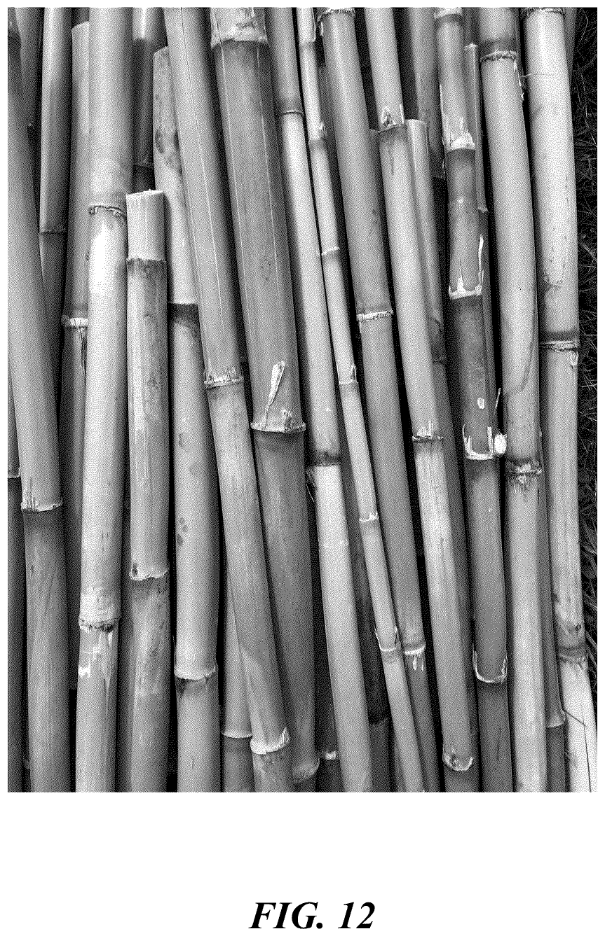

Example products were prepared from Arundo donax produced by methods described herein. Selected example products are shown in FIGS. 5-9 and 11-12. FIG. 5 illustrates pelletized Arundo donax made by methods described herein. FIG. 6A shows four medium density fiber board samples: a reference using 100% wood fiber for comparison (upper left, “REF”), a blend of 25% Arundo donax fiber with wood fiber (upper right, “B-25”), a blend of 50% Arundo donax fiber with wood fiber (lower left, “B-50”), and a 100% Arundo donax fiber medium density fiberboard (lower right, “B-100”). FIG. 6B shows an example particle board made with 100% Arundo donax particles. FIG. 7 shows Arundo donax pulp which is used as a starting material to make the Arundo donax paper shown in FIG. 8. FIG. 9 shows an oriented strand board made using strands of Arundo donax produced by methods described herein. FIG. 11A shows Arundo donax chips, which were produced in a variety of chip lengths as shown in FIG. 11B. FIG. 12 shows Arundo donax cane (stalks with the leaves stripped off).

Testing an Arundo-Based Composition for Shear Modulus and/or Young's Modulus by an American Society for Testing and Materials (ASTM) Method

Homogenous samples of an Arundo composition described herein are provided in rectangular bar, cylindrical rod, or flat disk form are tested using ASTM E1876-22 to determine Young's modulus and/or Shear Modulus.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations, or equivalents. It is intended that the following claims define the scope of the invention and that methods and structures within the scope of these claims and their equivalents be covered thereby.

1.-133. (canceled)

134. A method for growing Arundo grass, the method comprising:
(a) providing a plurality of Arundo grass planting units in soil; and
(b) subjecting said plurality of Arundo grass planting units to conditions sufficient to grow said plurality of Arundo grass planting units to provide a plurality of Arundo grass plants having a density of at least about 1 unit per square meter (U/m²) surface of said soil.

135. The method of claim 134, wherein each of said plurality of planting units is an Arundo grass plant, an Arundo grass plantlet, or an Arundo grass cultivar, or a part, stem, rhizome, or segment of any one of the foregoing.

136. The method of claim 134, wherein said plurality of harvested Arundo grass is harvested prior to the plants entering dormancy/cessation, such as by harvesting during the new moon.

137. The method of claim 134, wherein the method is used for bioremediation of soil.

138. The method of claim 134, wherein the bioremediation is used to reduce a content of one or more elements in the soil by at least 0.1 μg of element per gram of Arundo grown as measured in fiber produced from stalks of the Arundo.

139. The method of claim 138, wherein the one or more elements are selected from the group of: Aluminum, Antimony, Arsenic, Barium, Beryllium, Boron, Cadmium, Chromium, Cobalt, Copper, Iron, Lead, Lithium, Magnesium, Mercury, Molybdenum, Nickel, Phosphorus, Potassium, Selenium, Silicon, Silver, Strontium, Sulfur, Thallium, Tin, Titanium, Vanadium, and Zinc.

140. The method of claim 139, wherein the soil is contaminated with one or more toxins, and is rendered food safe after one or more Arundo plantings.

141. The method of claim 140, wherein the soil is not suitable for sustained growth of food crops prior to the growing of the plurality of Arundo grass plants.

142. The method of claim 141, further comprising repeatedly planting and harvesting Arundo grass plants in the soil until a predetermined target soil composition is obtained.

143. A method for preparing Arundo base materials from Arundo grass grown by the method of claim 134, the method of preparing comprising:
(a) providing a plurality of Arundo grass that comprises at most 30%, by weight, leaves;
(b) processing said plurality of Arundo grass to provide a plurality of Arundo grass chips; and
(c) processing said plurality of Arundo grass chips to provide a material selected from the group consisting of a pellet, a weed control mat, an absorptive pellet, a combustion pellet, a flooring material, a structural beam, a fiberboard, a fiber reinforcement in a composite, a particle board, a bioplastic, a fire retardant, an animal feed, a biochar, an aggregate, a pulp, a paper product (e.g., packaging, toilet paper, paper towels, tissue, or a combination thereof), a fabric, a weaving, a biofuel material, a biochemical material, a wood replacement material, a bamboo replacement material, a corn replacement material, an oriented strand board (OSB), a bioplastic, an insulation material, and a reinforcement material.

144. The method of claim 143, further comprises washing said plurality of Arundo grass chips, e.g., with an acid, such as hydrochloride (HCl).

145. The method of claim 143, further comprising orienting said Arundo grass stalks prior to cutting.

146. The method of claim 145, further comprising sorting said Arundo grass stalks by diameter.

147. The method of claim 143, wherein said Arundo grass stalks are substantially free of leaves.

148. A composition comprising, by weight, at least about 10% Arundo fibers characterized by at least one of:
(i) said Arundo fibers comprise, by weight, no more than about 0.05-0.15% of one or more chlorine content(s);
(ii) said Arundo fibers comprise, by weight, a sugar content of about 5% to about 32%;
(iii) said Arundo fibers comprise, by weight, a cellulose content of about 25% to about 44%;
(iv) said Arundo fibers comprise, by weight, a hemicellulose content of about 25% to about 28%; and
(v) said Arundo fibers comprise, by weight, a lignin content of about 15% to about 25%;
(vi) said Arundo fibers have a Young's modulus of about 5 gigapascals (GPa) to about 30 GPa as determined by an American Society for Testing and Materials (ASTM) Standard method; and
(vii) said Arundo fibers have a shear modulus of about 0.8 megapascals (MPa) to about 12 MPa as determined by an American Society for Testing and Materials (ASTM) Standard method.

149. The composition of claim 148, wherein said Arundo fibers are characterized by (i)-(vii) and/or said Arundo fibers comprise, by dry weight, no more than about 8% ash content(s), and wherein said composition is a weed control mat, an absorptive pellet, a combustion pellet, a flooring material, a structural beam, a fiberboard, is a fiber reinforcement in a composite, an insulation material, a particle board, an animal feed, a biochar, aggregate, a pulp, a paper product, a fabric, a weaving, a biofuel material, a reinforcement material, or an oriented strand board (OSB).

150. An oriented strand board, comprising:
randomly oriented, orthogonally oriented, or substantially parallel oriented strands of Arundo grass plant; and
a binding agent, the oriented strands being bound together by the binding agent;
wherein the Arundo grass plant strands are at least 10% of a total composition of the oriented strand board, and the binding agent is no more than about 10% of the total composition of the oriented strand board.

151. The oriented strand board of claim 150, wherein the strands are randomly oriented.

152. The oriented strand board of claim 150, wherein the strands are orthogonally oriented

153. The oriented strand board of claim 150, wherein the strands are parallel oriented.
